(19) United States
(12) Patent Application Publication
(10) Pub. No.: US 2015/0323850 A1
(43) Pub. Date: Nov. 12, 2015

(54) METHOD FOR PREPARING ELECTROPHORETIC PARTICLES, ELECTROPHORETIC PARTICLES, ELECTROPHORETIC DISPERSION, ELECTROPHORETIC SHEET, ELECTROPHORETIC APPARATUS, AND ELECTRONIC DEVICE

(71) Applicant: Seiko Epson Corporation, Tokyo (JP)

(72) Inventors: Kozo Shitagami, Chino-shi (JP); Harunobu Komatsu, Matsumoto-shi (JP); Shinobu Yokokawa, Okaya-shi (JP)

(21) Appl. No.: 14/704,496

(22) Filed: May 5, 2015

(30) Foreign Application Priority Data
May 7, 2014 (JP) 2014-096299
Jun. 9, 2014 (JP) 2014-118635

(51) Int. Cl. G02F 1/167; C08F 130/08

(52) U.S. Cl. CPC G02F 1/167; C08F 130/08; G02F 2001/1678

(57) ABSTRACT

A method for preparing electrophoretic particles includes mixing a first compound (a compound provided with a functional group having reactivity with a hydroxyl group) or a second compound (a compound provided with a functional group having reactivity with a hydroxyl group and a polymer), and a plurality of particles to obtain a mixture, and linking the first compound or the second compound to the surface of the particles. When obtaining the mixture, the content of the first compound or the second compound in the mixture is 75% by weight or more.

### BACKGROUND

### Technical Field

The invention relates to a method for preparing electrophoretic particles, electrophoretic particles, an electrophoretic dispersion, an electrophoretic sheet, an electrophoretic apparatus, and an electronic device.

It has been generally known that fine particles move (migrate) in liquid by coulomb force when an electric field is applied to a dispersion system in which the fine particles are dispersed in the liquid. This phenomenon is called electrophoresis, and an electrophoretic display device which utilizes the electrophoresis to display desired information (image) has recently attracted attention as a new display device.

The electrophoretic display device has features in that it has a display memory property in the state where application of a voltage is stopped and a wide viewing angle, and is capable of providing a high-contrast display at low power consumption, and so on.

In addition, the electrophoretic display device is a non-light-emitting device, and accordingly, has another feature in that it has a lower impact on viewer's eyes, as compared to light-emitting display devices such as a cathode-ray tube display.

As such an electrophoretic display device, a device which is provided with dispersion of electrophoretic particles in a solvent as electrophoretic dispersion disposed between a pair of substrates with electrodes has been known.

An electrophoretic dispersion having such a configuration includes positively charged electrophoretic particles and negatively charged electrophoretic particles as the electrophoretic particles. By applying voltage between the pair of substrates (electrodes), the positively charged electrophoretic particles move to one side of a substrate and the negatively charged electrophoretic particles move to the other side of the substrate, and accordingly, desired information (image) can thus be displayed.

Here, as the electrophoretic particles, particles provided with base particles and coating layers including polymers linked to the base particles are used. With such a configuration provided with the coating layers (polymers), it becomes possible to disperse and charge the electrophoretic particles in the electrophoretic dispersion.

In addition, the electrophoretic particles with such a configuration are prepared in the following manner by using an atom transfer radical polymerization (ATRP) reaction, for example.

That is, first, a base particle is prepared, and a shell body, which is constituted with an organic polymer and engulfs the base particle in the shape of a cell, is formed on the surface of the base particle, thereby obtaining an AMP particle. Next, a polymerization initiator having a polymerization initiating group is bonded to the shell body of the AMP particle. Thereafter, the monomers are polymerized in living radical polymerization from the polymerization initiating group as a starting point to form a polymer. By providing the polymer on the surface of the base particle in such a manner, electrophoretic particles are prepared (for example, JP-A-2013-218036).

Furthermore, in the case where the shell body exposes a hydroxyl group (—OH group) on the surface thereof in the method, a polymerization initiator having a functional group having reactivity with the hydroxyl group is used as a polymerization initiator. In addition, the polymerization initiator links the hydroxyl group of the shell body with the functional group of the polymerization initiator, thereby linking the polymerization initiator to the shell body.

However, when the hydroxyl group is exposed from the surface of the shell body, aggregation between the AMP particles may occur in some cases due to the occurrence of hydrogen bonds between the hydroxyl groups. In the case where a polymerization initiator is bonded (chemically modified) to the shell body provided in the AMP particles thus aggregated, thereby preparing electrophoretic particles, when the particle size distribution of the obtained electrophoretic particle is measured, a plurality of peaks may be shown in some cases. In order to provide the electrophoretic display device with excellent display quality, it was necessary to make the particle diameters of the electrophoretic particles uniform to a certain degree, and therefore, it was required to carry out a screening operation and the like.

Furthermore, these problems are not limited to AMP particles provided with a shell body, and also occur in the particles having no shell body and having a hydroxyl group exposed on the surface thereof.

### SUMMARY

An advantage of some aspects of the invention is to provide a method for preparing electrophoretic particles, by which electrophoretic particles imparted with desired dispersibility and chargeability can be prepared by bonding a polymer to the surface of a base particle even with the use of a particle (base particle) having a hydroxyl group exposed on the surface thereof; electrophoretic particles imparted with such characteristics; and an electrophoretic dispersion, an electrophoretic sheet, an electrophoretic apparatus, and an electronic device, each having high reliability by using such electrophoretic particles.

Such an advantage is achieved by the invention as follows.

According to an aspect of the invention, there is provided a method for preparing electrophoretic particles including particles having a hydroxyl group exposed on the surface thereof and a coating layer covering at least a part of the particles, the method including obtaining a mixture obtained by mixing a first compound provided with a functional group having reactivity with the hydroxyl group and a plurality of the particles to link the first compound to the surface of the particles; and linking the polymer to the surface of the particles through the first compound to form a coating layer, thereby obtaining electrophoretic particles,

in which the content of the compound excluding a plurality of the particles in the mixture is 75% by weight or more when the mixture is obtained.

Even though particles having a hydroxyl group exposed on the surface thereof as described above are used, electrophoretic particles imparted with desired dispersibility and chargeability can be prepared by dissociating the aggregation between the particles and fixing the polymer to the surface.

In the method for preparing electrophoretic particles, the first compound is preferably a polymerization initiating group-containing compound having the functional group and a polymerization initiating group.

In this manner, the polymerization initiating group-containing compound is reliably linked to the surface of the particles. Further, the monomers can be polymerized from the polymerization initiating group as a starting point.

In the method for preparing electrophoretic particles, the polymerization initiating group is preferably represented by the following general formula (1):

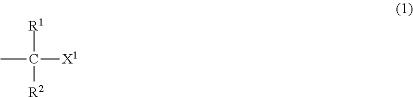

[in which R¹ and R² each independently represent a group selected from hydrogen and an alkyl group having 1 to 20 carbon atoms, in which arbitrary —CH₂— may be substituted with —O— or a cycloalkylene group, and X¹ represents chlorine, bromine, or iodine].

In this manner, it is possible to perform living radical polymerization in which the polymerization initiating group is reacted with the monomers in higher efficiency.

In the method for preparing electrophoretic particles, the polymer is preferably formed by subjecting the monomers to radical polymerization from the polymerization initiating group as a starting point with the addition of the monomers and a catalyst to the mixture in the linking of the polymer to the surface of the particles through the first compound.

In this manner, electrophoretic particles provided with coating layers constituted with the polymer on the surface of the particles are obtained.

In the method for preparing electrophoretic particles, the monomers preferably include silicone macro monomers represented by the following general formula (I):

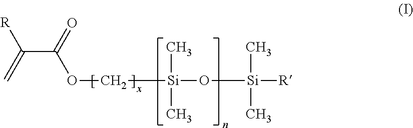

[in which R represents a hydrogen atom or a methyl group, R′ represents a hydrogen atom or an alkyl group having 1 to 4 carbon atoms, n represents an integer of 0 or more, and x represents an integer of 1 to 3].

By using such monomers, these monomers exhibit excellent affinity for the dispersion medium in the case where the electrophoretic dispersion contains a dispersion medium having silicone oil as a main component. As a result, the dispersibility of the electrophoretic particles provided with a polymer obtained by the polymerization of the monomers in the dispersion medium can further be improved.

In the method for preparing electrophoretic particles, a positively or negatively charged compound further having the functional group, in addition to the polymerization initiating group-containing compound, is preferably included as the first compound.

In this manner, in the linking of the polymer to the surface of the particles through the first compound, non-ionic monomers can be used alone while cationic monomers and anionic monomers are not used as the monomers when the polymer is formed. Also in this case, electrophoretic particles imparted with dispersibility and chargeability can be reliably obtained.

Moreover, the above advantage is also accomplished by the following invention.

According to another aspect of the invention, there is provided a method for preparing electrophoretic particles including particles having a hydroxyl group exposed on the surface thereof, and a coating layer covering at least a part of the particles, the method including mixing a second compound having a functional group having reactivity with the hydroxyl group, and a polymer with a plurality of the particles; and linking the second compound to the surface of the particles in the mixture to form a coating layer, thereby obtaining electrophoretic particles, in which the content of the compound excluding a plurality of the particles in the mixture is 75% by weight or more when the mixture is obtained.

Even though particles having a hydroxyl group exposed on the surface thereof as described above are used, electrophoretic particles imparted with desired dispersibility and chargeability can be prepared by dissociating the aggregation between the particles and bonding the second compound to the surface.

In the method for preparing electrophoretic particles, the second compound preferably has the functional group and a polyorganosiloxane linked to the functional group at one end thereof.

In this manner, in the case where the electrophoretic dispersion contains a dispersion medium having silicone oil as a main component, the non-ionic monomers exhibit excellent affinity for the dispersion medium. As a result, the dispersibility of the electrophoretic particles provided with a second compound obtained by the polymerization of the non-ionic monomers in the dispersion medium can further be improved.

In the method for preparing electrophoretic particles, the mixture preferably further includes a non-polar solvent, and the content of the second compound excluding a plurality of the particles in the mixture is preferably set to 75% by weight or more and less than 100% by weight.

In this manner, the second compound can be prevented from being decomposed by the solvent in the functional group.

In the method for preparing electrophoretic particles, the mixture preferably further includes the polymer, and the content of the second compound excluding the particles in the mixture is preferably set to 75% by weight or more and less than 100% by weight.

In this manner, the second compound can be prevented from being decomposed by the solvent in the functional group.

In the method for preparing electrophoretic particles, a plurality of the particles are preferably obtained by drying the aqueous dispersion having a plurality of the particles dispersed therein.

The method for preparing electrophoretic particles is suitably applied, in particular to a plurality of the particles thus obtained.

In the method for preparing electrophoretic particles, the functional group is preferably a halogenated carboxyl group or a halogenated sulfonic acid.

Since such a halogenated acidic group has excellent reactivity with the hydroxyl group, it can reliably link the second compound to the surface of the particles.

According to still another aspect of the invention, there are provided electrophoretic particles prepared by using the method for preparing electrophoretic particles of the aspect.

The electrophoretic particles have desired dispersibility and chargeability.

According to still another aspect of the invention, there is provided an electrophoretic dispersion including the electrophoretic particles of the aspect.

In this manner, it can be formed into an electrophoretic dispersion provided with electrophoretic particles exhibiting excellent dispersibility and migratability.

According to still another aspect of the invention, there is provided an electrophoretic sheet including a substrate, and a plurality of structures, which are disposed on top of the substrate and respectively store the electrophoretic dispersion of the aspect.

In this manner, an electrophoretic sheet having high reliability is obtained.

According to still another aspect of the invention, there is provided an electrophoretic apparatus provided with the electrophoretic sheet of the aspect.

In this manner, an electrophoretic apparatus having high reliability is obtained.

According to still another aspect of the invention, there is provided an electronic device provided with the electrophoretic apparatus of the aspect.

In this manner, an electronic device having high reliability is obtained.

### BRIEF DESCRIPTION OF THE DRAWINGS

The invention will be described with reference to the accompanying drawings, in which like numbers reference like elements.

FIG. 1 is a longitudinal cross-sectional view showing an electrophoretic particle prepared by a method for preparing electrophoretic particles according to a first embodiment of the invention.

FIG. 2 is a schematic view showing the coating layer included in the electrophoretic particles shown in FIG. 1.

FIGS. 3A to 3G are each a schematic view for explaining the method for preparing electrophoretic particles according to the first embodiment of the invention.

FIG. 4A is a partially enlarged view showing a dispersion state of the mother particles that can occur in the aqueous dispersion of FIG. 3C. FIG. 4B is a partially enlarged view showing a configuration of the particles of FIG. 3D.

FIG. 5A is a partially enlarged view showing another dispersion state of the mother particles that can occur in the aqueous dispersion of FIG. 3C. FIG. 5B is a partially enlarged view showing another configuration of the particles of FIG. 3D.

FIGS. 6A to 6C are each a schematic view for explaining a mechanism in which an aggregated particles are gradually dissociated and the particles having a polymerization initiating group-containing compound linked to the surface thereof are dispersed in the mixture.

FIGS. 7A to 7C are each a schematic view for explaining a mechanism in which an aggregated particles are gradually dissociated and the particles having a polymerization initiating group-containing compound and a non-polymerization initiating group-containing compound linked to the surface thereof are dispersed in the mixture.

FIG. 8 is a longitudinal cross-sectional view showing the electrophoretic particle prepared by a method for preparing electrophoretic particles according to a second embodiment of the invention.

FIG. 9 is a schematic view showing the particle and the coating layer included in the electrophoretic particles shown in FIG. 8.

FIGS. 10A to 10F are each a schematic view for explaining the method for preparing electrophoretic particles according to the second embodiment of the invention.

FIG. 11A is a partially enlarged view showing a dispersion state of the mother particles that can occur in the aqueous dispersion of FIG. 10C. FIG. 11B is a partially enlarged view showing a configuration of the particles of FIG. 10D.

FIG. 12A is a partially enlarged view showing another dispersion state of the mother particles that can occur in the aqueous dispersion of FIG. 10C. FIG. 12B is a partially enlarged view showing another configuration of the particles of FIG. 10D.

FIGS. 13A to 13C are each a schematic view for explaining a mechanism in which an aggregated particles are gradually dissociated and the particles having a compound having a functional group and a polymer linked to the surface thereof are dispersed in the mixture.

FIG. 14 is a view schematically showing the longitudinal cross-section of an electrophoretic display device according to an embodiment.

FIGS. 15A and 15B are each a view schematically showing the operation principle of the electrophoretic display device shown in FIG. 14.

FIG. 16 is a perspective view showing a case where the electronic device according to an embodiment of the invention is applied to the electronic paper.

FIGS. 17A and 17B are each a view showing to a case where an electronic device according to an embodiment of the invention is applied to a display.

FIG. 18 is a graph showing the particle size distribution of the encapsulated mother particles having a polymerization initiating group-containing compound bonded to the surface thereof in each of Examples and Comparative Examples.

FIG. 19 is a graph showing the relationship of the standard deviation of the particle size distribution with the content of the polymerization initiating group-containing compound in each of Examples and Comparative Examples.

FIG. 20 is a graph showing the relationship of the total area of the particles having a particle diameter of 1 μm or more among the encapsulated mother particles having a polymerization initiating group-containing compound bonded to the surface thereof with the content of the polymerization initiating group-containing compound in each of Examples and Comparative Examples.

### DESCRIPTION OF EXEMPLARY EMBODIMENTS

Hereinafter, a method for preparing electrophoretic particles, electrophoretic particles, an electrophoretic dispersion, an electrophoretic sheet, an electrophoretic apparatus, and an electronic device of the invention will be described in detail, based on preferable embodiments shown in the accompanying drawings.

### First Embodiment

The method for preparing electrophoretic particles according to the first embodiment of the invention will be described.

Prior to describing the method for preparing electrophoretic particles of the present embodiment, electrophoretic particles prepared by applying the method for preparing electrophoretic particles of the present embodiment (the electrophoretic particles of the present embodiment) will be first described.

The electrophoretic particle prepared by applying the method for preparing electrophoretic particles of the present embodiment has a particle and a coating layer covering at least a part of the particles. This particle is provided with a mother particle and a shell body which is constituted with an organic polymer and engulfs the mother particle in the shape of a cell. Further, the coating layer is provided with a polymer formed by the polymerization of monomers from a polymerization initiating group as a starting point. By way of example, an electrophoretic particle with such a configuration will be described.

### Electrophoretic Particles

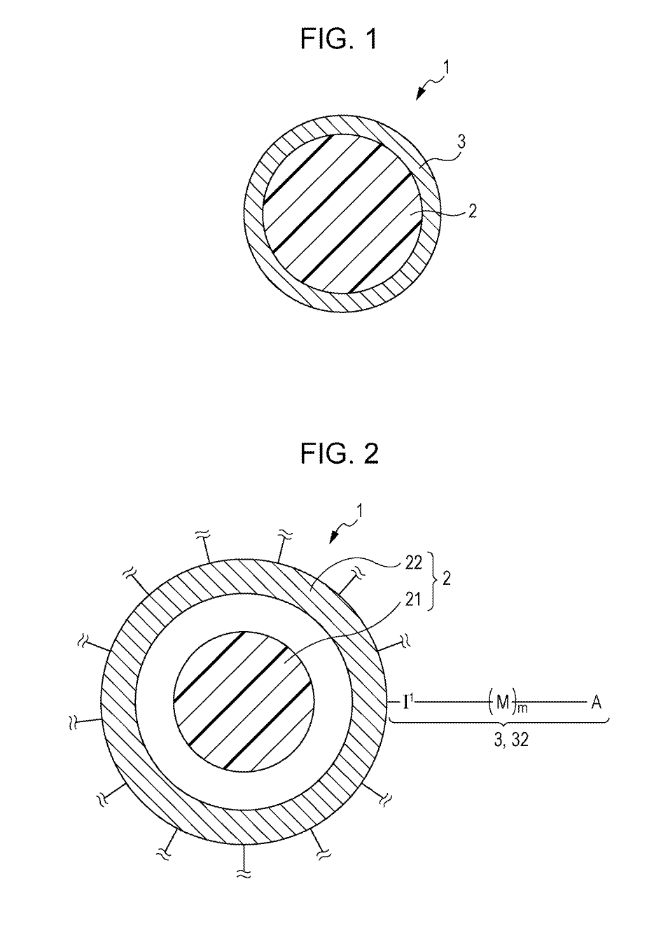

FIG. 1 is a longitudinal cross-sectional view showing the electrophoretic particle prepared by the method for preparing electrophoretic particles according to the first embodiment of the invention. FIG. 2 is a schematic view showing the coating layer included in the electrophoretic particles shown in FIG. 1.

The electrophoretic particle 1 has a particle 2 having a hydroxyl group exposed on the surface thereof and a coating layer 3 provided on the surface of the particle 2.

In the present embodiment, the particle 2 is configured to have a mother particle 21 and a shell body 22 which engulfs the mother particle 21 in the shape of a cell (in the form of a capsule).

The mother particle (base particle) 21 mainly constitutes the particle 2 and functions as a core material (mother material) of the particle 2.

The cross-sectional shape of the mother particle 21, as shown in FIG. 2, forms a circular shape. In this manner, by allowing the mother particle 21 to form a spherical shape, the cross-sectional shape of the particles 2 can also be a circular shape, as shown in FIG. 2. Accordingly, since it is possible to make the electrophoretic performance provided for the electrophoretic particles 1 more uniform, the shape is preferably selected as the shape of the mother particle 21. In addition, if the electrophoretic performance provided for the electrophoretic particle 1 is made uniform, the cross-sectional shape of the mother particle 21 may have an elliptical shape or a polygonal shape such as a rectangular shape, a pentagonal shape, and a hexagonal shape, or may be an aggregate in which granules having such a shape are aggregated with each other.

As the mother particle 21, for example, at least one of a pigment particle, a dye particle, a resin particle, and a complex particle thereof is suitably used. These particles are easily prepared.

Examples of the pigment constituting the pigment particles include black pigments such as carbon black, aniline black, and titanium black, white pigments such as titanium dioxide, antimony trioxide, barium sulfate, zinc sulfide, zinc oxide, and silicon dioxide, azo-based pigments such as monoazo, disazo, and polyazo, yellow pigments such as isoindolinone, chrome yellow, yellow iron oxide, cadmium yellow, titanium yellow, and antimony, azo-based pigments such as monoazo, disazo, and polyazo, red pigments such as quinacridone red and chrome vermilion, blue pigments such as phthalocyanine blue, indanthrene blue, iron blue, ultramarine, and cobalt blue, and green pigments such as phthalocyanine green, and among these, one kind or a combination of two or more kinds thereof may be used.

In addition, examples of the dye material constituting the dye particles include azo compounds such as Oil Yellow 3G (manufactured by Orient Chemical Industries Co., Ltd.), azo compounds such as Fast Orange G (manufactured by BASF Japan, Ltd.), anthraquinones such as Macrolex Blue RR (manufactured by Bayer Holding, Ltd.), anthraquinones such as Sumiplast Green G (manufactured by Sumitomo Chemical Co., Ltd.), azo compounds such as Oil Brown GR (manufactured by Orient Chemical Industries Co., Ltd.), azo compounds such as Oil Red 5303 (manufactured by Arimoto Chemical Co., Ltd.) and Oil Red 5B (manufactured by Orient Chemical Industries Co., Ltd.), anthraquinones such as Oil Violet #730 (manufactured by Orient Chemical Industries Co., Ltd.), azo compounds such as Sudan Black X60 (manufactured by BASF Ltd.), and mixtures of anthraquinone-based Macrolex Blue FR (manufactured by Bayer Holding Ltd.) and azo-based Oil Red XO (manufactured by Kanto Chemical Co., Inc.), and one kind or a combination of two or more kinds thereof may be used.

In addition, examples of the resin material constituting the resin particles include an acrylic-based resin, a urethane-based resin, a urea-based resin, an epoxy-based resin, a polystyrene, and a polyester, and one kind or a combination of two or more kinds thereof may be used.

In addition, examples of the complex particles include particles formed by carrying out a coating treatment by covering the surface of the pigment particles by resin materials, particles formed by carrying out a coat treatment by covering the surface of resin particles by pigments, particles constituted with mixtures in which pigments and resin materials are mixed at an appropriate composition ratio, or the like.

Incidentally, by appropriately selecting the types of pigment particles, resin particles and complex particles to be used as the mother particle 21, it is possible to set the color of the electrophoretic particle 1 as the desired color.

Furthermore, the mother particle 21 needs to have a charge on the surface thereof so as to align the first polymerizable surfactant 61 to the mother particle 21 during formation of the shell body 22 in the method for preparing the electrophoretic particles of the present embodiment as will described later. However, there are some cases where the mother particle 21 does not have a charge or the electrification amount which is insufficient, depending on the types of a pigment particle, a resin particle, and a complex particle. Thus, in such a case, it is preferable to impart the charge to the surface of the mother particle 21 by carrying out a treatment for absorbing a compound having polarity, such as a coupling agent and a surfactant, onto the surface of the mother particle 21 in advance.

The mother particle 21 is engulfed in the shape of a cell by the shell body 22. By providing the particle 2 with the shell body 22 having such a configuration, it is possible to accurately prevent the influence of the charge of the mother particle (base particle) 21 on the electrophoretic particle 1. Thus, by setting the type, the number, or the like of the polymer 32 to be linked to the shell body 22, it is possible to accurately prevent or prevent the change in the characteristics such as dispersibility and chargeability, which are imparted to the electrophoretic particle 1, depending on the charge of the particle 2. That is, the electrophoretic particle 1 exhibits desired characteristics such as dispersibility and chargeability, irrespective of the type of the mother particle 21.

The shell body 22 is constituted with an organic polymer in the present embodiment. Further, the shell body 22 is not particularly limited as long as it is possible to engulf the particle 2 in the shape of a cell by the organic polymer. In particular, it is preferable that a network structure (linked structure) formed by crosslinking a plurality of the organic polymers to each other is formed. In so doing, the shell body 22 has excellent strength, and accordingly, it is possible to reliably prevent the shell body 22 from being peeled from the particle 2.

It is possible to obtain the shell body 22 with such a configuration, for example, by a method as shown below. First, a first polymerizable surfactant 61 having a first polar group 611 which has polarity opposite to the charge of the surface of the particle 2, a hydrophobic group 612, and a polymerizable group 613 is added to an aqueous dispersion 90 in which the particles 2 having the charge on the surface thereof are dispersed, and mixed. Next, a second polymerizable surfactant 62 having a hydroxyl group which is a second polar group 621, a hydrophobic group 622, and a polymerizable group 623 is added to the mixed solution of the aqueous dispersion 90 and the first polymerizable surfactant 61, and emulsified. Then, a polymerization initiator is added to the mixed solution of the aqueous dispersion 90, the first polymerizable surfactant 61, and the second polymerizable surfactant 62 to cause a polymerization reaction to occur. This method will be described in detail in the description of the method for preparing the electrophoretic particles as described later.

The particle 2 is covered with the coating layer 3 on at least a part (approximately the entire part in the configuration shown) of the surface thereof.

This coating layer 3 is configured to have a plurality of polymers 32 bonded to the surface of the shell body 22 provided in the particle 2 in the present embodiment.

The polymer 32 is formed by the polymerization of the monomers from the polymerization initiating group-containing compound linked to the second polar group (hydroxyl group) 621 provided in the shell body 22 as a starting point. This polymer 32 is a component that exhibits the characteristics of the electrophoretic particle 1 in the electrophoretic dispersion as described later.

The polymerization initiating group-containing compound is provided with a polymerization initiating group. After linking to the second polar group (hydroxyl group) 621 exposed from the surface of the shell body 22, the monomers are sequentially linked and used as a starting point for polymerization.

This polymerization initiating group-containing compound has a functional group Z having reactivity with the second polar group (hydroxyl group), and a polymerization initiating group A. A detailed description of the polymerization initiating group-containing compound will be applied in the method for preparing electrophoretic particles as described later.

A monomer is provided with a polymerizable group capable of being polymerized by living radical polymerization. The monomer is classified into a non-ionic monomer, an anionic monomer, and a cationic monomer, based on the characteristics imparted to the electrophoretic particle 1. Further, examples of the polymerizable group contained in the monomer include polymerizable groups including carbon-carbon double bonds, such as a vinyl group, a styryl group, and a (meth)acryloyl group.

By forming the polymer 32 by living radical polymerization using a monomer including a non-ionic monomer, the polymer 32 exhibits excellent affinity for a dispersion medium included in the electrophoretic dispersion as described later. Therefore, it is possible to disperse the electrophoretic particles 1 in the electrophoretic dispersion while not aggregating the electrophoretic particles 1 provided with such a polymer 32. That is, it is possible to impart the characteristics of the dispersibility to the electrophoretic particles 1.

Examples of such a non-ionic monomer include an acrylic-based monomer such as 1-hexene, 1-heptene, 1-octene, methyl(meth)acrylate, ethyl(meth)acrylate, propyl(meth)acrylate, stearyl(meth)acrylate, lauryl(meth)acrylate, decyl(meth)acrylate, isooctyl(meth)acrylate, isobornyl(meth)acrylate, cyclohexyl(meth)acrylate, pentafluoro(meth)acrylate, and a silicone macro monomer represented by the following general formula (I); and a styrene-based monomer such as styrene, 2-methyl styrene, 3-methyl styrene, 4-methyl styrene, 2-ethyl styrene, 3-ethyl styrene, 4-ethyl styrene, 2-propyl styrene, 3-propyl styrene, 4-propyl styrene, 2-isopropyl styrene, 3-isopropyl styrene, 4-isopropyl styrene, and 4-tert-butyl styrene.

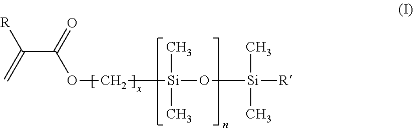

[in which R represents a hydrogen atom or a methyl group, R′ represents a hydrogen atom or an alkyl group having 1 to 4 carbon atoms, n represents an integer of 0 or more, and x represents an integer of 1 to 3].

Among these, the non-ionic monomer is preferably a silicone macro monomer represented by General Formula (I). By adopting such a non-ionic monomer, when a solvent having silicone oil as a main component is used as a dispersion medium included in the electrophoretic dispersion as described later, the non-ionic monomer exhibits excellent affinity for the dispersion medium. Accordingly, the electrophoretic particle 1 provided with the polymer 32 obtained by the polymerization of the non-ionic monomers has further improved dispersibility in the dispersion medium.

Furthermore, by forming the polymer 32 by living radical polymerization using monomers including cationic monomers, the polymer 32 becomes positively charged (plus) in the electrophoretic dispersion as described later. Therefore, the electrophoretic particle 1 provided with such a polymer 32 becomes the electrophoretic particle with positive chargeability (positive electrophoretic particle) in the electrophoretic dispersion. That is, it is possible to impart the characteristics of positive chargeability to the electrophoretic particle 1.

Examples of such a cationic monomer include a monomer provided with an amino group in the structure thereof, specifically, benzyl(meth)acrylate, 2-(diethylamino)ethyl(meth)acrylate, 2-(trimethylammonium chloride)ethyl(meth)acrylate, 1,2,2,6,6-pentamethyl-4-piperidyl(meth)acrylate, 2,2,6,6-tetramethyl-4-piperidyl(meth)acrylate, 1,1,1,3,3,3-hexafluoroisopropyl(meth)acrylate, aminomethyl(meth)acrylate, aminoethyl(meth)acrylate, N,N-dimethylaminoethyl(meth)acrylate, N-ethyl-N-phenylaminoethyl(meth)acrylate, N,N-dimethyl(meth)acrylamide, N,N-diethyl(meth)acrylamide, 4-vinylpyridine, and methacryloylcholine chloride.

Furthermore, by forming the polymer 32 by living radical polymerization using a monomer including an anionic monomer, the polymer 32 becomes negatively charged (minus) in the electrophoretic dispersion as described later. Therefore, the electrophoretic particle 1 provided with such a polymer 32 becomes the electrophoretic particle with negative chargeability (negative electrophoretic particle) in the electrophoretic dispersion. That is, it is possible to impart the characteristics of negative chargeability to the electrophoretic particle 1.

Examples of such an anionic monomer include a monomer provided with a carboxyl group or a sulfonyl group in the structure thereof, specifically, (meth)acrylic acid, carboxymethyl(meth)acrylate, carboxyethyl(meth)acrylate, vinylbenzoic acid, vinylphenylacetic acid, vinylphenylpropionic acid, vinylsulfonic acid, sulfomethyl(meth)acrylate, 2-sulfoethyl(meth)acrylate, polyethylene glycol mono(meth)acrylate, and 2-methoxyethyl(meth)acrylate.

Since the polymer 32 is formed by polymerization of various monomers as described above, it is possible to set the polymer 32 at the desired level of the characteristics derived from various monomers by setting the number of structural units derived from these monomers.

In addition, it is possible to illustrate the polymer 32 obtained from the polymerization initiating group-containing compound and the monomer by a schematic view as in FIG. 2, when the monomer is denoted as M and the polymerization initiating group-containing compound is denoted as I¹.

Such an electrophoretic particle 1 is prepared as follows, by applying the method for preparing electrophoretic particles of the present embodiment.

### Method of Preparing Electrophoretic Particles

Hereinafter, a method for preparing the electrophoretic particles 1 of the present embodiment will be described.

Furthermore, in the method for preparing the electrophoretic particles 1 as described later, first, a particle 2 (AMP particle) in which the mother particle 21 is engulfed in the form of a capsule by the shell body 22 is formed. Next, a plurality of the polymers 32 are produced in (linked to) the surface of the particles 2 to form a coating layer 3. By using such a method, the electrophoretic particles 1 are obtained.

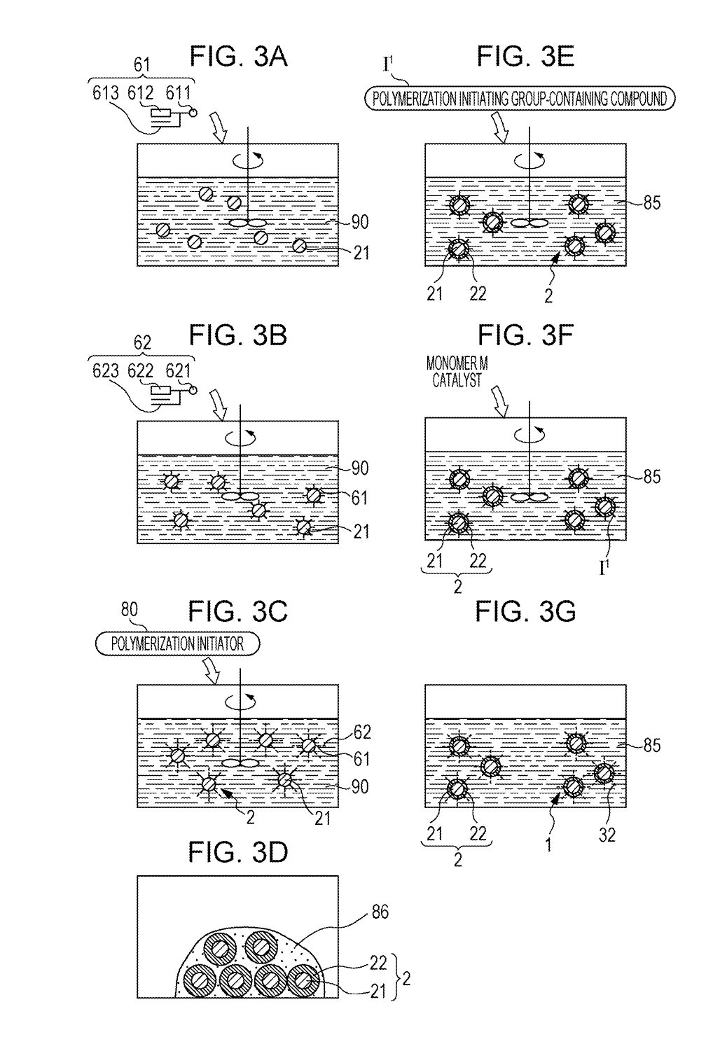

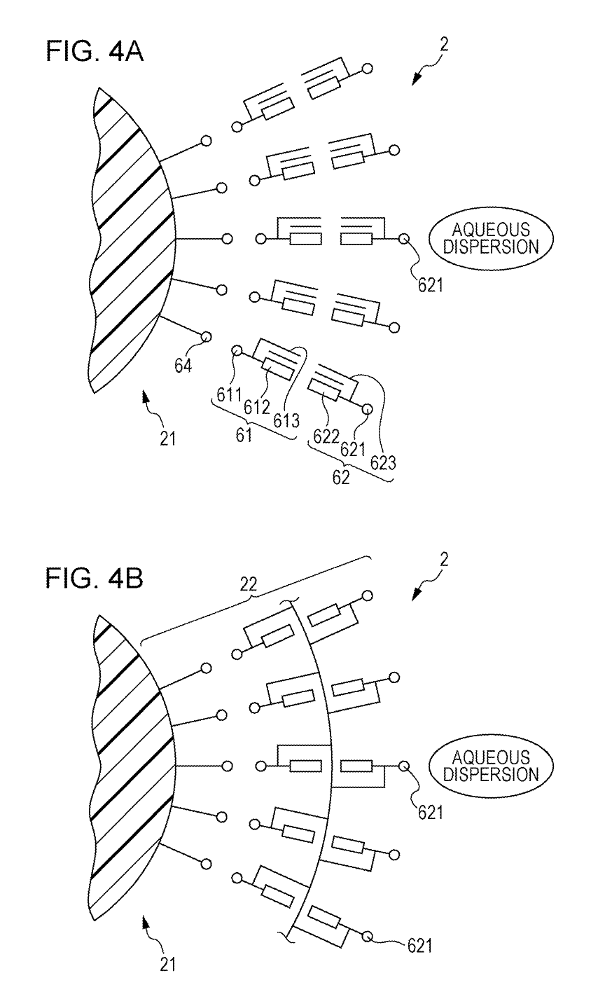

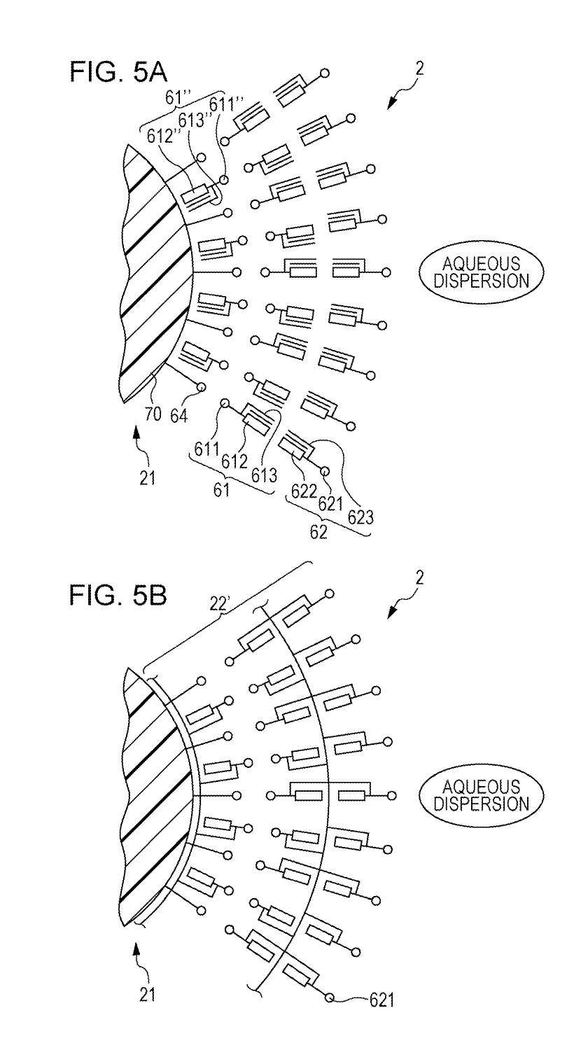

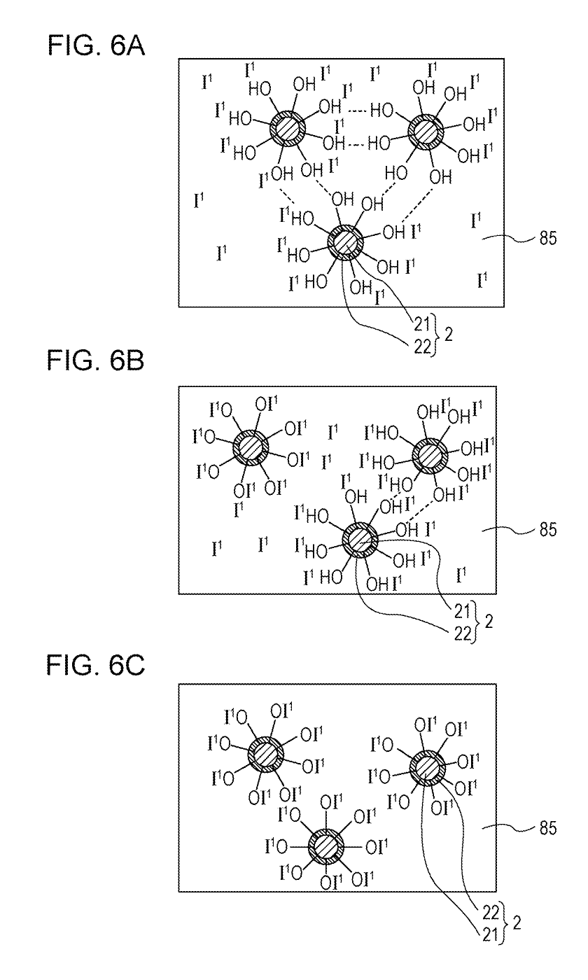

FIGS. 3A to 3G are each a schematic view for explaining the method for preparing electrophoretic particles according the first embodiment of the invention. FIG. 4A is a partially enlarged view showing a dispersion state of the mother particles that can occur in the aqueous dispersion of FIG. 3C. FIG. 4B is a partially enlarged view showing a configuration of the particles of FIG. 3D. Further, FIG. 5A is a partially enlarged view showing another dispersion state of the mother particles that can occur in the aqueous dispersion of FIG. 3C. FIG. 5B is a partially enlarged view showing another configuration of the particles of FIG. 3D. Further, FIGS. 6A to 6C are each a schematic view for explaining a mechanism in which an aggregated particles are gradually dissociated and the particles having a polymerization initiating group-containing compound linked to the surface thereof are dispersed in the mixture.

In the present embodiment, the method for preparing the electrophoretic particles 1 includes [1] dispersing mother particles 21 having the charge on the surface thereof into an aqueous dispersion 90, [2] adding a first polymerizable surfactant 61 which has the first polar group 611 having polarity opposite to the charge 64 of the mother particles 21, a hydrophobic group 612, and a polymerizable group 613 to the aqueous dispersion 90, and mixing them, [3] adding the second polymerizable surfactant 62 having a second polar group 621 (hydroxyl group), a hydrophobic group 622, and a polymerizable group 623 to the aqueous dispersion 90, and emulsifying them, [4] obtaining a particle 2 which is made by engulfing the mother particle 21 in the form of a capsule by a shell body 22 constituted with an organic polymer by adding polymerization initiator 80 to the aqueous dispersion 90 to cause a polymerization reaction to occur, [5] obtaining a dried product (aggregate) 86 of the particles 2 by drying the aqueous dispersion 90 including the particles 2, [6] linking the polymerization initiating group-containing compound I¹ to the surface of the particles 2 by setting the content of the polymerization initiating group-containing compound I¹ except for the dried product 86 (particles 2) to 75% by weight or more in a mixture 85 obtained by adding a polymerization initiating group-containing compound I¹ (first compound) having a functional group Z having reactivity with the second polar group (hydroxyl group) 621 and a polymerization initiating group A to the dried product of the particles 2 into the aqueous dispersion 90, and mixing them, [7] obtaining the electrophoretic particles 1 by adding the monomers M and a catalyst to the mixture 85 to form a polymer 32, [8] collecting the electrophoretic particles 1 from the mixture 85, and [9] drying the electrophoretic particles 1.

In the present embodiment, when the polymerization initiating group-containing compound I¹ is linked to the surface of the particles 2 in the process [6], the content of the polymerization initiating group-containing compound I¹ except for the dried product 86 (particles 2) is set to 75% by weight or more in the mixture 85 of the dried product of the particles 2 and the polymerization initiating group-containing compound I¹. In doing so, even when the particles 2 having the second polar group (hydroxyl group) 621 exposed on the surface thereof are used, electrophoretic particles having a small number of peaks can be prepared as the particle size distribution is measured. More preferably, electrophoretic particles 1 having only a single peak can be prepared. Further, the content of the polymerization initiating group-containing compound I¹ except for the dried product 86 (particles 2) in the mixture 85 may be 75% by weight or more when the reaction is initiated. Thereafter, according to the progress of the reaction, the polymerization initiating group-containing compound I¹ is consumed and may be in an amount of below 75% by weight.

Hereinafter, the respective processes as described above will be described in order.

[1] First, mother particles 21 having the charge 64 on the surface thereof are dispersed into an aqueous dispersion 90.

As the aqueous dispersion 90, for example, various types of water such as distilled water, ion-exchanged water, pure water, ultrapure water, and R. O. water alone or an aqueous medium formed by mixing water as a main component with various lower alcohols such as methanol and ethanol is suitably used.

[2] Next, as shown in FIG. 3A, the first polymerizable surfactant 61 which has the first polar group 611 having polarity opposite to the charge 64 of the mother particle 21, a hydrophobic group 612, and a polymerizable group 613 is added to the aqueous dispersion 90, and mixed.

At this time, the additive amount of the first polymerizable surfactant 61 is preferably in the range of 0.5-fold moles to 2-fold moles, and more preferably in the range of 0.8-fold moles to 1.2-fold moles, with respect to the total number of moles (=weight of the used mother particle 21 [g]×the amount of a polar group having the charge 64 of the mother particle 21 [mol/g]) of a polar group, having the charge 64, converted from the amount of the mother particle 21 used. Further, by setting the additive amount of the first polymerizable surfactant 61 to 0.5-fold moles or more with respect to the total number of moles of the polar group having the charge 64, it is possible for the first polymerizable surfactant 61 to strongly bond ionically with the mother particle 21 and be easily encapsulated. On the other hand, by setting the additive amount of the first polymerizable surfactant 61 to 2-fold moles or less with respect to the total number of moles of the group having the charge 64, it is possible to reduce the amount of the first polymerizable surfactant 61 generated, which is not adsorbed to the mother particle 21, and it is also possible to prevent the occurrence of a polymer particle (particle which consists of only polymers) not having the mother particle 21 as a core material.

In addition, the aqueous dispersion 90 may be irradiated with ultrasonic waves for a predetermined time as necessary. In this manner, the arrangement pattern of the first polymerizable surfactant 61 present around the mother particle 21 is controlled to a high degree.

Specifically, in the case where the mother particle 21 has the negative charge 64, it is possible to use a cationic polymerizable surfactant as the first polymerizable surfactant 61. In contrast, in the case where the mother particle 21 has the positive charge 64, an anionic polymerizable surfactant can be used as the first polymerizable surfactant 61.

Examples of the cationic group contained in the cationic polymerizable surfactant include a primary amine cationic group, a secondary amine cationic group, a tertiary amine cationic group, a quaternary ammonium cationic group, a quaternary phosphonium cationic group, a sulfonium cationic group, and a pyridinium cationic group.

Among these, a cationic group is preferably one selected from a group consisting of a primary amine cationic group, a secondary amine cationic group, a tertiary amine cationic group, and a quaternary ammonium cationic group.

A hydrophobic group contained in the cationic polymerizable surfactant preferably includes at least one of an alkyl group and an aryl group.

A polymerizable group contained in the cationic polymerizable surfactant is preferably a radically polymerizable unsaturated hydrocarbon group.

Moreover, among radically polymerizable unsaturated hydrocarbon groups, one selected from a group consisting of a vinyl group, an allyl group, an acryloyl group, a methacryloyl group, a propenyl group, a vinylidene group, and a vinylene group is preferable. Furthermore, among these, especially, an acryloyl group and a methacryloyl group may be exemplified as more preferable examples.

Examples of the cationic polymerizable surfactant include the cationic allyl acid derivatives described in JP-B-4-65824, or the like. Specific examples of the cationic polymerizable surfactant include dimethylaminoethyl methacrylate methyl chloride, dimethylaminoethyl methacrylate benzyl chloride, methacryloyloxyethyl trimethyl ammonium chloride, diallyl dimethyl ammonium chloride, and 2-hydroxy-3-methacryloxypropyl trimethyl ammonium chloride.

In addition, as the cationic polymerizable surfactant, commercial products may also be used. For example, Acryester DMC (Mitsubishi Rayon Co., Ltd.), Acryester DML60 (Mitsubishi Rayon Co., Ltd.), C-1615 (Dai-ichi Kogyo Seiyaku Co., Ltd.), or the like may be used.

The cationic polymerizable surfactants exemplified above may be used alone or as a mixture of two or more kinds.

On the other hand, examples of the anionic group contained in the anionic polymerizable surfactant include a sulfonate anionic group (—SO₃⁻), a sulfinate anionic group (—RSO₂⁻: R is an alkyl group having 1 to 12 carbon atoms, or a phenyl group or a modified body thereof), a carboxylate anionic group (—COO⁻), a phosphate anionic group (—PO₃⁻), and an alkoxide anionic group (—O⁻); however, one selected from a group consisting of these is preferable.

As a hydrophobic group contained in the anionic polymerizable surfactant, the same hydrophobic group as the hydrophobic group contained in the cationic polymerizable surfactant as described above can be used.

As a polymerizable group contained in the anionic polymerizable surfactant, the same polymerizable group as the polymerizable group contained in cationic polymerizable surfactant as described above can be used.

Examples of the anionic polymerizable surfactant include the anionic allyl derivatives described in JP-B-49-46291, JP-B-1-24142 and JP-A-62-104802, the anionic propenyl derivatives described in JP-A-62-221431, the anionic acrylic acid derivatives described in JP-A-62-34947 and JP-A-55-11525, and the anionic itaconic acid derivatives described in JP-B-46-34898 and JP-A-51-30284.

As a specific example of such an anionic polymerizable surfactant, a compound represented by General Formula (31):

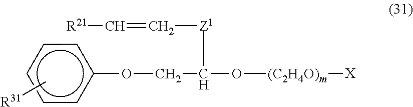

[in which R²¹ and R³¹ are each independently a hydrogen atom or a hydrocarbon group having 1 to 12 carbon atoms, Z¹ is carbon-carbon single bond or a group represented by the formula —CH₂—O—CH₂—, m is an integer of 2 to 20, X is a group represented by the formula —SO₃M¹, and M¹ is an alkali metal, an ammonium salt or an alkanolamine], or

a compound represented by General Formula (32):

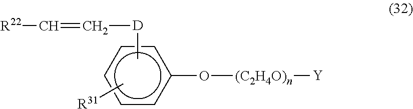

[in which R²² and R³² are each independently a hydrogen atom or a hydrocarbon group having 1 to 12 carbon atoms, D is carbon-carbon single bond or a group represented by the formula —CH₂—O—CH₂—, n is an integer of 2 to 20, Y is a group represented by the formula —SO₃M², and M² is an alkali metal, an ammonium salt or an alkanolamine]

is preferable.

The polymerizable surfactant represented by Formula (31) is described in JP-A-5-320276 and JP-A-10-316909. By arbitrarily adjusting the type of R²¹ and the value of X in Formula (31), it is possible to correspond to the degree of the electrification amount of the charge 64 included in the mother particle 21. Examples of the preferable polymerizable surfactant represented by Formula (31) include a compound represented by the following formula (310) and specifically include compounds represented by the following formulae (31a) to (31d).

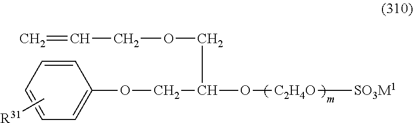

[in which R³¹, m, and M¹ are the same as for the compound represented by Formula (31)]

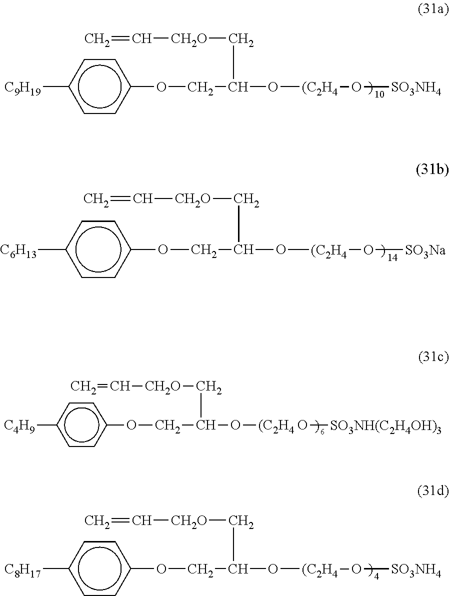

Adeka Reasoap SE-10N of Adeka Chemical Supply Co., Ltd. is a compound represented by Formula (310), in which M₁ is NH₄, R³¹ is C₉H₁₉, and m=10. Adeka Reasoap SE-20N of Adeka Chemical Supply Co., Ltd. is a compound represented by Formula (310), in which M₁ is NH₄, R³¹ is C₉H₁₉, and m=20.

In addition, as the anionic group contained in the anionic polymerizable surfactant, for example, a compound represented by General Formula (33):

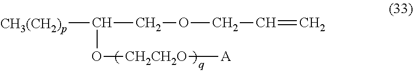

[in which p is 9 or 11, q is an integer of 2 to 20, A is a group represented by —SO₃M³, and M³ is an alkali metal, an ammonium salt or an aikanolamine]

is preferable. Preferable examples of the anionic polymerizable surfactant represented by Formula (33) include the following compounds:

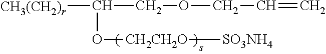

[in which r is 9 or 11, and s is 5 or 10].

As the anionic polymerizable surfactant, commercial products may also be used. For example, Aquaron KH series (Aquaron KH-5 and Aquaron KH-10) of Dai-ichi Kogyo Seiyaku Co., Ltd., or the like may be used. Aquaron KH-5 is a mixture of the compound in which r is 9 and s is 5 and the compound in which r is 11 and s is 5, each represented by the formula above, and Aquaron KH-10 is a mixture of the compound in which r is 9 and s is 10 and the compound in which r is 11 and s is 10, each represented by the formula above.

In addition, as the anionic polymerizable surfactant, a compound represented by the following formula (34) is preferable:

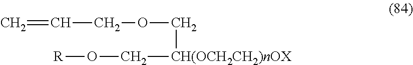

[in which R is an alkyl group having 8 to 15 carbon atoms, n is an integer of 2 to 20, X is a group represented by —SO₃B, and B is an alkali metal, an ammonium salt, or an alkanolamine].

As the anionic polymerizable surfactant, commercial products may also be used. Examples of the commercial product include Adeka Reasoap SR series (Adeka Reasoap SR-10, SR-20, and R-1025) (all, product names) manufactured by Adeka Chemical Supply Co., Ltd. Adeka Reasoap SR series are compounds in which B is represented by NH₄, SR-10 is the compound with n=10, and SR-20 is the compound with n=20, each of which is the compound of General Formula (34).

In addition, as the anionic polymerizable surfactant, a compound represented by the following formula (A) is also preferable:

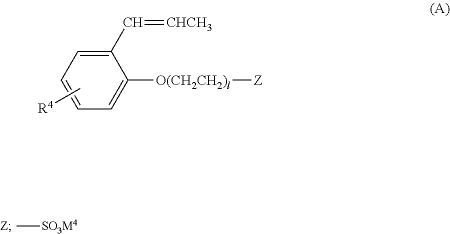

[in the formula describe above, R⁴ represents a hydrogen atom or a hydrocarbon group having 1 to 12 carbon atoms, I represents a number of 2 to 20, and M⁴ represents an alkali metal, an ammonium salt, or an alkanolamine].

As the anionic polymerizable surfactant, commercial products may also be used. As the commercial product, for example, Aquaron HS series (Aquaron HS-10, HS-20, and HS-1025) (all, product names) manufactured by of Dai-ichi Kogyo Seiyaku Co., Ltd. can be used.

In addition, examples of the anionic polymerizable surfactant used in the invention include a sodium alkylaryl sulfosuccinate ester salt represented by General Formula (35).

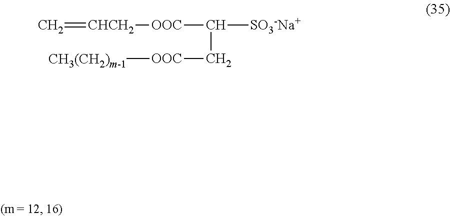

As the anionic polymerizable surfactant, commercial products may also be used. As the commercial product, for example, Eleminol JS-2 of Sanyo Chemical Industries, Ltd. can be used, which is the compound represented by General Formula (35) with m=12.

In addition, examples of the anionic polymerizable surfactant used in the invention include a sodium methacryloyioxypolyoxyalkylene sulfate ester salt represented by General Formula (36). In the following formula, n is 1 to 20.

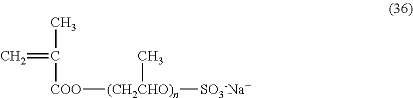

As the anionic polymerizable surfactant, commercial products may also be used. As the commercial product, for example, Eleminol RS-30 of Sanyo Chemical Industries, Ltd. can be used, which is a compound represented by General Formula (36) with n=9.

In addition, as the anionic polymerizable surfactant used in the invention, for example, a compound represented by General Formula (37) can be used.

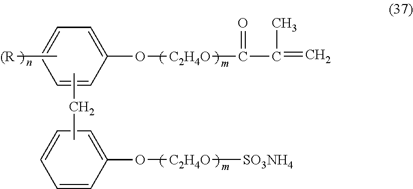

As the anionic polymerizable surfactant, commercial products may also be used, to which Antox MS-60 of Nippon Nyukazai Co., Ltd. corresponds.

The anionic polymerizable surfactants exemplified above may be used alone or as a mixture of two or more kinds thereof.

In addition, the organic polymer constituting the shell body 22 preferably includes a repeating structural unit derived from a hydrophobic monomer.

This hydrophobic monomer has at least a hydrophobic group and a polymerizable group in the molecular structure thereof. By including such a hydrophobic monomer, it is possible to improve the hydrophobic property and the polymerizable property of the shell body 22. As a result, it is possible to promote the improvement of the mechanical strength and the durability of the shell body 22.

Among these, examples of the hydrophobic group include at least one of an aliphatic hydrocarbon group, an alicyclic hydrocarbon group, and an aromatic hydrocarbon group.

Examples of the alicyclic hydrocarbon group include a methyl group, an ethyl group, and a propyl group, examples of the aliphatic hydrocarbon group include a cyclohexyl group, an dicyclopentenyl group, a dicyclopentanyl group, and an isobornyl group, and examples of the aromatic hydrocarbon group include a benzyl group, a phenyl group, and a naphthyl group.

In addition, as the polymerizable group, an unsaturated hydrocarbon group capable of radical polymerization, which is one selected from a group consisting of a vinyl group, an allyl group, an acryloyl group, a methacryloyl group, a propenyl group, a vinylidene group, and a vinylene group, is preferable.

Specific examples of the hydrophobic monomer include styrene and styrene derivatives such as methyl styrene, dimethyl styrene, chlorostyrene, dichlorostyrene, bromostyrene, p-chloromethylstyrene, and divinylbenzene; monofunctional acrylic esters as methyl acrylate, ethyl acrylate, n-butyl acrylate, butoxyethyl acrylate, benzyl acrylate, phenyl acrylate, phenoxyethyl acrylate, cyclohexyl acrylate, dicyclopentanyl acrylate, dicyclopentenyl acrylate, dicyclopentenyloxyethyl acrylate, tetrahydrofurfuryl acrylate, and isobornyl acrylate; monofunctional methacrylic esters such as methyl methacrylate, ethyl methacrylate, n-butyl methacrylate, 2-ethylhexyl methacrylate, butoxymethyl methacrylate, benzyl methacrylate, phenyl methacrylate, phenoxyethyl methacrylate, cyclohexyl methacrylate, dicyclopentanyl methacrylate, dicyclopentenyl methacrylate, dicyclopentenyloxyethyl methacrylate, tetrahydrofurfuryl methacrylate, and isobornyl methacrylate; allyl compounds such as allyl benzene, allyl-3-cyclohexane propionate, 1-allyl-3,4-dimethoxybenzene, allylphenoxy acetate, allylphenyl acetate, allylcyclohexane, and polyhydric allyl carbonate; esters of fumaric acid, maleic acid, or itaconic acid; and monomers having radically polymerizable group such as N-substituted maleimide or cyclic olefin. The hydrophobic monomers are appropriately selected to satisfy the required characteristics described above and the addictive amount thereof is arbitrarily determined.

In addition, the organic polymer constituting the shell body 22 preferably includes a repeating structural unit derived from a crosslinkable monomer and/or a repeating structural unit derived from a monomer represented by the following general formula (B):

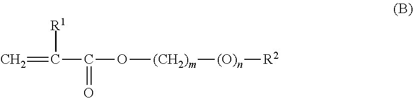

[in which R¹ represents a hydrogen atom or a methyl group, R² represents a t-butyl group, an alicyclic hydrocarbon group, an aromatic hydrocarbon group, or a heterocyclic group, m represents an integer of 0 to 3, and n represents an integer of 0 or 1].

By incorporating a repeating structural unit derived from a crosslinkable monomer in the organic polymer constituting the shell body 22, a more refined crosslinked structure is formed in the polymer. Thus, it is possible to improve the mechanical strength of the shell body 22, and in turn of the electrophoretic particle 1.

By incorporating the repeating structural unit derived from the monomer represented by General Formula (B) in the organic polymer, the flexibility of a molecule of the shell body 22 is decreased, that is, due to the migratability of a molecule being constrained, depending on the R² group which is a “bulky” group, the mechanical strength of the shell body 22 is improved. In addition, by the R² group, which is a “bulky” group present in the shell body 22, the solvent resistance of the shell body 22 is improved. In General Formula (B), examples of the alicyclic hydrocarbon group represented by R² include a cycloalkyl group, a cycloalkenyl group, an isobornyl group, a dicyclopentanyl group, a dicyclopentenyl group, an adamantane group, and a tetrahydrofuran group.

Specific examples of the crosslinkable monomer include a monomer having a compound which has two or more unsaturated hydrocarbon groups of one or more kinds selected from a vinyl group, an allyl group, an acryloyl group, a methacryloyl group, a propenyl group, a vinylidene group, and a vinylene group, for example, ethylene glycol diacrylate, diethylene glycol diacrylate, triethylene glycol diacrylate, tetraethylene glycol diacrylate, polyethylene glycol diacrylate, allyl acrylate, bis(acryloxyethyl)hydroxyethyl isocyanurate, bis(acryloxy neopentylglycol) adipate, 1,3-butylene glycol diacrylate, 1,6-hexanediol diacrylate, neopentyl glycol diacrylate, propylene glycol diacrylate, polypropylene glycol diacrylate, 2-hydroxy-1,3-diacryloxypropane, 2,2-bis[4-(acryloxy)phenyl]propane, 2,2-bis[4-(acryloxyethoxy)phenyl]propane, 2,2-bis[4-(acryloxyethoxydiethoxy)phenyl]propane, 2,2-bis[4-(acryloxyethoxypolyethoxy)phenyl]propane, hydroxy pivalic acid neopentyl glycol diacrylate, 1,4-butanediol diacrylate, dicyclopentanyl diacrylate, dipentaerythritol hexaacrylate, dipentaerythritol monohydroxy pentaacrylate, ditrimethylolpropane tetraacrylate, pentaerythritol triacrylate, tetrabromobisphenol A diacrylate, triglycerol diacrylate, trimethylolpropane triacrylate, tris(acryloxyethyl) isocyanurate, ethylene glycol dimethacrylate, diethylene glycol dimethacrylate, triethylene glycol dimethacrylate, tetraethylene glycol dimethacrylate, polyethylene glycol dimethacrylate, propylene glycol dimethacrylate, polypropylene glycol dimethacrylate, 1,3-butylene glycol dimethacrylate, 1,4-butanediol dimethacrylate, 1,6-hexanediol dimethacrylate, neopentyl glycol dimethacrylate, 2-hydroxy-1,3-dimethacryloxyl propane, 2,2-bis[4-(methacryloxy)phenyl]propane, 2,2-bis[4-(methacryloxyethoxydiethoxy)phenyl]propane, 2,2-bis[4-(methacryloxyethoxy)phenyl]propane, 2,2-bis[4 (methacryloxyethoxypolyethoxy)phenyl]propane, tetrabromobisphenol A dimethacrylate, dicyclopentanyl dimethacrylate, dipentaerythritol hexamethacrylate, glycerol dimethacrylate, hydroxy pivalic acid neopentyl glycol dimethacrylate, dipentaerythritol monohydroxy pentamethacrylate, ditrimethylolpropane tetramethacrylate, pentaerythritol trimethacrylate, pentaerythritol tetramethacrylate, triglycerol dimethacrylate, trimethylolpropane trimethacrylate, tris(methacryloxyethyl)isocyanurate, allyl methacrylate, divinylbenzene, diallyl phthalate, diallyl terephthalate, diallyl isophthalate, and diethylene glycol bisallyl carbonate.

Specific examples of the monomer represented by General Formula (B) include the following monomers.

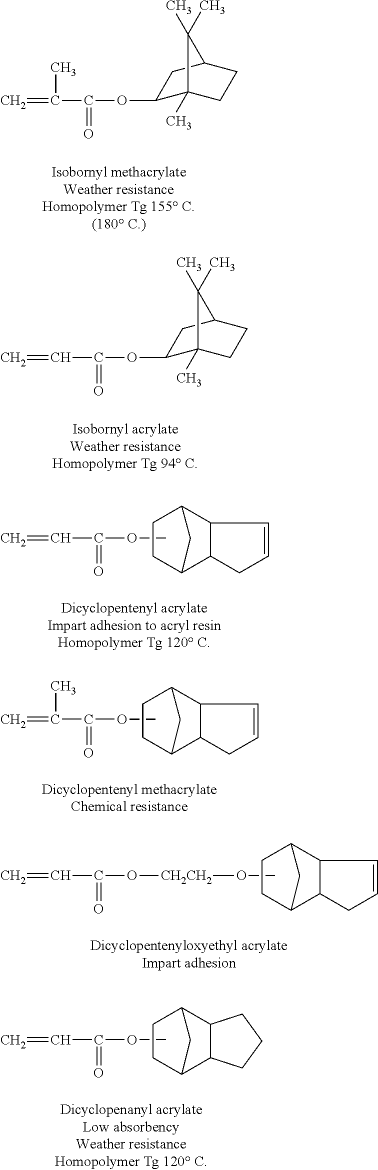

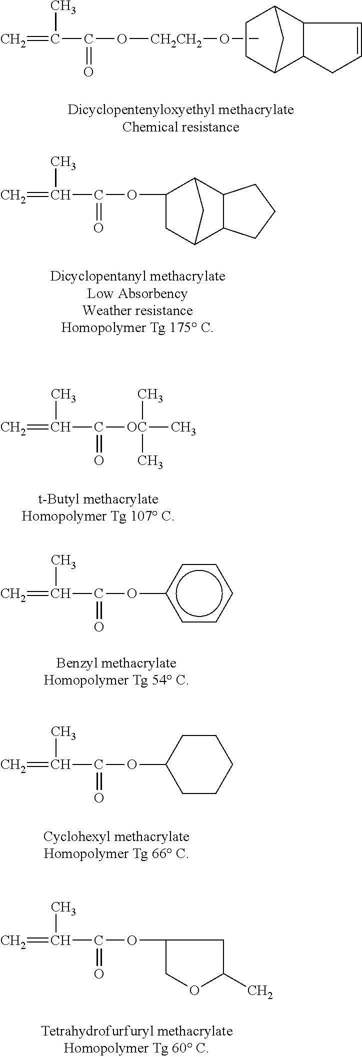

[3] Next, the second polymerizable surfactant 62 having a hydroxyl group as the second polar group 621, a hydrophobic group 622, and a polymerizable group 623 is added to the aqueous dispersion 90 as shown in FIG. 3B, and then emulsified as shown in FIG. 3C.

Furthermore, the electrification amount on the surface of the shell body 22 can be controlled by setting at least one condition out of the conditions selected from (A) the number of the second polar groups (hydroxyl groups) 621 in the second polymerizable surfactant 62, and (B) the additive amount of the second polymerizable surfactant 62 in the present processes.

Furthermore, the additive amount of the second polymerizable surfactant 62 is preferably in the range of approximately 1-fold mole to 10-fold moles, and more preferably in the range of approximately 1-fold mole to 5-fold moles, with respect to the first polymerizable surfactant 61 added in the process [2]. By setting the additive amount of the second polymerizable surfactant 62 to 1-fold mole or more of the first polymerizable surfactant 61 added, it is possible to more accurately control the electrification amount of the shell body 22. On the other hand, by setting the additive amount of the second polymerizable surfactant 62 to 10-fold moles or less of the first polymerizable surfactant 61 added, it is possible to prevent the occurrence of a hydrophilic monomer which does not contribute to formation of the shell body 22 and prevent the occurrence of a polymer particle in which a core material is not present except for the particle 2.

In addition, the aqueous dispersion 90 may be irradiated with ultrasonic waves for a predetermined time as necessary. In this manner, the arrangement pattern of the second polymerizable surfactant 62 which is present around the particle 2 is controlled to an extremely high degree.

As the second polymerizable surfactant 62, among the polymerizable surfactants included as the first polymerizable surfactant as described above, a polymerizable surfactant having the second polar group (hydroxyl group) 621 is used so as to react with a polymerization initiator having a polymerization initiating group in the subsequent process [5]. That is, an anionic polymerizable surfactant having an alkoxide anionic group (—O⁻) as an anionic group is used.

[4] Next, the polymerization initiator 80 is added to the aqueous dispersion 90 as shown in FIG. 3C to cause a polymerization reaction to occur. In this manner, the particle (encapsulated mother particle) 2, made by engulfing the mother particle 21 in the form of a capsule by the shell body 22 constituted with the organic polymer, is obtained.

At this time, the temperature of the aqueous dispersion 90 is heated up to a predetermined temperature (the temperature at which the polymerization initiator 80 is activated) as necessary. In this manner, it is possible to reliably activate the polymerization initiator 80 and allow the polymerization reaction in the aqueous dispersion 90 to suitably proceed.

As the polymerization initiator 80, a water-soluble polymerization initiator is preferable, and examples thereof include potassium persulfate, ammonium persulfate, sodium persulfate, 2,2-azobis-(2-methylpropion amidine)dihydrochloride, and 4,4-azobis(4-cyanovaleric acid), and one kind or a combination of two or more kinds thereof may be used.

Here, according to an emulsion polymerization method which is polymerization in the aqueous dispersion 90 as explained above, it is presumed that the first polymerizable surfactant 61 and the respective monomers show the following behavior in the aqueous dispersion 90. Here, a case of further adding a hydrophobic monomer in the process [2] will be described below.

First, the first polymerizable surfactant 61 is adsorbed onto the charge 64 included in the particle 2 in the aqueous dispersion 90, and next, the aqueous dispersion 90 is irradiated with ultrasonic waves. Then, a hydrophobic monomer and a second polymerizable surfactant 62 are added to the aqueous dispersion 90, and irradiated with ultrasonic waves. Thus, the arrangement pattern of the first polymerizable surfactant 61 present around the particle 2 and the monomer is controlled to an extremely high degree, and as a result, the first polar group 611 is aligned toward the center of the particle 2 on the innermost shell. Further, a state where the second polar group 621 is aligned toward the aqueous dispersion 90 (the outer side of the particle 2) on the outermost shell is formed. Further, the monomer is transformed into an organic polymer to form the shell body 22, as the pattern which is controlled to a high degree by emulsion polymerization, the particle 2, made by engulfing the mother particle 21 in the form of a capsule by the shell body 22, is formed.

According to the above method, it is possible to decrease the production of a water-soluble oligomer or polymer, which is a by-product. Thus, it is possible to reduce the viscosity of the aqueous dispersion 90 in which the obtained particles 2 are dispersed, and therefore, further facilitate the purification process such as ultrafiltration.

The polymerization reaction as described above is preferably carried out in a reactor vessel provided with an ultrasonic generator, a mixer, a reflux condenser, a dropping funnel, and a temperature regulator.

By increasing the temperature up to the cleavage-temperature of the polymerization initiator 80 which has been added to the reaction system (the aqueous dispersion 90), a polymerization reaction makes the polymerization initiator 80 cleave to generate initiator radicals. By the initiator radicals attacking unsaturated groups of the respective polymerizable surfactants 61 and 62 or unsaturated groups of the monomers, the polymerization reaction is initiated.

The addition of the polymerization initiator 80 into the reaction system can be carried out, for example, by dripping a solution in which the water-soluble polymerization initiator 80 is dissolved into the pure water, into the reactor vessel. At this time, a solution including the polymerization initiator 80 in the aqueous dispersion 90 which is heated up to the temperature at which the polymerization initiator 80 is activated may be added all at once or separately, or may be continuously added.

In addition, after adding the polymerization initiator 80, the aqueous dispersion 90 may be heated up to the temperature at which the polymerization initiator 80 is activated.

Moreover, as described above, it is preferable that a water-soluble polymerization initiator is used as a polymerization initiator 80 and a solution obtained by dissolving this into the pure water is added by dripping it into the aqueous dispersion 90 in the reactor vessel. In this manner, the added polymerization initiator 80 is cleaved, the initiator radical is generated, and by attacking a polymerizable group of the respective polymerizable surfactants 61 and 62 or a polymerizable group of a polymerization monomer, the polymerization reaction occurs. The polymerization temperature and the polymerization reaction time vary depending on the type of the polymerization initiator 80 used and the type of the polymerization monomer, but a person skilled in the art can facilitate the process to arbitrarily set the preferable polymerization conditions.

The activation of the polymerization initiator 80 in the reaction system can be suitably carried out by heating up the aqueous dispersion 90 to a predetermined polymerization temperature as described above. The polymerization temperature is preferably set to be in the range of 60° C. to 90° C. In addition, the polymerization time is preferably set to from 3 hours to 10 hours.

The particle 2 obtained as described above becomes a particle in which the mother particle 21 is engulfed by the shell body 22.

Here, in the preparation process of the particle 2 thus obtained, one example of the behavior shown in the respective polymerizable surfactants and the respective monomers will be described in more detail, based on FIGS. 4A and 4B.

When the first polymerizable surfactant 61 is added to the aqueous dispersion 90, the charge 64 included in the mother particle 21 and the first polar group 611 of the first polymerizable surfactant 61 are ionically bonded to each other. By the opposite polarities being bonded to each other, both polarities (the charge 64 and the first polar group 611) are cancelled.

In addition, the first hydrophobic group 612 of the first polymerizable surfactant 61 faces the hydrophobic group 622 of the second polymerizable surfactant 62, and the second polar group (hydroxyl group) 621 of the second polymerizable surfactant 62 is aligned toward the side of the aqueous dispersion 90 (the outer side of the particle 2), thereby forming a micelle-like structure as shown in FIG. 4A.

When the polymerization reaction is carried out in this state, the shell body 22 constituted with an organic polymer as shown in FIG. 4B with the above structure maintained is formed on the surface of the mother particle 21 in the state where the second polar group (hydroxyl group) 621 exposed on the surface. That is, the arrangement pattern of each of the polymerizable surfactants 61 and 62 which are present around the mother particle 21 before the polymerization reaction is controlled to an extremely high level. Then, by an emulsion polymerization reaction, each of the polymerizable surfactants 61 and 62, and each of the monomers are transformed into organic polymers as a pattern which has been controlled to a high degree. Therefore, the particle 2 prepared by the above method has the second polar group (hydroxyl group) 621 exposed on the surface thereof. The structure of this particle 2 is controlled with an extremely high degree of accuracy.

In addition, one example of other behaviors shown in the respective polymerizable surfactants and the respective monomers will be described, based on FIGS. 5A and 5B.

In the first polymerizable surfactant 61, the first polar group 611 is aligned toward the mother particle 21 having the negative charge 64 and absorbed onto the mother particle 21 with ionically strong bonds as shown in FIG. 5A. On the other hand, the hydrophobic group 612 and the polymerizable group 613 of the first polymerizable surfactant 61 face the hydrophobic group 622 and the polymerizable group 623 of the second polymerizable surfactant 62, respectively, by the hydrophobic interaction, and as a result, as a result, the second polar group 621 faces a direction in which the aqueous dispersion 90 is present, that is, in a direction away from the mother particle 21.

In addition, the surface of the mother particle 21 has a negative charge 64 which is chemically bonded with the specific density and a hydrophobic area 70 between the negative charges 64, and in the hydrophobic area 70, a hydrophobic group 612″ and a polymerizable group 613″ of another first polymerizable surfactant 61″ face. Then, the first polymerizable surfactant 61 is arranged so that the first polar group 611 thereof faces the first polar group 611″ of another first polymerizable surfactant 61″. Each hydrophobic group 612 and each polymerizable group 613 of the first polymerizable surfactant 61 face the hydrophobic group 622 and the polymerizable group 623 of the second polymerizable surfactant 62, respectively, by the hydrophobic interaction, and as a result, the second polar group (hydroxyl group) 621 faces a direction in which the aqueous dispersion 90 is present, that is, in a direction away from the particle 2.

For example, the polymerization initiator 80 is added to the aqueous dispersion 90 in such a dispersion state to polymerize each of the polymerizable groups 613, 613″, and 623 of the first polymerizable surfactants 61 and 61″, and the second polymerizable surfactant 62. Thus, the particle 2 in which the mother particle 21 is engulfed by the shell body 22′ is prepared as shown in FIG. 5B.

Each of the polymerizable surfactants 61 and 62 forms a micelle-like structure in which the second polar group 621 of the second polymerizable surfactant 62 in the outermost shell is aligned toward the side of the aqueous dispersion 90 after the charge 64 included in the mother particle 21 and the first polar group 611 of the first polymerizable surfactant 61 are ionically bonded in the polymerization system, and then forms the shell body 22 by generating an organic polymer by a polymerization reaction. Thus, the arrangement pattern of a monomer present around the mother particle 21 before the emulsion polymerization affects the state of the polarization in the vicinity of the mother particle 21 after the polymerization, and therefore, it may be said that it is possible to control the process with an extremely high degree of accuracy.

As a result, the obtained particle 2, in which the second polar group (hydroxyl group) 621 is arranged outside thereof, becomes a particle having electrification polarity which depends on the hydroxyl group. Further, the particle 2 has charges in the electrification amount which depends on the number of the second polar group 621 in the second polymerizable surfactant 62, the molecular weight of the second polymerizable surfactant 62, and the additive amount of the second polymerizable surfactant 62.

Furthermore, in the polymerization reaction, one kind or two or more kinds of each of the polymerizable surfactants, a hydrophobic monomer, a crosslinkable monomer, a compound represented by General Formula (1) and other well-known polymerization monomers may be respectively used.

In addition, since the emulsion polymerization reaction is carried out using an ionic polymerizable surfactant, the state of emulsion of a mixed solution including raw material monomers is good without using an emulsifying agent in many cases. Therefore, it is not necessary to use the emulsifying agent, but at least one selected from a group consisting of well-known anionic, non-ionic, and cationic emulsifying agents may be used as necessary.

[5] Next, by drying the aqueous dispersion 90 including the particles 2 as shown in FIG. 3D, a dried product 86 of the particles 2 is obtained.

Here, since the hydroxyl group (—OH group) is exposed from the surface of the shell body 22, a hydrogen bond is generated between the hydroxyl groups of the shell body 22 provided in the adjacent particles 2. As a result, an aggregate in which a plurality of particles 2 are aggregated with each other is formed in the dried product 86.

The drying of the aqueous dispersion 90 can be carried out by various drying methods such as freeze drying, through-flow drying, surface drying, fluidization drying, flash drying, spray drying, vacuum drying, infrared ray drying, high-frequency drying, ultrasonic wave drying, and pulverization drying, for example. Among these drying methods, freeze drying is preferable. According to the freeze drying, it is possible to dry the particle 2 mostly without affecting the original shapes, functions, or the like in the shell body 22 included in the particle 2 due to the drying by sublimation of the aqueous dispersion 90 from solid to liquid.

In addition, as this freeze drying method, the same method as described in the subsequent process [9] can be used.

Moreover, it is preferable to carry out a purification process such as ultrafiltration, for purifying the particles 2 in the aqueous dispersion 90 before drying the aqueous dispersion 90. In this manner, it is possible to remove the water-soluble oligomers or polymers, included as a by-product in the aqueous dispersion 90, and thus, the content of the particles 2 in the dried product 86 can be increased.

In the present embodiment, by carrying out the processes [1] to [5] as described above, an aggregate in which the particles 2 are aggregated with each other due to a hydrogen bond generated from the hydroxyl group is prepared.

[6] Next, a polymerization initiating group-containing compound (compound provided with a functional group Z) I¹ having a functional group Z having reactivity with the second polar group (hydroxyl group) 621 and a polymerization initiating group A are added to the dried product (aggregated) 86, and mixed, as shown in FIG. 3E, to obtain a mixture 85 (first process). This process is preferably carried out in an inert gas atmosphere such as an argon gas and a nitrogen gas.

Here, as described in the process [5], an aggregate in which the particles 2 are aggregated with each other is formed in the dried product 86. In the present embodiment, the content of the polymerization initiating group-containing compound I¹ except for the dried product 86 (particles 2) in the mixture 85 is set to a high content (high concentration) which is 75% by weight or more. In the mixture 85, the polymerization initiating group-containing compound I¹ is linked to the surface of the particles 2. At this time, since the polymerization initiating group-containing compound I¹ is present at a high content as described above, the affinity of the particles 2 having the polymerization initiating group-containing compound I¹ linked to the surface thereof for the mixture 85 is increased, and thus, the particles are easily dispersed in the mixture 85. Thus, the aggregation between the particles 2 is easily dissociated, and thus, the ratio of particles having a large particle diameter, considered to have aggregates from a plurality of particles 2, can be reduced. In addition, the polymerization initiating group-containing compound I¹ can be linked to approximately the entire surface of the particles 2. As a result, the particles 2 having the polymerization initiating group-containing compound I¹ linked to the surface thereof are dispersed in the mixture 85 (see FIG. 3F).

Furthermore, hereinafter, “the content of the polymerization initiating group-containing compound I¹ except for the dried product 86 (particles 2) in the mixture 85” is simply referred to as “the content of the polymerization initiating group-containing compound I¹” in some cases for the sake of convenience in description.

In the present embodiment, it is presumed that the linking of the polymerization initiating group-containing compound I¹ to approximately the entire surface of the particles 2 as described above is due to a mechanism as follows.

That is, when an aggregate of the particles 2 which are aggregated by hydrogen bonds between the hydroxyl groups exposed from the surface thereof is engulfed by the polymerization initiating group-containing compound I¹ at a high concentration (see FIG. 6A), the hydroxyl group exposed from the outermost surface of the aggregate is reacted with the functional group Z contained in the polymerization initiating group-containing compound I¹. Further, after the reaction, a sufficient amount of the unreacted polymerization initiating group-containing compound I¹ is present near the position. By this, as shown in FIG. 6B, the affinity of a site derived from the polymerization initiating group-containing compound I¹ bonded to the surface of the particles 2 for the polymerization initiating group-containing compound I¹ in the mixture 85 becomes higher than the aggregation force due to a hydrogen bond or the like, exerted between the particles 2 having the polymerization initiating group-containing compound I¹ bonded to the surface thereof and other particles 2. As a result, the particles 2 are dispersed in the mixture 85. Thus, the reaction between the hydroxyl groups exposed on the surface of the other particles 2 and the functional group Z contained in the polymerization initiating group-containing compound I¹ further proceeds with such a reaction being repeated, and thus, consequently, the aggregation between the particles 2 is dissociated. As a result, as shown in FIG. 6C, it is presumed that the particles 2 having the polymerization initiating group-containing compound I¹ linked to approximately the entire surface thereof are mono-dispersed in the mixture 85.

By the reaction between the second polar group (hydroxyl group) 621 and the functional group Z as described above, the polymerization initiating group-containing compound I¹ is linked to approximately the entire surface of the shell body 22 (particles 2). That is, the polymerization initiating group A provided in the polymerization initiating group-containing compound I¹ is introduced into the surface of the particles 2. With this polymerization initiating group-containing compound I¹, in the subsequent process [7], the monomers are polymerized from the polymerization initiating group A as a starting point to form a polymer 32. Accordingly, a polymerization initiating group-containing compound I¹ having a polymerization initiating group A constitutes a connecting part for connecting (linking) the shell body 22 to the polymer 32.

The polymerization initiating group-containing compound I¹ (the “compound provided with a functional group Z” in the present embodiment) is a compound having a functional group Z having reactivity with the second polar group (hydroxyl group) 621 and a polymerization initiating group A, as described above.

Among these, examples of the functional group Z include a halogenated carboxyl group and a halogenated sulfonic acid, and one of them is selected. Since such a halogenated acidic group has excellent reactivity with a hydroxyl group, the polymerization initiating group-containing compound I¹ can be reliably linked to the surface of the shell body 22.

In addition, the polymerization initiating group A may be polymerized with monomers from a polymerization initiating group as a starting point, and examples thereof include a functional group which is polymerized by atom transfer radical polymerization (ATRP), a functional group which is polymerized by nitroxide-mediated polymerization (NMP), a functional group which is polymerized by reversible addition-fragmentation chain transfer polymerization (RAFT), and a functional group which is polymerized by living radical polymerization (TERP) using an organotellurium compound, but among these, a functional group which is polymerized by atom transfer radical polymerization is preferable. In this manner, it is possible to allow living radical polymerization in which the polymerization initiating group A is reacted with the monomer to more effectively proceed.

Examples of such a polymerization initiating group A include functional groups derived from organic halides represented by the following general formula (1):

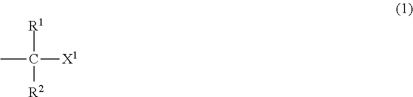

[in Formula (1), R¹ and R² each independently represent a group selected from hydrogen and an alkyl group having 1 to 20 carbon atoms, in which arbitrary —CH₂— may be substituted with —O— or a cycloalkylene group, and X¹ represents chlorine, bromine, or iodine].

Accordingly, specific examples of the polymerization initiating group-containing compound I¹ include acid halogenated compounds (acid halides) represented by the following general formula (2) or (3):

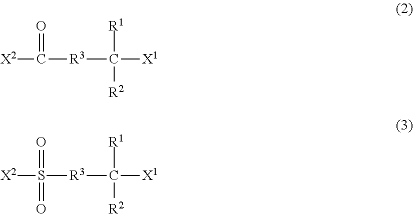

[in Formulae (2) and (3), R¹ and R² each independently represent a group selected from hydrogen and an alkyl group having 1 to 20 carbon atoms, in which arbitrary —CH₂— may be substituted with —O— or a cycloalkylene group, R³ represents a group selected from a single bond, hydrogen, and an alkylene or arylene group having 1 to 20 carbon atoms, and X¹ and X² each independently represent chlorine, bromine, or iodine].

In addition, the groups R¹ and R² in General Formulae (1) to (3) are each preferably an alkyl group having 1 to 3 carbon atoms. Particularly, it is preferably an alkyl group having 1 carbon atom. Further, the group R³ in General Formulae (1) to (3) is preferably a single bond or an arylene group having 5 or 6 carbon atoms, and more preferably a single bond. Thus, since the dispersibility of the particles 2 into the mixture 85 is improved, it is possible to allow the reaction between the polymerization initiating group-containing compound I¹ and the surface of the shell body 22 (particles 2) to further proceed.

From the above points, as the polymerization initiating group-containing compound I¹, a compound represented by the following general formula (4) or (5) is preferably used:

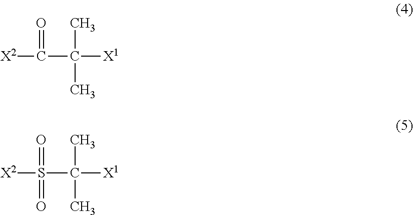

[in Formulae (4) and (5), X¹ and X² each independently represent chlorine, bromine, or iodine].

In the present embodiment, the content of the polymerization initiating group-containing compound I¹ may be 75% by weight or more, but it is preferably 85% by weight or more, more preferably 95% by weight or more, and still more preferably 100% by weight. Thus, the affinity of a site derived from the polymerization initiating group-containing compound I¹ bonded to the surface of the particles 2 for the polymerization initiating group-containing compound I¹ in the mixture 85 becomes higher than the aggregation force due to a hydrogen bond or the like, exerted between the particles 2 having the polymerization initiating group-containing compound I¹ bonded to the surface thereof and other particles 2. As a result, the dispersibility of the particles 2 into the mixture 85 can be further improved.

Moreover, in the case where the content of the polymerization initiating group-containing compound I¹ is set to 75% by weight or more and less than 100% by weight, a solvent is added to the mixture 85 so as to set the content of the polymerization initiating group-containing compound I¹ to the range described above. This solvent is preferably a non-polar solvent or a low-polarity solvent. Thus, an acid halogenated compound represented by General Formula (2) or (3), which is used as the polymerization initiating group-containing compound I¹, can be prevented from being decomposed by the solvent.

Such a non-polar solvent or the low-polarity solvent is not particularly limited, examples thereof include hexane, cyclohexane, benzene, toluene, xylene, diethylether, chloroform, ethyl acetate, methylene chloride, isooctane, decane, dodecane, tetradecane, and tetrahydrofuran, and one kind or a combination of two or more kinds thereof may be used.

[7] Next, a monomer M and a catalyst are added to the mixture 85 and a polymer 32 is formed by polymerizing the monomer M from the polymerization initiating group A contained in the polymerization initiating group-containing compound I¹ as a starting point using living radical polymerization as shown in FIG. 3F (third process).

In this manner, the electrophoretic particle 1 provided with a coating layer 3 constituted with the polymer 32 on the surface of the particles 2 is obtained as shown in FIG. 3G, by linking the polymer 32 to the surface of the particles 2 through the polymerization initiating group-containing compound I¹.

As the catalyst, a catalyst which can set a growth terminal as a polymerizable group in the growth process of the polymer 32 or a catalyst in which Lewis acidity is relatively low, is used. Examples of such a catalyst include a halide of a transition metal such as Cu, Fe, Au, Ag, Hg, Pd, Pt, Co, Mn, Ru, Mo, and Nb, and a transition metal complex in which an organic group such as copper phthalocyanine is aligned as a ligand, but among these, a catalyst having a halide of a transition metal as a major component is preferable.

When the monomer M and the catalyst are added to the mixture 85, the polymerization initiating group A comes into contact with the monomer M and the polymerization reaction occurs between them. In addition, the growth terminal always becomes the polymerization initiating group A in the growth process of the polymer 32, and further, the polymerization reaction occurs between the polymerization initiating group and the polymerizable group of the monomer to synthesize (produce) the polymer 32.

Here, in living radical polymerization, since the growth terminal always has polymerization activation in the growth process of a polymer, after a monomer is consumed and the polymerization reaction is stopped, the polymerization reaction further proceeds by newly adding a monomer.

Therefore, as a result of adjusting the amount of monomer which is supplied to the reaction system, the reaction time and the amount of catalyst depending on a desired polymerization degree, it is possible to accurately control the number of the structural unit, derived from a monomer included in the polymer 32 to be synthesized.

In addition, since it is possible to obtain the polymer 32 in which the distribution of polymerization degree is uniform, it is possible to set the film thickness of a coating layer 3 which is formed, as a relatively uniform cover layer.

According to this, it is possible to form the polymer 32 having a desired polymerization degree using a simple process while minimizing variability of each electrophoretic particle 1. As a result, the electrophoretic particle 1 exhibits excellent dispersibility and migratability in the electrophoretic dispersion as described later.

Furthermore, it is preferable for the solution (reaction liquid) containing a monomer M and a catalyst to conduct a deoxygenation treatment before starting the polymerization reaction. Examples of the deoxygenation treatment include a substitution or purge treatment after vacuum degassing by inert gases such as an argon gas and a nitrogen gas.

In addition, at the time of the polymerization reaction, by heating up (warming up) the temperature of the mixture 85 to a predetermined temperature (a temperature at which a monomer and a catalyst become active), it is possible to more promptly and reliably carry out the polymerization reaction of monomers.

The heating temperature varies slightly depending on the type of a catalyst, or the like, but is not particularly limited and is preferably approximately 30° C. to 100° C. In addition, the heating time (reaction time) is preferably approximately 10 hours to 20 hours in the case of setting the heating temperature as the range described above.

In this manner, the electrophoretic particle 1 is prepared.

[8] Next, the electrophoretic particle 1 is collected from the mixture 85 as necessary.

As a collecting method, various filtration methods such as ultrafiltration, nanofiltration, microfiltration, cake filtration, and reverse osmosis are included and one kind or a combination of two or more kinds thereof can be used. Among these, ultrafiltration is particularly preferably used.

Ultrafiltration is a method for filtering fine particles, which is suitably used as a method for filtering the electrophoretic particle 1.

[9] Next, the electrophoretic particle 1 is dried as necessary.

The drying of the electrophoretic particle 1, for example, is carried out by various drying methods such as freeze drying, through-flow drying, surface drying, fluidization drying, flash drying, spray drying, vacuum drying, infrared ray drying, high-frequency drying, ultrasonic wave drying, and pulverization drying, but the drying is preferably carried out by freeze drying.

According to the freeze drying, it is possible to dry the shell body 22 mostly without affecting the original shapes, functions, or the like in the shell body 22 included in the electrophoretic particle 1 due to the drying by sublimation of the mixture 85 from solid to liquid.

Hereinafter, a method for freeze drying the electrophoretic particle 1 will be described.

First, the electrophoretic particle 1 which is separated out from the mixture 85 by filtration is cooled and frozen. In this manner, a liquid-phase component (liquid component) such as a solvent included in the electrophoretic particle 1 is changed to a solid.

The cooling temperature is not particularly limited as long as cooling temperature is equal to or lower than the temperature at the liquid-phase component is frozen, but it is preferably approximately −100° C. to −20° C., and more preferably −80° C. to −40° C. If the cooling temperature is higher than the range of the temperature described above, there is a case where the liquid-phase component is unable to be sufficiently solidified. On the other hand, if the cooling temperature is lower than the range of the temperature described above, it is not possible to expect the solidification of the liquid-phase component any more.

Next, the surrounding area of the frozen electrophoretic particle 1 is reduced in pressure. In this manner, the boiling point of the liquid-phase component is decreased, and therefore, it is possible to sublimate the liquid-phase component.

The pressure during the reduction of pressure varies depending on the composition of the liquid-phase component, but it is preferably approximately 100 Pa or less, and more preferably approximately 10 Pa or less. If the pressure during the reduction of pressure is within the range described above, it is possible to more reliably sublimate the liquid-phase component.

In addition, since the pressure of the surrounding area of the electrophoretic particle 1 along with the sublimation of the liquid-phase component is increased, it is preferable to continuously exhaust using a vacuum pump or the like during freeze drying and maintain a constant level of pressure. In this manner, it is possible to prevent an increase in the pressure and prevent a decrease in the efficiency of the sublimation of the liquid-phase component.

In this manner, it is possible to carry out freeze drying of the electrophoretic particle 1.

### Other Configuration Examples of Method for Preparing Electrophoretic Particles

Furthermore, in the present embodiment, the electrophoretic particle 1 can also be prepared by other preparation methods having other Configuration Examples as shown below, in addition to the method for preparing electrophoretic particles as described above.

### First Other Configuration Example

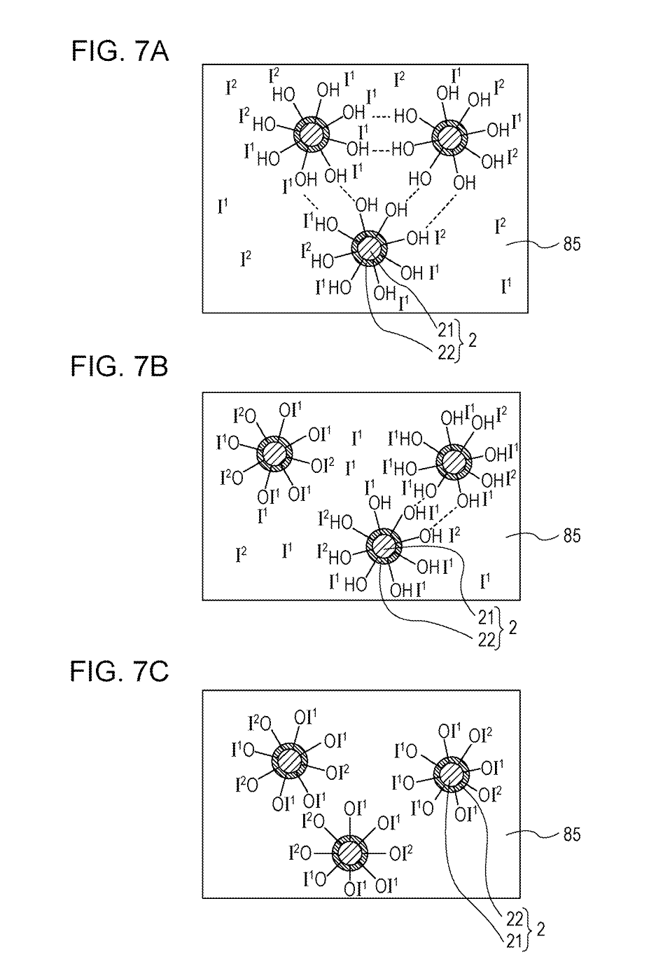

FIGS. 7A to 7C are each a schematic view for explaining a mechanism in which an aggregated particles are gradually dissociated and the particles having a polymerization initiating group-containing compound and a non-polymerization initiating group-containing compound linked to the surface thereof are dispersed in the mixture.

In the first other Configuration Example, the same method as the method for preparing electrophoretic particles except that the following process [6A] is carried out instead of the process [6] is applied. Specifically, the polymerization initiating group-containing compound I¹ and the non-polymerization initiating group-containing compound I² are linked to the surface of the particles 2.

[6A] In this first other Configuration Example, the polymerization initiating group-containing compound I¹ is added to the dried product 86 obtained in the process [5], and a positively or negatively charged non-polymerization initiating group-containing compound (charged compound) I² having a functional group Z having no polymerization initiating group A is further added thereto and mixed to obtain the mixture 85.

At this time, in the dried product 86, an aggregate in which the particles 2 are aggregated with each other is formed, but in the present Configuration Example, the total content of the polymerization initiating group-containing compound I¹ and the non-polymerization initiating group-containing compound I² except for the dried product 86 (particles 2) in the mixture 85 is set to a high content (high concentration) which is 75% by weight or more. Thus, in the mixture 85, the aggregation between the particles 2 is dissociated, and the polymerization initiating group-containing compound I¹ and the non-polymerization initiating group-containing compound I² are linked to approximately the entire surface of the particles 2. Thus, the particles 2 having the polymerization initiating group-containing compound I¹ and the non-polymerization initiating group-containing compound I² linked to the surface thereof are dispersed in the mixture 85.

Furthermore, hereinafter, “the total content of the polymerization initiating group-containing compound I¹ and the non-polymerization initiating group-containing compound I² except for the dried product 86 (particles 2) in the mixture 85” is simply referred to as “the total content of the polymerization initiating group-containing compound I¹ and the non-polymerization initiating group-containing compound I²” in some cases for the sake of convenience in description.

In the present embodiment, it is presumed that the linking of the polymerization initiating group-containing compound I¹ and the non-polymerization initiating group-containing compound I² to approximately the entire surface of the particles 2 as described above is due to a mechanism as follows.

That is, when an aggregate of the particles 2 which are aggregated by hydrogen bonds between the hydroxyl groups exposed from the surface thereof is engulfed by the polymerization initiating group-containing compound I¹ and the non-polymerization initiating group-containing compound I² at a high concentration (see FIG. 7A), the hydroxyl group exposed from the outermost surface of the aggregate is reacted with the functional group Z contained in the polymerization initiating group-containing compound I¹ and the non-polymerization initiating group-containing compound I². Further, after the reaction, a sufficient amount of the unreacted polymerization initiating group-containing compound I¹ and the non-polymerization initiating group-containing compound I² is present near the position. By this, as shown in FIG. 7B, the affinity of a site derived from the polymerization initiating group-containing compound I¹ and the non-polymerization initiating group-containing compound I² bonded to the surface of the particles 2 for the polymerization initiating group-containing compound I¹ and the non-polymerization initiating group-containing compound I² in the mixture 85 becomes higher than the aggregation force due to a hydrogen bond or the like, exerted between the particles 2 having the polymerization initiating group-containing compound I¹ and the non-polymerization initiating group-containing compound I² bonded to the surface thereof and other particles 2. As a result, the particles 2 are dispersed in the mixture 85. Thus, the reaction between the other hydroxyl groups exposed on the surface of the particles 2 and the functional group Z contained in the polymerization initiating group-containing compound I¹ and the non-polymerization initiating group-containing compound I² further proceeds with such a reaction being repeated, and thus, consequently, the aggregation between the particles 2 is dissociated. As a result, as shown in FIG. 6C, it is presumed that the particles 2 having the polymerization initiating group-containing compound I¹ and the non-polymerization initiating group-containing compound 12 linked to approximately the entire surface thereof are mono-dispersed in the mixture 85.

In this manner, the second polar group (hydroxyl group) 621 is reacted with the functional group Z, and thus, the polymerization initiating group-containing compound I¹ and the non-polymerization initiating group-containing compound I² are linked to approximately the entire surface of the shell body 22 (particles 2).

That is, the polymerization initiating group A provided in the polymerization initiating group-containing compound I¹ is introduced into the surface of the particles 2. With this polymerization initiating group-containing compound I¹, in the subsequent process [7], the monomers are polymerized from the polymerization initiating group A as a starting point to form a polymer 32. Accordingly, a polymerization initiating group-containing compound I¹ having a polymerization initiating group A constitutes a connecting part for connecting (linking) the shell body 22 to the polymer 32.

Furthermore, the surface of the particles 2 is provided with chargeability for positive or negative electrification provided in the non-polymerization initiating group-containing compound I². Accordingly, in the process [7], even though a cationic monomer and an anionic monomer are not used, but a non-ionic monomer is used alone as the monomer M at a time of forming polymer 32, an electrophoretic particle 1 imparted with dispersibility and chargeability can be reliably obtained.

Furthermore, when the electrophoretic particle 1 is provided with the characteristics of positive chargeability, a positively charged non-polymerization initiating group-containing compound I² may be added to the mixture 85. In addition, when the electrophoretic particle 1 is provided with the characteristics of negative chargeability, a negatively charged non-polymerization initiating group-containing compound I² may be added to the mixture 85.

Examples of the positively charged non-polymerization initiating group-containing compound I² include compounds represented by the following general formulae (6) and (7), and examples of the negatively charged non-polymerization initiating group-containing compound I² include compounds represented by the following general formulae (8) to (11):

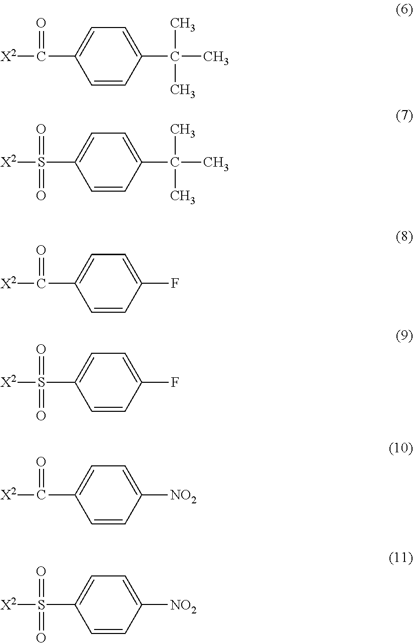

[in Formulae (6) to (11), X² represents chlorine, bromine, or iodine].

In addition, the total content of the polymerization initiating group-containing compound I¹ and the non-polymerization initiating group-containing compound I² may be 75% by weight or more, preferably 85% by weight or more, more preferably 95% by weight or more, and still more preferably 100% by weight. Thus, the affinity of a site derived from the polymerization initiating group-containing compound I¹ and the non-polymerization initiating group-containing compound I² bonded to the surface of the particles 2 for the polymerization initiating group-containing compound I¹ and the non-polymerization initiating group-containing compound I² in the mixture 85 reliably becomes higher than the aggregation force due to a hydrogen bond or the like, exerted between the particles 2 having the polymerization initiating group-containing compound I¹ and the non-polymerization initiating group-containing compound I² bonded to the surface thereof and other particles 2. As a result, the dispersibility of the particles 2 into the mixture 85 can be further improved.

Furthermore, the ratio of the content of the polymerization initiating group-containing compound I¹ to the content of the non-polymerization initiating group-containing compound I² slightly varies depending on the types of the non-polymerization initiating group-containing compound I² and the monomer M to be used, the number of the hydroxyl groups exposed from the shell body 22, or the like. However, the ratio of the content of I¹ to the content of I² is, for example, preferably approximately 10:1 to 1:5, and more preferably approximately 5:1 to 1:2. Thus, well-balanced characteristics of dispersibility and chargeability can be both imparted to the obtained electrophoretic particle 1.

### Second Other Configuration Example

The second other Configuration Example is the same as in the above-described method for preparing electrophoretic particles, except that the processes [6B] and [7B] as described later are carried out instead of the processes [6] and [7]. Specifically, a polymer 32 is formed by linking a carbon-carbon double bond-containing compound to the surface of the particles 2, and then linking a polymer provided with an Si—H group at a terminal thereof to the carbon-carbon double bond-containing compound, and thus, an electrophoretic particle 1 is obtained.

[6B] In this second other Configuration Example, a mixture 85 is obtained by adding a carbon-carbon double bond-containing compound having a functional group Z and a carbon-carbon double bond (vinyl group), respectively, at a proximal end and a terminal, instead of the polymerization initiating group-containing compound I¹, to the dried product 86 obtained in the process [5], and mixing them.

At this time, an aggregate in which the particles 2 are aggregated with each other is formed in the dried product 86, but in the present Configuration Example, the content of the carbon-carbon double bond-containing compound except for the dried product 86 (particles 2) in the mixture 85 is set to a high content (high concentration) which is 75% by weight or more. Thus, in the mixture 85, the carbon-carbon double bond-containing compound from the dissociation of the aggregation between the particles 2 is linked to approximately the entire surface of the particles 2. As a result, the particles 2 having the carbon-carbon double bond-containing compound linked to the surface thereof are dispersed in the mixture 85.

Furthermore, hereinafter, “the content of the carbon-carbon double bond-containing compound except for the dried product 86 (particles 2) in the mixture 85” is simply referred to as “the content of the carbon-carbon double bond-containing compound” in some cases for the sake of convenience in description.

In addition, in the present embodiment, the linking of the carbon-carbon double bond-containing compound to approximately the entire surface of the particles 2 as described above is presumed to be due to the same mechanism as a mechanism in which the polymerization initiating group-containing compound I¹ is linked to approximately the entire surface of the particles 2, as described in the process [6]. By such a mechanism, the second polar group (hydroxyl group) 621 is reacted with a functional group Z to link the carbon-carbon double bond-containing compound to approximately the entire surface of the shell body 22 (particles 2). That is, the carbon-carbon double bond provided in the carbon-carbon double bond-containing compound is introduced into the surface of the particles 2.

The polymer 32 is linked to the carbon-carbon double bond by the reaction of the carbon-carbon double bond with the Si—H group provided in the polymer in the process [7B] as described later. Accordingly, the carbon-carbon double bond-containing compound having a carbon-carbon double bond constitutes a connecting part for connecting (linking) the shell body 22 to the polymer 32.

Examples of such a carbon-carbon double bond-containing compound include acid halogenated compounds represented by the following general formula (12) or (13):

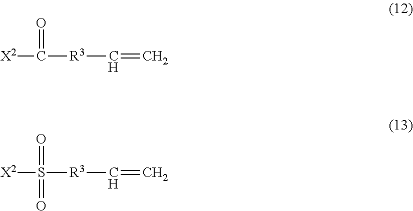

[in Formulae (12) and (13), R³ represents a group selected from a single bond, hydrogen, and an alkylene or arylene group having 1 to 20 carbon atoms, and X¹ and X² each independently represent chlorine, bromine, or iodine].

Furthermore, the group R³ in General Formula (12) or (13) is preferably an alkylene group having 1 to 5 carbon atoms, and more preferably an alkylene group having 2 carbon atoms. Thus, since the dispersibility of the particles 2 into the mixture 85 is improved, it is possible to allow the reaction between the carbon-carbon double bond-containing compound and the surface of the shell body 22 (particles 2) to further proceed.

From the above points, as the carbon-carbon double bond-containing compound, a compound represented by the following general formula (14) or (15) is preferably used:

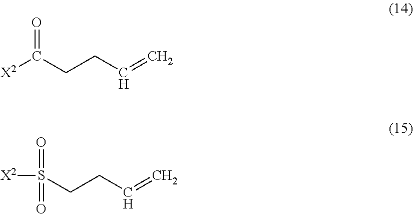

[in Formulae (14) and (15), X² represents chlorine, bromine, or iodine].

Furthermore, the content of the carbon-carbon double bond-containing compound may be 75% by weight or more, preferably 85% by weight or more, more preferably 95% by weight or more, and still more preferably 100% by weight. Thus, the affinity of a site derived from the carbon-carbon double bond-containing compound bonded to the surface of the particles 2 for the carbon-carbon double bond-containing compound in the mixture 85 reliably becomes higher than the aggregation force due to a hydrogen bond or the like, exerted between the particles 2 having the carbon-carbon double bond-containing compound bonded to the surface thereof and other particles 2. As a result, the dispersibility of the particles 2 into the mixture 85 can be further improved.

[7B] Next, in this second other Configuration Example, for example, a polymer provided with an Si—H group at a terminal thereof, represented by the following general formula (16), and a platinum catalyst are added to the mixture 85.

Thus, the Si—H group is reacted with the carbon-carbon double bond (vinyl group) by a hydrosilylation reaction, and as a result, a polymer 32 is formed on the surface of the particles 2. Thus, electrophoretic particle 1 provided with the polymer 32 on the surface of the particles 2 is obtained.

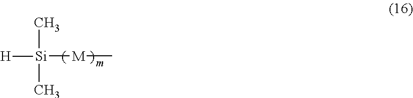

[in Formula (16), M represents the monomer and m represents an integer of 1 or more].

Furthermore, when the Si—H group is reacted with the carbon-carbon double bond (vinyl group) by a hydrosilylation reaction, the reaction can be more promptly and reliably carried out by setting the temperature of the mixture 85 at a determined temperature.

This heating temperature is not particularly limited, and is preferably approximately 30° C. to 100° C. In addition, the heating time (reaction time) is preferably approximately 10 hours to 20 hours in the case of setting the heating temperature as the range described above.

### Third Other Configuration Example

The third other Configuration Example is the same as in the above-described method for preparing electrophoretic particles, except that the processes [6C] and [7C] as described later are carried out instead of the processes [6] and [7]. Specifically, a polymer 32 is formed by linking an acid halogenated compound (acid halide) to the surface of the particles 2, and then linking a polymer provided with a hydroxyl group at a terminal thereof to the acid halogenated compound, and thus, an electrophoretic particle 1 is obtained.

[6C] In this third other Configuration Example, first, an oxidizing agent such as potassium permanganate is added to the dried product 86 obtained in the process [5]. Thus, by oxidizing at least a part of the hydroxyl groups exposed from the surface of the shell body 22 to afford carboxyl groups in advance, particle 2 provided with hydroxyl groups and carboxyl groups on the surface (shell body 22) thereof are obtained. In addition, a mixture 85 is obtained by further adding an acid halogenated compound having two functional groups (halogenated acidic group) Z instead of the polymerization initiating group-containing compound I¹ to this dried product 86, and mixing them.

At this time, an aggregate in which the particles 2 are aggregated with each other is formed in the dried product 86, but in the present Configuration Example, the content of the acid halogenated compound except for the dried product 86 (particles 2) in the mixture 85 is set to a high content (high concentration) which is 75% by weight or more. Thus, in the mixture 85, the acid halogenated compound from the dissociation of the aggregation between the particles 2 is linked to approximately the entire surface of the particles 2. As a result, the particles 2 having the acid halogenated compound linked to the surface thereof are dispersed in the mixture 85.

Furthermore, hereinafter, “the content of the acid halogenated compound except for the dried product 86 (particles 2) in the mixture 85” is simply referred to as “the content of the acid halogenated compound” in some cases for the sake of convenience in description.

In addition, in the present embodiment, the linking of the acid halogenated compound to approximately the entire surface of the particles 2 as described above is presumed to be due to the same mechanism as a mechanism in which the polymerization initiating group-containing compound I¹ is linked to approximately the entire surface of the particles 2, as described in the process [6]. By such a mechanism, the second polar group (hydroxyl group) 621 is reacted with one functional group Z to link the acid halogenated compound to approximately the entire surface of the shell body 22 (particles 2). That is, another functional group (halogenated acidic group) Z provided in the acid halogenated compound is introduced into the surface of the particles 2.

The polymer 32 is linked to the other functional group Z by the reaction of the other functional group Z with the hydroxyl group provided in the polymer in the process [7C] as described later. Accordingly, the acid halogenated compound having a functional group Z constitutes a connecting part for connecting (linking) the shell body 22 to the polymer 32.

Examples of such an acid halogenated compound include an acid halogenated compound represented by the following general formula (17) or (18):

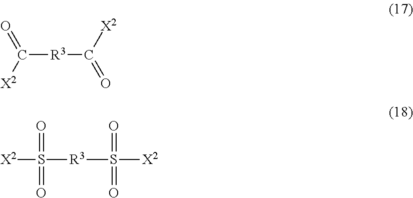

[in Formulae (17) and (18), R³ represents a group selected from a single bond, hydrogen, and an alkylene or arylene group having 1 to 20 carbon atoms, and two X²'s each independently represent chlorine, bromine, or iodine].

Furthermore, the group R³ in General Formula (17) or (18) is preferably a single bond or an alkylene group having 1 or 2 carbon atoms, and more preferably a single bond. Thus, since the dispersibility of the particles 2 into the mixture 85 is improved, it is possible to allow the reaction between the acid halogenated compound and the surface of the shell body 22 (particles 2) to further proceed.

From the above points, as the acid halogenated compound, a compound represented by the following general formula (19) or (20) is preferably used:

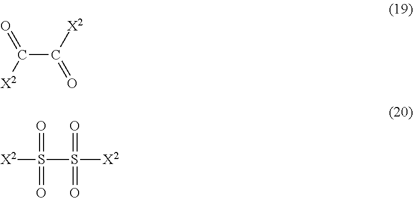

[in Formulae (19) and (20), two X²'s each independently represent chlorine, bromine, or iodine].

Furthermore, the content of the acid halogenated compound may be 75% by weight or more, preferably 85% by weight or more, more preferably 95% by weight or more, and still more preferably 100% by weight. Thus, the affinity of a site derived from the acid halogenated compound bonded to the surface of the particles 2 for the acid halogenated compound in the mixture 85 reliably becomes higher than the aggregation force due to a hydrogen bond or the like, exerted between the particles 2 having the acid halogenated compound bonded to the surface thereof and other particles 2. As a result, the dispersibility of the particles 2 into the mixture 85 can be further improved.

[7C] Next, in this third other Configuration Example, for example, a polymer provided with a hydroxyl group at a terminal thereof, represented by the following general formula (21), and a base such as triethylamine are added to the mixture 85.

Thus, the hydroxyl group is reacted with the functional group (halogenated acidic group) Z, and as a result, a polymer 32 is formed on the surface of the particles 2. Thus, electrophoretic particle 1 provided with the polymer 32 on the surface of the particles 2 is obtained.

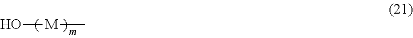

[in Formula (21), M represents the monomer and m represents an integer of 1 or more].

Furthermore, when the hydroxyl group is reacted with the functional group (halogenated acidic group) Z, the reaction can be more quickly and reliably carried out by setting the temperature of the mixture 85 at a determined temperature.

This heating temperature is not particularly limited, and is preferably approximately 30° C. to 100° C. In addition, the heating time (reaction time) is preferably approximately 5 hours to 20 hours in the case of setting the heating temperature as the range described above.

### Second Embodiment

Next, the method for preparing electrophoretic particles according to the second embodiment of the invention will be described.

First, prior to describing the method for preparing electrophoretic particles of the present embodiment, electrophoretic particles prepared by applying the method for preparing electrophoretic particles of the present embodiment (the electrophoretic particles of the present embodiment) will be described.

The electrophoretic particles prepared by applying the method for preparing electrophoretic particles of the present embodiment have particles and a coating layer covering at least a part of the particles in the same manner as for the electrophoretic particle 1 according to the first embodiment as described above. These particles are provided with mother particles and a shell body which is constituted with an organic polymer and engulfs the mother particle in the shape of a cell. Further, the coating layer has a compound (second compound) including a functional group having reactivity with a hydroxyl group exposed on the surface of the shell body and a polymer. By way of example, an electrophoretic particle with such a configuration will be described.

### Electrophoretic Particles

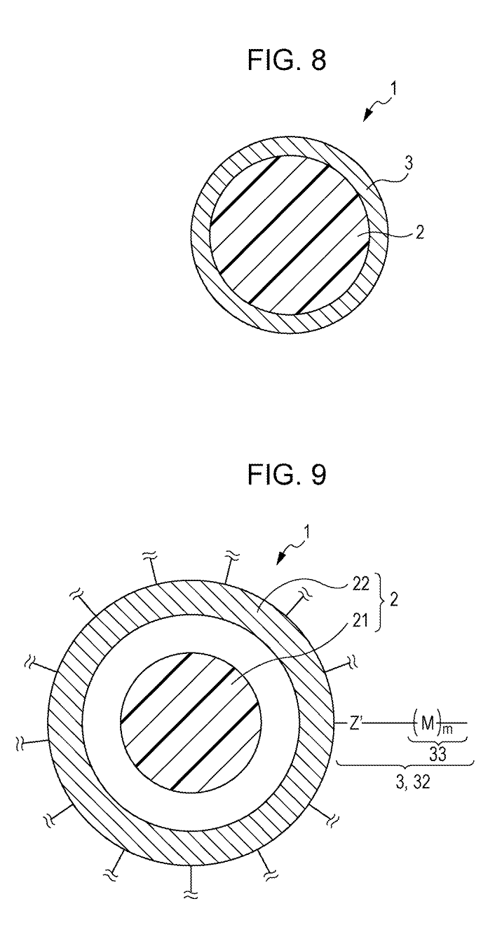

FIG. 8 is a longitudinal cross-sectional view showing the electrophoretic particle prepared by the method for preparing electrophoretic particles according to the second embodiment of the invention. FIG. 9 is a schematic view showing the particle and the coating layer included in the electrophoretic particles shown in FIG. 8.

The electrophoretic particle 1 has a particle 2 having a hydroxyl group exposed on the surface thereof and a coating layer 3 provided on the surface of the particle 2.

In the present embodiment, the particle 2 is configured to have a mother particle 21 and a shell body 22 which engulfs the mother particle 21 in the shape of a cell (in the form of a capsule).

The mother particle (base particle) 21 mainly constitutes the particle 2 and functions as a core material (mother material) of the particle 2.

The mother particle 21, as shown in FIG. 9, the cross-sectional shape forms a circular shape. Thus, since the mother particle 21 forms a spherical shape, the cross-sectional shape of the particles 2 can also be a circular shape, as shown in FIG. 9. Accordingly, since it is possible to make the electrophoretic performance provided for the electrophoretic particles 1 more uniform, the shape is preferably selected as the shape of the mother particles 21. In addition, if the electrophoretic performance provided for the electrophoretic particle 1 is made uniform, the mother particle 21 may have an elliptical shape or a polygonal shape such as a rectangular shape, a pentagonal shape, and a hexagonal shape, or may be an aggregate in which granules having such a shape are aggregated with each other.

As the mother particle 21, for example, at least one of a pigment particle, a dye particle, a resin particle, and a complex particle thereof is suitably used. These particles are easily prepared.

Examples of the pigment constituting the pigment particles include black pigments such as carbon black, aniline black, and titanium black, white pigments such as titanium dioxide, antimony trioxide, barium sulfate, zinc sulfide, zinc oxide, and silicon dioxide, azo-based pigments such as monoazo, disazo, and polyazo, yellow pigments such as isoindolinone, chrome yellow, yellow iron oxide, cadmium yellow, titanium yellow, and antimony, red pigments such as quinacridone red and chrome vermilion, blue pigments such as phthalocyanine blue, indanthrene blue, iron blue, ultramarine, and cobalt blue, and green pigments such as phthalocyanine green, and among these, one kind or a combination of two or more kinds thereof may be used.

In addition, examples of the dye material constituting the dye particles include azo compounds such as Oil Yellow 3G (manufactured by Orient Chemical Industries Co., Ltd.), azo compounds such as Fast Orange G (manufactured by BASF Ltd.), anthraquinones such as Macrolex Blue RR (manufactured by Bayer Holding Ltd.), anthraquinones such as Sumiplast Green G (manufactured by Sumitomo Chemical Co., Ltd.), azo compounds such as Oil Brown GR (manufactured by Orient Chemical Industries Co., Ltd.), azo compounds such as Oil Red 5303 (manufactured by Arimoto Chemical Co., Ltd.) and Oil Red 5B (manufactured by Orient Chemical Industries Co., Ltd.), anthraquinones such as Oil Violet #730 (manufactured by Orient Chemical Industries Co., Ltd.), azo compounds such as Sudan Black X60 (manufactured by BASF Ltd.), and mixtures of anthraquinone-based Macrolex Blue FR (manufactured by Bayer Holding Ltd.) and azo-based Oil Red XO (manufactured by Kanto Chemical Co., Inc.), and one kind or a combination of two or more kinds thereof may be used.

In addition, examples of the resin material constituting the resin particles include an acrylic-based resin, a urethane-based resin, a urea-based resin, an epoxy-based resin, a polystyrene, and a polyester, and one kind or a combination of two or more kinds thereof may be used.

In addition, examples of the complex particles include particles formed by carrying out a coating treatment by covering the surface of the pigment particles by resin materials, particles formed by carrying out a coat treatment by covering the surface of resin particles by pigments, particles constituted with mixtures in which pigments and resin materials are mixed at an appropriate composition ratio, or the like.

Incidentally, by arbitrarily selecting the types of pigment particles, resin particles and complex particles to be used as the mother particle 21, it is possible to set the color of the electrophoretic particle 1 as the desired color.

Furthermore, the mother particle 21 needs to have a charge on the surface thereof so as to align the first polymerizable surfactant 61 to the mother particle 21 during formation of the shell body 22 in the method for preparing the electrophoretic particles of the present embodiment as will described later. However, there are some cases where the mother particle 21 does not have a charge or the electrification amount which is insufficient, depending on the types of a pigment particle, a resin particle, and a complex particle. Thus, in such a case, it is preferable to impart the charge to the surface of the mother particle 21 by carrying out a treatment for absorbing a compound having polarity, such as a coupling agent and a surfactant into the surface of the mother particle 21 in advance.

The mother particle 21 is engulfed in the shape of a cell by the shell body 22. By providing the particle 2 with the shell body 22 having such a configuration, it is possible to accurately prevent the influence of the charge of the mother particle (base particle) 21 on the electrophoretic particle 1. Thus, by setting the types, the number, or the like of the polymer 32 to be linked to the shell body 22, it is possible to accurately prevent or prevent the change in the characteristics such as dispersibility and chargeability, which are imparted to the electrophoretic particle 1, depending on the charge of the particle 2. That is, the electrophoretic particle 1 exhibits desired characteristics such as dispersibility and chargeability, irrespective of the type of the mother particle 21.

The shell body 22 is constituted with an organic polymer in the present embodiment. Further, the shell body 22 is not particularly limited as long as it is possible to engulf the particle 2 in the shape of a cell by the organic polymer. In particular, it is preferable that a network structure (linked structure) formed by crosslinking a plurality of the organic polymers to each other is formed. In so doing, the shell body 22 has excellent strength, and accordingly, it is possible to reliably prevent the shell body 22 from being peeled from the particle 2.

It is possible to obtain the shell body 22 with such a configuration, for example, by a method as shown below. First, a first polymerizable surfactant 61 having a first polar group 611 which has polarity opposite to the charge of the surface of the particle 2, a hydrophobic group 612, and a polymerizable group 613 is added to an aqueous dispersion 90 in which the particles 2 having the charge on the surface thereof are dispersed, and mixed. Next, a second polymerizable surfactant 62 having a hydroxyl group which is a second polar group 621, a hydrophobic group 622, and a polymerizable group 623 is added to the mixed solution of the aqueous dispersion 90 and the first polymerizable surfactant 61, and emulsified. Then, a polymerization initiator is added to the mixed solution of the aqueous dispersion 90, the first polymerizable surfactant 61, and the second polymerizable surfactant 62 to cause a polymerization reaction to occur. This method will be described in detail in the description of the method for preparing the electrophoretic particles as described later.

The particle 2 is covered with the coating layer 3 on at least a part (approximately the entire part in the configuration shown) of the surface thereof.

This coating layer 3 is configured to have a plurality of polymers 32 bonded to the surface of the shell body 22 provided in the particle 2 in the present embodiment.

The polymer 32 is a compound provided with a functional group Z and a repeat (polymer) 33 formed by polymerization of the monomer M (a second compound having a functional group having reactivity with a hydroxyl group and a polymer). This polymer 32 is a component for exhibiting the characteristics of the electrophoretic particle 1 in the electrophoretic dispersion as described later.

The functional group Z is a functional group which has reactivity with the second polar group (hydroxyl group) 621 provided in the shell body 22 and is linked to one end of the repeat 33. A detailed description of the functional group Z will be applied in the method for preparing electrophoretic particles as described later.

The repeat 33 is a polymer formed by polymerization of a plurality of monomers M. For this repeat 33, the type of the monomer M as the constituent is selected based on the characteristics provided for the electrophoretic particle 1. Specific examples of the monomer M include a non-ionic monomer, a cationic monomer, and an anionic monomer.

By forming a repeat 33 (polymer 32) using monomers including the non-ionic monomer as the monomer M, the polymer 32 exhibits excellent affinity for a dispersion medium included in the electrophoretic dispersion as described later. Therefore, it is possible to disperse the electrophoretic particles 1 in the electrophoretic dispersion while not aggregating the electrophoretic particles 1 provided with such a polymer 32. That is, it is possible to impart the characteristics of the dispersibility to the electrophoretic particles 1.

Examples of such a non-ionic monomer include acryl-based monomers such as ethylene, 1-hexene, 1-heptene, 1-octene, methyl(meth)acrylate, ethyl(meth)acrylate, propyl(meth)acrylate, stearyl(meth)acrylate, lauryl(meth)acrylate, decyl(meth)acrylate, isooctyl(meth)acrylate, isobornyl(meth)acrylate, cyclohexyl(meth)acrylate, and pentafluoro(meth)acrylate, styrene-based monomers such as styrene, 2-methyl styrene, 3-methyl styrene, 4-methyl styrene, 2-ethyl styrene, 3-ethyl styrene, 4-ethyl styrene, 2-propyl styrene, 3-propyl styrene, 4-propyl styrene, 2-isopropyl styrene, 3-isopropyl styrene, 4-isopropyl styrene, and 4-tert-butyl styrene, and an organosiloxane monomer capable of forming a siloxane structure represented by the following general formula (I):

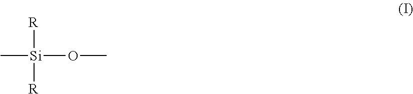

[in which the respective R's each independently represent a substituted or unsubstituted hydrocarbon group].

Among these, the non-ionic monomer preferably includes an organosiloxane monomer capable for forming a siloxane structure represented by General Formula (I). That is, the polymer 32 is preferably polymer having a functional group Z and a polyorganosiloxane linked to one end of the functional group Z. By adopting such a non-ionic monomer, when a solvent having silicone oil as a main component is used as a dispersion medium included in the electrophoretic dispersion as described later, the non-ionic monomer exhibits excellent affinity for the dispersion medium. Accordingly, the electrophoretic particle 1 provided with the polymer 32 obtained by the polymerization of the non-ionic monomers has further improved dispersibility in the dispersion medium.

Furthermore, by forming the polymer 32 by living radical polymerization using monomers including cationic monomers, the polymer 32 becomes positively charged (plus) in the electrophoretic dispersion as described later. Therefore, the electrophoretic particle 1 provided with such a polymer 32 becomes the electrophoretic particle with positive chargeability (positive electrophoretic particle) in the electrophoretic dispersion. That is, it is possible to impart the characteristics of positive chargeability to the electrophoretic particle 1.

Examples of such a cationic monomer include a monomer provided with an amino group in the structure thereof, specifically, benzyl(meth)acrylate, 2-(diethylamino)ethyl(meth)acrylate, 2-(trimethylammonium chloride)ethyl(meth)acrylate, 1,2,2,6,6-pentamethyl-4-piperidyl(meth)acrylate, 2,2,6,6-tetramethyl-4-piperidyl(meth)acrylate, 1,1,1,3,3,3-hexafluoroisopropyl(meth)acrylate, aminomethyl(meth)acrylate, aminoethyl(meth)acrylate, N,N-dimethylaminoethyl(meth)acrylate, N-ethyl-N-phenylaminoethyl(meth)acrylate, N,N-dimethyl(meth)acrylamide, N,N-diethyl(meth)acrylamide, 4-vinylpyridine, and methacryloylcholine chloride.

Furthermore, by forming the polymer 32 by living radical polymerization using a monomer including an anionic monomer, the polymer 32 becomes negatively charged (minus) in the electrophoretic dispersion as described later. Therefore, the electrophoretic particle 1 provided with such a polymer 32 becomes the electrophoretic particle with negative chargeability (negative electrophoretic particle) in the electrophoretic dispersion. That is, it is possible to impart the characteristics of negative chargeability to the electrophoretic particle 1.

Examples of such an anionic monomer include a monomer provided with a carboxyl group or sulfonyl group in the structure thereof, specifically, diol-based monomers such as (meth)acrylic acid, carboxymethyl(meth)acrylate, carboxyethyl(meth)acrylate, vinylbenzoic acid, vinylphenylacetic acid, vinylphenylpropionic acid, vinylsulfonic acid, sulfomethyl(meth)acrylate, 2-sulfoethyl(meth)acrylate, polyethylene glycol mono(meth)acrylate, 2-methoxyethyl(meth)acrylate, 1,2-ethane diol, 1,2-butanediol, and 1,4-butanediol.

Since the polymer 32 is formed by polymerization of various monomers as described above, by setting the number of structural units derived from these monomers, it is possible to set the polymer 32 at the desired level of the characteristics derived from various monomers.

In addition, it is possible to illustrate the polymer 32 by a schematic view as in FIG. 9, when the monomer is denoted as M and the linking group formed by the reaction of the functional group Z with the hydroxyl group is denoted as Z′.

Such an electrophoretic particle 1 is prepared as follows, by applying the method for preparing electrophoretic particles of the present embodiment.

### Method of Preparing Electrophoretic Particles

Hereinafter, the method for preparing the electrophoretic particles 1 of the present embodiment will be described.

Furthermore, in the method for preparing the electrophoretic particles 1 as described later, first, a particle 2 (AMP particle) in which the mother particle 21 is engulfed in the form of a capsule by the shell body 22 is formed. Next, a plurality of the polymers 32 are produced in (linked to) the surface of the particles 2 to form a coating layer 3. By using such a method, the electrophoretic particle 1 is obtained.

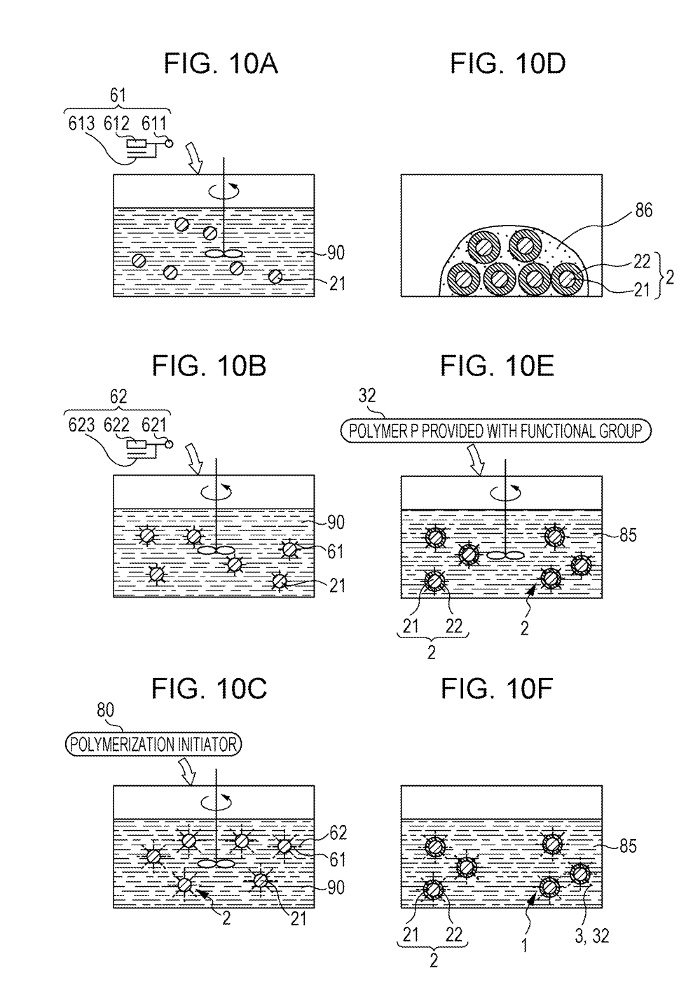

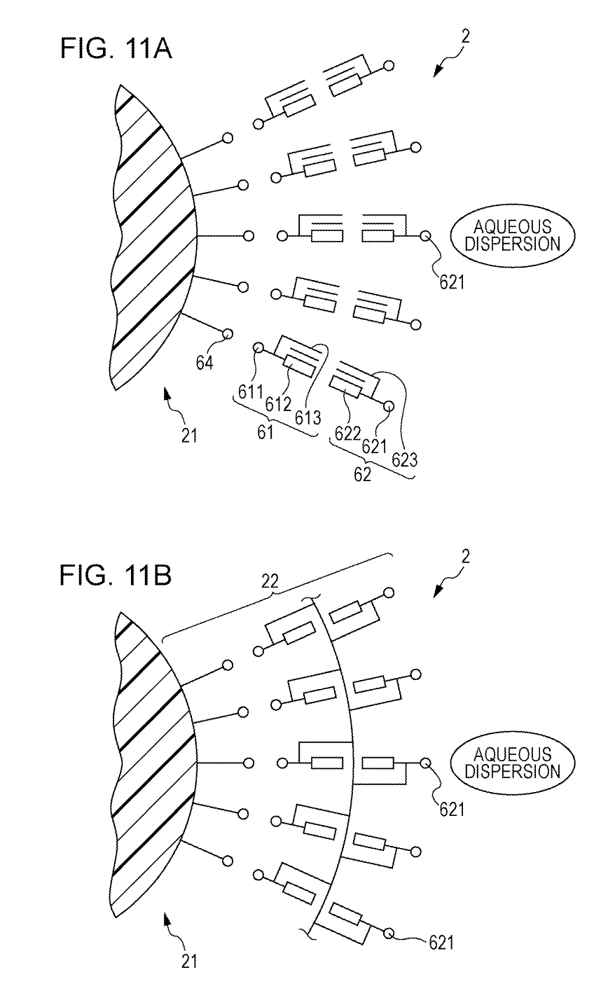

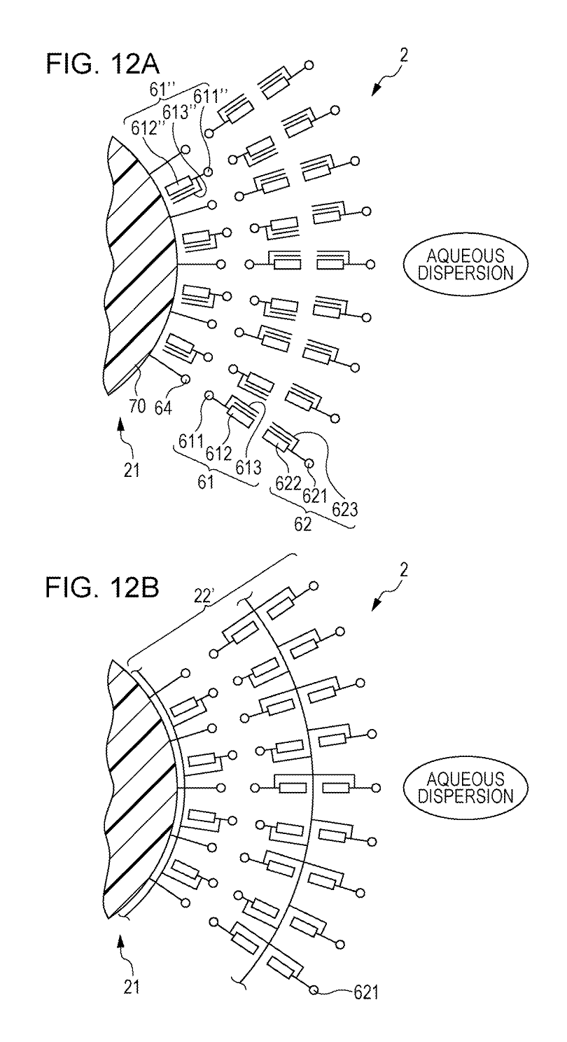

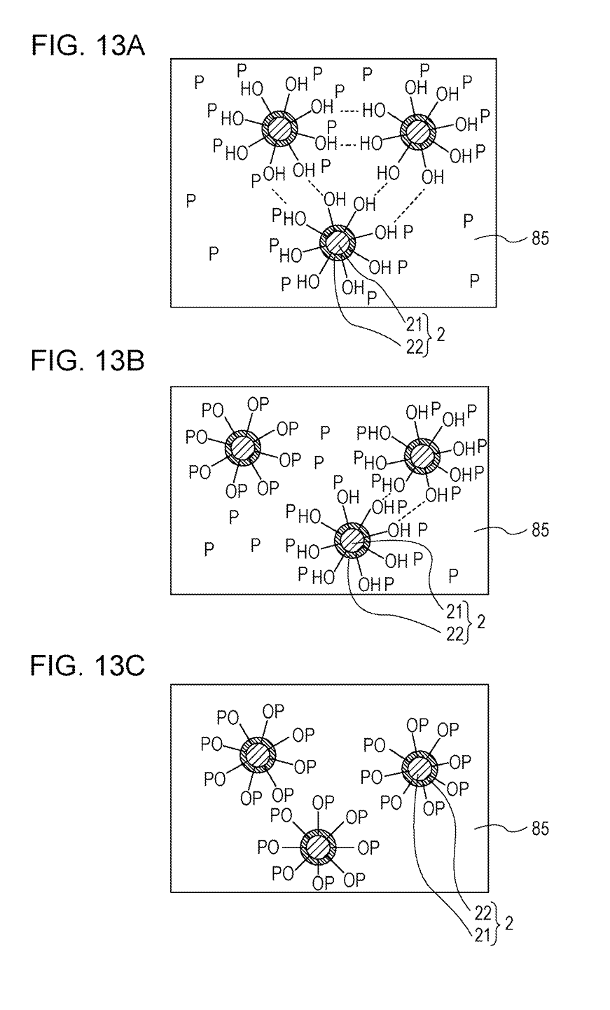

FIGS. 10A to 10F are each a schematic view for explaining the second embodiment of the method for preparing electrophoretic particles. FIG. 11A is a partially enlarged view showing a dispersion state of the mother particles that can occur in the aqueous dispersion of FIG. 10C. FIG. 11B is a partially enlarged view showing a configuration of the particles of FIG. 10D. Further, FIG. 12A is a partially enlarged view showing another dispersion state of the mother particles that can occur in the aqueous dispersion of FIG. 10C. FIG. 12B is a partially enlarged view showing another configuration of the particles of FIG. 10D. Further, FIGS. 13A to 13C are each a schematic view for explaining a mechanism in which an aggregated particles are gradually dissociated and the particles having a compound having a functional group and a polymer linked to the surface thereof are dispersed in the mixture.

In the present embodiment, the method for preparing the electrophoretic particles 1 includes [1] dispersing mother particles 21 having the charge on the surface thereof into an aqueous dispersion 90, [2] adding a first polymerizable surfactant 61 which has the first polar group 611 having polarity opposite to the charge 64 of the mother particles 21, a hydrophobic group 612, and a polymerizable group 613 to the aqueous dispersion 90, and mixing them, [3] adding the second polymerizable surfactant 62 having a second polar group 621 (hydroxyl group), a hydrophobic group 622, and a polymerizable group 623 into the aqueous dispersion 90, and emulsifying them, [4] obtaining a particle 2 which is made by engulfing the mother particle 21 in the form of a capsule by a shell body 22 constituted with an organic polymer by adding polymerization initiator 80 into the aqueous dispersion 90 to cause a polymerization reaction to occur, [5] obtaining a dried product (aggregate) 86 of the particles 2 by drying the aqueous dispersion 90 including the particles 2, [6] linking the polymer 32 to the surface of the particles 2 by setting the content of the polymer 32 except for the dried product 86 (particles 2) to 75% by weight or more in a mixture 85 obtained by adding a polymer 32 provided with a functional group Z having reactivity with the second polar group (hydroxyl group) 621 (a second compound having a functional group Z and a repeat 33 (polymer)) to the dried product of the particles 2, and mixing them, thereby obtaining electrophoretic particles 1, [7] collecting the electrophoretic particles 1 from the mixture 85, and [8] drying the electrophoretic particles 1.

In the present embodiment, when the polymer 32 is linked to the surface of the particles 2 in the process [6], the content of the polymer 32 except for the dried product 86 (particles 2) is set to 75% by weight or more in the mixture 85 of the dried product of the particles 2 and the polymer 32. In doing so, even when the particles 2 having the second polar group (hydroxyl group) 621 exposed on the surface thereof are used, electrophoretic particles having a small number of peaks can be prepared as the particle size distribution is measured. More preferably, electrophoretic particles 1 having only a single peak can be prepared. Further, the content of the polymer 32 except for the dried product 86 (particles 2) in the mixture 85 may be 75% by weight or more when the reaction is initiated. Thereafter, according to the progress of the reaction, the polymer 32 is consumed and may be below 75% by weight.

Hereinafter, the respective processes as described above will be described in order.

[1] First, mother particles 21 having the charge 64 on the surface thereof are dispersed into an aqueous dispersion 90.

As the aqueous dispersion 90, for example, various types of water such as distilled water, ion-exchanged water, pure water, ultrapure water, and R. O. water alone or an aqueous medium formed by mixing water as a main component with various lower alcohols such as methanol and ethanol is suitably used.

[2] Next, as shown in FIG. 10A, the first polymerizable surfactant 61 which has the first polar group 611 having polarity opposite to the charge 64 of the mother particle 21, a hydrophobic group 612, and a polymerizable group 613 is added to the aqueous dispersion 90, and mixed.

At this time, the additive amount of the first polymerizable surfactant 61 is preferably in the range of 0.5-fold moles to 2-fold moles, and more preferably in the range of 0.8-fold moles to 1.2-fold moles, with respect to the total number of moles (=weight of the used mother particle 21 [g]×the amount of a polar group having the charge 64 of the mother particle 21 [mol/g]) of a polar group, having the charge 64, converted from the amount of the mother particle 21 used. Further, by setting the additive amount of the first polymerizable surfactant 61 to 0.5-fold moles or more with respect to the total number of moles of the polar group having the charge 64, it is possible for the first polymerizable surfactant 61 to strongly bond ionically with the mother particle 21 and be easily encapsulated. On the other hand, by setting the additive amount of the first polymerizable surfactant 61 to 2-fold moles or less with respect to the total number of moles of the polar group having the charge 64, it is possible to reduce the occurrence of the first polymerizable surfactant 61 which is not adsorbed to the mother particle 21 and it is also possible to prevent the occurrence of a polymer particle (particle which consists of only polymers) not having the mother particle 21 as a core material.

In addition, the aqueous dispersion 90 may be irradiated with ultrasonic waves for a predetermined time as necessary. In this manner, the arrangement pattern of the first polymerizable surfactant 61 present around the mother particle 21 is controlled to a high degree.

Specifically, in the case where the mother particle 21 has the negative charge 64, it is possible to use a cationic polymerizable surfactant as the first polymerizable surfactant 61. In contrast, in the case where the mother particle 21 has the positive charge 64, an anionic polymerizable surfactant can be used as the first polymerizable surfactant 61.

Examples of the cationic group contained in the cationic polymerizable surfactant include a primary amine cationic group, a secondary amine cationic group, a tertiary amine cationic group, a quaternary ammonium cationic group, a quaternary phosphonium cationic group, a sulfonium cationic group, and a pyridinium cationic group.

Among these, a cationic group is preferably one selected from a group consisting of a primary amine cationic group, a secondary amine cationic group, a tertiary amine cationic group, and a quaternary ammonium cationic group.

A hydrophobic group contained in the cationic polymerizable surfactant preferably includes at least one of an alkyl group and an aryl group.

A polymerizable group contained in the cationic polymerizable surfactant is preferably a radically polymerizable unsaturated hydrocarbon group.

Moreover, among radically polymerizable unsaturated hydrocarbon groups, one selected from a group consisting of a vinyl group, an allyl group, an acryloyl group, a methacryloyl group, a propenyl group, a vinylidene group, and a vinylene group is preferable. Furthermore, among these, especially, an acryloyl group and a methacryloyl group may be exemplified as more preferable examples.

Examples of the cationic polymerizable surfactant include the cationic allyl acid derivatives described in JP-B-4-65824, or the like. Specific examples of the cationic polymerizable surfactant include dimethylaminoethyl methacrylate methyl chloride, dimethylaminoethyl methacrylate benzyl chloride, methacryloyloxyethyl trimethyl ammonium chloride, diallyl dimethyl ammonium chloride, and 2-hydroxy-3-methacryloxypropyl trimethyl ammonium chloride.

In addition, as the cationic polymerizable surfactant, commercial products may also be used. For example, Acryester DMC (Mitsubishi Rayon Co., Ltd.), Acryester DML60 (Mitsubishi Rayon Co., Ltd.), C-1615 (Dai-ichi Kogyo Seiyaku Co., Ltd.), or the like may be used.

The cationic polymerizable surfactant exemplified above may be used alone or as a mixture of two or more kinds.

On the other hand, examples of the anionic group contained in the anionic polymerizable surfactant include a sulfonate anionic group (—SO₃⁻), a sulfinate anionic group (—RSO₂⁻: R is an alkyl group having 1 to 12 carbon atoms, or a phenyl group or a modified body thereof), a carboxylate anionic group (—COO⁻), a phosphate anionic group (—PO₃⁻), and an alkoxide anionic group (—O⁻), and however, one selected from a group consisting of these is preferable.

As a hydrophobic group contained in the anionic polymerizable surfactant, the same hydrophobic group as a hydrophobic group contained in the cationic polymerizable surfactant as described above can be used.

As a polymerizable group contained in the anionic polymerizable surfactant, the same polymerizable group as a polymerizable group contained in cationic polymerizable surfactant as described above can be used.

Examples of the anionic polymerizable surfactant include the anionic allyl derivatives described in JP-B-49-46291, JP-B-1-24142 and JP-A-62-104802, the anionic propenyl derivatives described in JP-A-62-221431, the anionic acrylic acid derivatives described in JP-A-62-34947 and JP-A-55-11525, and the anionic itaconic acid derivatives described in JP-B-46-34898 and JP-A-51-30284.

As a specific example of such an anionic polymerizable surfactant, a compound represented by General Formula (31):

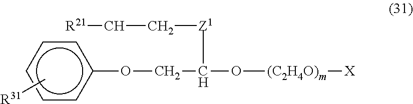

[in which R²¹ and R³¹ are each independently a hydrogen atom or a hydrocarbon group having 1 to 12 carbon atoms, Z¹ is carbon-carbon single bond or a group represented by the formula —CH₂—O—CH₂—, m is an integer of 2 to 20, X is a group represented by the formula —SO₃M¹, and M¹ is an alkali metal, an ammonium salt or an alkanolamine], or

a compound represented by General Formula (32):

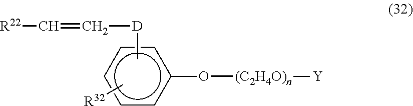

[in which R²² and R³² are each independently a hydrogen atom or a hydrocarbon group having 1 to 12 carbon atoms, D is carbon-carbon single bond or a group represented by the formula —CH₂—O—CH₂—, n is an integer of 2 to 20, Y is a group represented by the formula —SO₃M², and M² is an alkali metal, an ammonium salt or an alkanolamine]

is preferable.

The polymerizable surfactant represented by Formula (31) is described in JP-A-5-320276 and JP-A-10-316909. By arbitrarily adjusting the type of R²¹ and the value of X in Formula (31), it is possible to correspond to the degree of the electrification amount of the charge 64 included in the mother particle 21. Examples of the preferable polymerizable surfactant represented by Formula (31) include a compound represented by the following formula (310) and specifically include compounds represented by the following formulae (31a) to (31d).

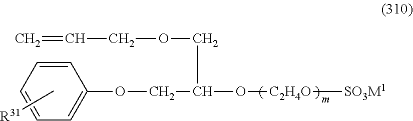

[in which R³¹, m, and M¹ are the same as for the compound represented by Formula (31)]

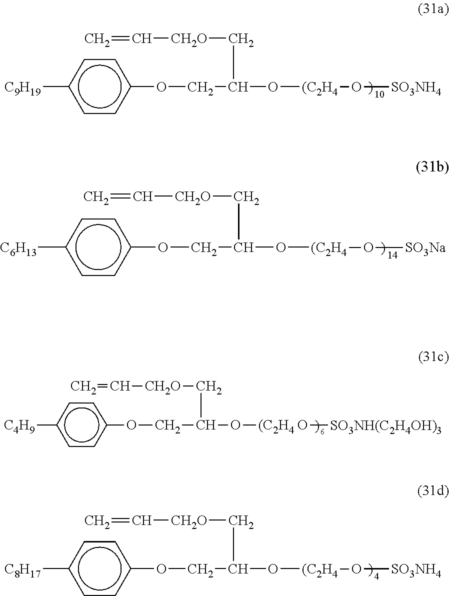

Adeka Reasoap SE-10N of Adeka Chemical Supply Co., Ltd. is the compound represented by Formula (310), in which M¹ is NH₄, R³¹ is C₉H₁₉, and m=10. Adeka Reasoap SE-20N of Adeka Chemical Supply Co., Ltd. is the compound represented by Formula (310), in which M₁ is NH₄, R³¹ is C₉H₁₉, and m=20.

In addition, as the anionic group contained in the anionic polymerizable surfactant, for example, a compound represent by General Formula (33):

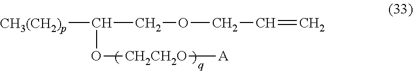

[in which p is 9 or 11, q is an integer of 2 to 20, A is a group represented by —SO₃M³, and M³ is an alkali metal, an ammonium salt or an aikanolamine]

is preferable. Preferable examples of the anionic polymerizable surfactant represented by Formula (33) include the following compounds:

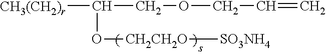

[in which r is 9 or 11, and s is 5 or 10].

As the anionic polymerizable surfactant, commercial products may also be used. For example, Aquaron KH series (Aquaron KH-5 and Aquaron KH-10) of Dai-ichi Kogyo Seiyaku Co., Ltd., or the like may be used. Aquaron KH-5 is a mixture of the compound in which r is 9 and s is 5 and the compound in which r is 11 and s is 5, each represented by the formula above, and Aquaron KH-10 is a mixture of the compound in which r is 9 and s is 10 and the compound in which r is 11 and s is 10, each represented by the formula above.

In addition, as the anionic polymerizable surfactant, a compound represented by the following formula (34) is preferable:

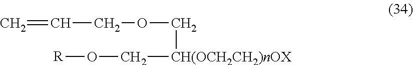

[in which R is an alkyl group having 8 to 15 carbon atoms, n is an integer of 2 to 20, X is a group represented by —SO₃B, and B is an alkali metal, an ammonium salt, or an alkanolamine].

As the anionic polymerizable surfactant, commercial products may also be used. Examples of the commercial product include Adeka Reasoap SR series (Adeka Reasoap SR-10, SR-20, and R-1025) (all, product names) manufactured by Adeka Chemical Supply Co., Ltd. Adeka Reasoap SR series are compounds in which B is represented by NH₄, SR-10 is the compound with n=10, and SR-20 is the compound with n=20, each of which is the compound of General Formula (34).

In addition, as the anionic polymerizable surfactant, a compound represented by the following formula (A) is also preferable:

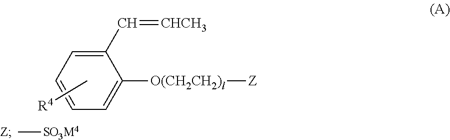

[in the formula describe above, R⁴ represents a hydrogen atom or a hydrocarbon group having 1 to 12 carbon atoms, I represents a number of 2 to 20, and M⁴ represents an alkali metal, an ammonium salt, or an alkanolamine].

As the anionic polymerizable surfactant, commercial products may also be used. As the commercial product, for example, Aquaron HS series (Aquaron HS-10, HS-20, and HS-1025) (all, product names) manufactured by of Dai-ichi Kogyo Seiyaku Co., Ltd. can be used.

In addition, examples of the anionic polymerizable surfactant used in the invention include a sodium alkylaryl sulfosuccinate ester salt represented by General Formula (35).

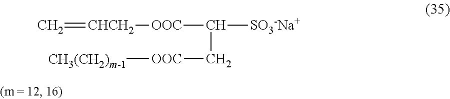

As the anionic polymerizable surfactant, commercial products may also be used. As the commercial product, for example, Eleminol JS-2 of Sanyo Chemical Industries, Ltd. can be used, which is the compound represented by General Formula (35) with m=12.

In addition, examples of the anionic polymerizable surfactant used in the invention include a sodium methacryloyloxypolyoxyalkylene sulfate ester salt represented by General Formula (36). In the following formula, n is 1 to 20.

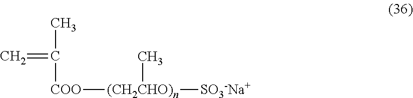

As the anionic polymerizable surfactant, commercial products may also be used. As the commercial product, for example, Eleminol RS-30 of Sanyo Chemical Industries, Ltd. can be used, which is a compound represented by General Formula (36) with n=9.

In addition, as the anionic polymerizable surfactant used in the invention, for example, a compound represented by General Formula (37) can be used.

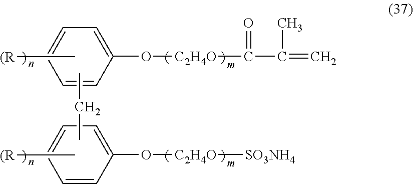

As the anionic polymerizable surfactant, commercial products may also be used, to which Antox MS-60 of Nippon Nyukazai Co., Ltd. corresponds.

The anionic polymerizable surfactants exemplified above may be used alone or as a mixture of two or more kinds thereof.

In addition, the organic polymer constituting the shell body 22 preferably includes a repeating structural unit derived from a hydrophobic monomer.

This hydrophobic monomer has at least a hydrophobic group and a polymerizable group in the molecular structure thereof. By including such a hydrophobic monomer, it is possible to improve the hydrophobic property and the polymerizable property of the shell body 22. As a result, it is possible to promote the improvement of the mechanical strength and the durability of the shell body 22.

Among these, examples of the hydrophobic group include at least one of an aliphatic hydrocarbon group, an alicyclic hydrocarbon group, and an aromatic hydrocarbon group.

Examples of the aliphatic hydrocarbon group include a methyl group, an ethyl group, and a propyl group, examples of the alicyclic hydrocarbon group include a cyclohexyl group, an dicyclopentenyl group, a dicyclopentanyl group, and an isobornyl group, and examples of the aromatic hydrocarbon group include a benzyl group, a phenyl group, and a naphthyl group.

In addition, as the polymerizable group, an unsaturated hydrocarbon group capable of radical polymerization, which is one selected from a group consisting of a vinyl group, an allyl group, an acryloyl group, a methacryloyl group, a propenyl group, a vinylidene group, and a vinylene group, is preferable.

Specific examples of the hydrophobic monomer include styrene and styrene derivatives such as methyl styrene, dimethyl styrene, chlorostyrene, dichlorostyrene, bromostyrene, p-chloromethylstyrene, and divinylbenzene; monofunctional acrylic esters as methyl acrylate, ethyl acrylate, n-butyl acrylate, butoxyethyl acrylate, benzyl acrylate, phenyl acrylate, phenoxyethyl acrylate, cyclohexyl acrylate, dicyclopentanyl acrylate, dicyclopentenyl acrylate, dicyclopentenyloxyethyl acrylate, tetrahydrofurfuryl acrylate, and isobornyl acrylate; monofunctional methacrylic esters such as methyl methacrylate, ethyl methacrylate, n-butyl methacrylate, 2-ethylhexyl methacrylate, butoxymethyl methacrylate, benzyl methacrylate, phenyl methacrylate, phenoxyethyl methacrylate, cyclohexyl methacrylate, dicyclopentanyl methacrylate, dicyclopentenyl methacrylate, dicyclopentenyloxyethyl methacrylate, tetrahydrofurfuryl methacrylate, and isobornyl methacrylate; an allyl compound such as allyl benzene, allyl-3-cyclohexane propionate, 1-allyl-3,4-dimethoxybenzene, allylphenoxy acetate, allylphenyl acetate, allylcyclohexane, and polyhydric allyl carbonate; esters of fumaric acid, maleic acid, or itaconic acid; and a monomer having radically polymerizable group such as N-substituted maleimide or cyclic olefin. The hydrophobic monomer is arbitrarily selected to satisfy the required characteristics described above and the addictive amount thereof is arbitrarily determined.

In addition, the organic polymer constituting the shell body 22 preferably includes a repeating structural unit derived from a crosslinkable monomer and/or a repeating structural unit derived from a monomer represented by the following general formula (B):

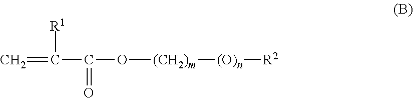

[in which R¹ represents a hydrogen atom or a methyl group, R² represents a t-butyl group, an alicyclic hydrocarbon group, an aromatic hydrocarbon group, or a heterocyclic group, m represents an integer of 0 to 3, and n represents an integer of 0 or 1].

By incorporating a repeating structural unit derived from a crosslinkable monomer in the organic polymer constituting the shell body 22, a more refined crosslinked structure is formed in the polymer. Thus, it is possible to improve the mechanical strength of the shell body 22, and in turn of the electrophoretic particle 1.

By incorporating a repeating structural unit derived from a monomer represented by General Formula (B) in the organic polymer, the flexibility of a molecule of the shell body 22 is decreased, that is, due to the migratability of a molecule being constrained, depending on the R² group which is a “bulky” group, the mechanical strength of the shell body 22 is improved. In addition, by the R² group, which is a “bulky” group present in the shell body 22, the solvent resistance of the shell body 22 is improved. In General Formula (B), examples of the alicyclic hydrocarbon group represented by R² include a cycloalkyl group, a cycloalkenyl group, an isobornyl group, a dicyclopentanyl group, a dicyclopentenyl group, an adamantane group, and a tetrahydrofuran group.

Specific examples of the crosslinkable monomer include a monomer having a compound which has two or more unsaturated hydrocarbon groups of one or more kinds selected from a vinyl group, an allyl group, an acryloyl group, a methacryloyl group, a propenyl group, a vinylidene group, and a vinylene group, for example, ethylene glycol diacrylate, diethylene glycol diacrylate, triethylene glycol diacrylate, tetraethylene glycol diacrylate, polyethylene glycol diacrylate, allyl acrylate, bis(acryloxyethyl)hydroxyethyl isocyanurate, bis(acryloxy neopentylglycol) adipate, 1,3-butylene glycol diacrylate, 1,6-hexanediol diacrylate, neopentyl glycol diacrylate, propylene glycol diacrylate, polypropylene glycol diacrylate, 2-hydroxy-1,3-diacryloxypropane, 2,2-bis[4-(acryloxy)phenyl]propane, 2,2-bis[4-(acryloxyethoxy)phenyl]propane, 2,2-bis[4-(acryloxyethoxydiethoxy)phenyl]propane, 2,2-bis[4-(acryloxyethoxypolyethoxy)phenyl]propane, hydroxy pivalic acid neopentyl glycol diacrylate, 1,4-butanediol diacrylate, dicyclopentanyl diacrylate, dipentaerythritol hexaacrylate, dipentaerythritol monohydroxy pentaacrylate, ditrimethylolpropane tetraacrylate, pentaerythritol triacrylate, tetrabromobisphenol A diacrylate, triglycerol diacrylate, trimethylolpropane triacrylate, tris(acryloxyethyl) isocyanurate, ethylene glycol dimethacrylate, diethylene glycol dimethacrylate, triethylene glycol dimethacrylate, tetraethylene glycol dimethacrylate, polyethylene glycol dimethacrylate, propylene glycol dimethacrylate, polypropylene glycol dimethacrylate, 1,3-butylene glycol dimethacrylate, 1,4-butanediol dimethacrylate, 1,6-hexanediol dimethacrylate, neopentyl glycol dimethacrylate, 2-hydroxy-1,3-dimethacryloxyl propane, 2,2-bis[4-(methacryloxy)phenyl]propane, 2,2-bis[4-(methacryloxyethoxy)phenyl]propane, 2,2-bis[4-(methacryloxyethoxydiethoxy)phenyl]propane, 2,2-bis[4 (methacryloxyethoxypolyethoxy)phenyl]propane, tetrabromobisphenol A dimethacrylate, dicyclopentanyl dimethacrylate, dipentaerythritol hexamethacrylate, glycerol dimethacrylate, hydroxy pivalic acid neopentyl glycol dimethacrylate, dipentaerythritol monohydroxy pentamethacrylate, ditrimethylolpropane tetramethacrylate, pentaerythritol trimethacrylate, pentaerythritol tetramethacrylate, triglycerol dimethacrylate, trimethylolpropane trimethacrylate, tris(methacryloxyethyl)isocyanurate, allyl methacrylate, divinylbenzene, diallyl phthalate, diallyl terephthalate, diallyl isophthalate, and diethylene glycol bisallyl carbonate.

Specific examples of the monomer represented by General Formula (B) include the following monomers.

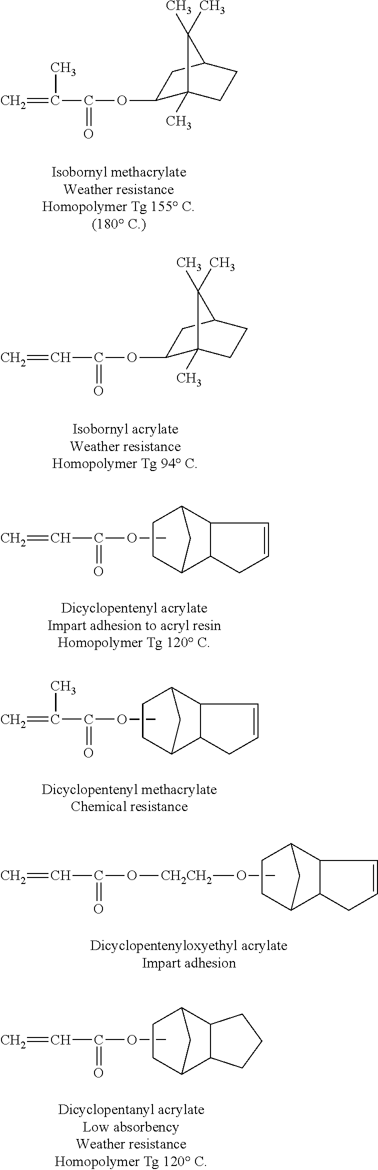

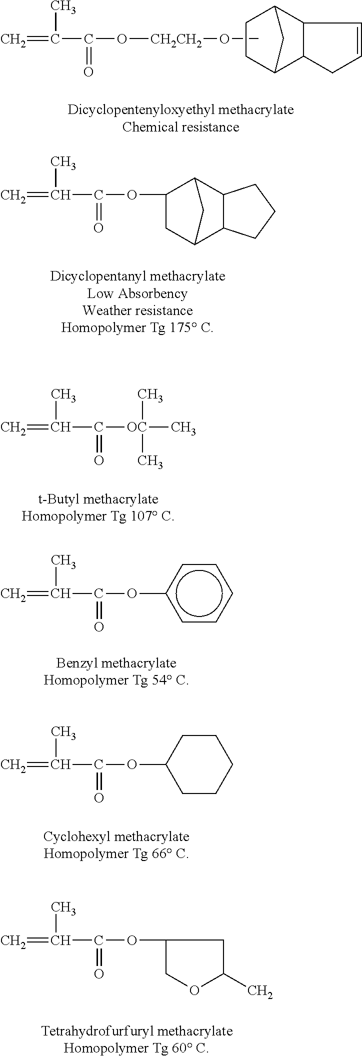

[3] Next, the second polymerizable surfactant 62 having a hydroxyl group as the second polar group 621, a hydrophobic group 622, and a polymerizable group 623 is added to the aqueous dispersion 90 as shown in FIG. 10B, and then emulsified as shown in FIG. 10C.

Furthermore, the electrification amount on the surface of the shell body 22 can be controlled by setting at least one condition out of the conditions selected from (A) the number of the second polar groups (hydroxyl groups) 621 in the second polymerizable surfactant 62, and (B) the additive amount of the second polymerizable surfactant 62 in the present processes.

Furthermore, the additive amount of the second polymerizable surfactant 62 is preferably in the range of approximately 1-fold mole of the second polymerizable surfactant 62 to 10-fold moles of the first polymerizable surfactant 61 added, and more preferably in the range of approximately 1-fold mole to 5-fold moles, with respect to the first polymerizable surfactant 61 added in the process [2]. By setting the additive amount of the second polymerizable surfactant 62 to 1-fold mole or more of the first polymerizable surfactant 61 added, it is possible to more accurately control the electrification amount of the shell body 22. On the other hand, by setting the additive amount to 10-fold moles or less, it is possible to prevent the occurrence of a hydrophilic monomer which does not contribute to the form of the shell body 22 and prevent the occurrence of a polymer particle in which a core material is not present except for the particle 2.

In addition, the aqueous dispersion 90 may be irradiated with ultrasonic waves for a predetermined time as necessary. In this manner, the arrangement pattern of the second polymerizable surfactant 62 which is present around the particle 2 is controlled to a high degree.

As the second polymerizable surfactant 62, among the polymerizable surfactants included as the first polymerizable surfactant as described above, a polymerizable surfactant having the second polar group (hydroxyl group) 621 is used so as to react with a polymerization initiator having a polymerization initiating group in the subsequent process [5]. That is, an anionic polymerizable surfactant having an alkoxide anionic group (—O⁻) as an anionic group is used.

[4] Next, the polymerization initiator 80 is added to the aqueous dispersion 90 as shown in FIG. 10C to cause a polymerization reaction to occur. In this manner, the particle (encapsulated mother particle) 2, made by engulfing the mother particle 21 in the form of a capsule by the shell body 22 constituted with the organic polymer, is obtained.

At this time, the temperature of the aqueous dispersion 90 is heated up to a predetermined temperature (the temperature at which the polymerization initiator 80 is activated) as necessary. In this manner, it is possible to reliably activate the polymerization initiator 80 and allow the polymerization reaction in the aqueous dispersion 90 to suitably proceed.

As the polymerization initiator 80, a water-soluble polymerization initiator is preferable, and examples thereof include potassium persulfate, ammonium persulfate, sodium persulfate, 2,2-azobis-(2-methylpropion amidine)dihydrochloride, and 4,4-azobis(4-cyanovaleric acid), and one kind or a combination of two or more kinds thereof may be used.

Here, according to an emulsion polymerization method which is polymerization in the aqueous dispersion 90 as explained above, it is presumed that the first polymerizable surfactant 61 and each of the monomers show the following behavior in the aqueous dispersion 90. Here, a case of further adding a hydrophobic monomer in the process [2] will be described below.

First, the first polymerizable surfactant 61 is adsorbed onto the charge 64 included in the particle 2 in the aqueous dispersion 90, and next, the aqueous dispersion 90 is irradiated with ultrasonic waves. Then, a hydrophobic monomer and a second polymerizable surfactant 62 are added to the aqueous dispersion 90, and irradiated with ultrasonic waves. Thus, the arrangement pattern of the first polymerizable surfactant 61 present around the particle 2 and the monomer is controlled to a high degree, and as a result, the first polar group 611 is aligned toward the center of the particle 2 on the innermost shell. Further, a state where the second polar group 621 is aligned toward the aqueous dispersion 90 (the outer side of the particle 2) on the outermost shell is formed. Further, the monomer is transformed into an organic polymer to form the shell body 22, as the pattern which is controlled to a high degree by emulsion polymerization, the particle 2, made by engulfing the mother particle 21 in the form of a capsule by the shell body 22, is formed.

According to the above method, it is possible to decrease the production of a water-soluble oligomer or polymer, which is a by-product. Thus, it is possible to reduce the viscosity of the aqueous dispersion 90 in which the obtained particles 2 are dispersed, and therefore, further facilitate the purification process such as ultrafiltration.

The polymerization reaction as described above is preferably carried out in a reactor vessel provided with an ultrasonic generator, a mixer, a reflux condenser, a dropping funnel, and a temperature regulator.

By increasing the temperature up to the cleavage-temperature of the polymerization initiator 80 which has been added to the reaction system (the aqueous dispersion 90), a polymerization reaction makes the polymerization initiator 80 cleave to generate initiator radicals. By the initiator radicals attacking unsaturated groups of the respective polymerizable surfactants 61 and 62 or unsaturated groups of the monomers, the polymerization reaction is initiated.

The addition of the polymerization initiator 80 into the reaction system can be carried out, for example, by dripping a solution in which the water-soluble polymerization initiator 80 is dissolved into the pure water, into the reactor vessel. At this time, a solution including the polymerization initiator 80 in the aqueous dispersion 90 which is heated up to the temperature at which the polymerization initiator 80 is activated may be added all at once or separately, or may be continuously added.

In addition, after adding the polymerization initiator 80, the aqueous dispersion 90 may be heated up to the temperature at which the polymerization initiator 80 is activated.

Moreover, as described above, it is preferable that a water-soluble polymerization initiator is used as a polymerization initiator 80 and a solution obtained by dissolving this into the pure water is added by dripping it into the aqueous dispersion 90 in the reactor vessel. In this manner, the added polymerization initiator 80 is cleaved, the initiator radical is generated, and by attacking a polymerizable group of the respective polymerizable surfactants 61 and 62 or a polymerizable group of a polymerization monomer, the polymerization reaction occurs. The polymerization temperature and the polymerization reaction time vary depending on the type of the polymerization initiator 80 used and the type of the polymerization monomer, but a person skilled in the art can facilitate the process to arbitrarily set the preferable polymerization conditions.

The activation of the polymerization initiator 80 in the reaction system can be suitably carried out by heating up the aqueous dispersion 90 to a predetermined polymerization temperature as described above. The polymerization temperature is preferably set to be in the range of 60° C. to 90° C. In addition, the polymerization time is preferably set to from 3 hours to 10 hours.

The particle 2 obtained as described above becomes a particle in which the mother particle 21 is engulfed by the shell body 22.

Here, in the preparation process of the particle 2 thus obtained, one example of the behavior shown in the respective polymerizable surfactants and the respective monomers will be described in more detail, based on FIGS. 11A and 11B.

When the first polymerizable surfactant 61 is added to the aqueous dispersion 90, the charge 64 included in the mother particle 21 and the first polar group 611 of the first polymerizable surfactant 61 are ionically bonded to each other. By the opposite polarities being bonded to each other, both polarities (the charge 64 and the first polar group 611) are cancelled.

In addition, the first hydrophobic group 612 of the first polymerizable surfactant 61 faces the hydrophobic group 622 of the second polymerizable surfactant 62, and the second polar group (hydroxyl group) 621 of the second polymerizable surfactant 62 is aligned toward the side of the aqueous dispersion 90 (the outer side of the particle 2), thereby forming a micelle-like structure as shown in FIG. 11A.

When the polymerization reaction is carried out in this state, the shell body 22 constituted with an organic polymer as shown in FIG. 11B with the above structure maintained is formed on the surface of the mother particle 21 in the state where the second polar group (hydroxyl group) 621 exposed on the surface. That is, the arrangement pattern of each of the polymerizable surfactants 61 and 62 which are present around the mother particle 21 before the polymerization reaction is controlled to an extremely high level. Then, by an emulsion polymerization reaction, each of the polymerizable surfactants 61 and 62, and each of the monomers are transformed into organic polymers as a pattern which has been controlled to a high degree. Therefore, the particle 2 prepared by the above method has the second polar group (hydroxyl group) 621 exposed on the surface thereof. The structure of this particle 2 is controlled with an extremely high degree of accuracy.

In addition, one example of other behaviors shown in the respective polymerizable surfactants and the respective monomers will be described, based on FIGS. 12A and 12B.

In the first polymerizable surfactant 61, the first polar group 611 is aligned toward the mother particle 21 having the negative charge 64 and absorbed onto the mother particle 21 with ionically strong bonds as shown in FIG. 12A. On the other hand, the hydrophobic group 612 and the polymerizable group 613 of the first polymerizable surfactant 61 face the hydrophobic group 622 and the polymerizable group 623 of the second polymerizable surfactant 62, respectively, by the hydrophobic interaction, and as a result, the second polar group 621 faces a direction in which the aqueous dispersion 90 is present, that is, in a direction away from the mother particle 21.

In addition, the surface of the mother particle 21 has a negative charge 64 which is chemically bonded with the specific density and a hydrophobic area 70 between the negative charges 64, and in the hydrophobic area 70, a hydrophobic group 612″ and a polymerizable group 613″ of another first polymerizable surfactant 61″ face. Then, the first polymerizable surfactant 61 is arranged so that the first polar group 611 thereof faces the first polar group 611″ of another first polymerizable surfactant 61″. Each hydrophobic group 622 and each polymerizable group 623 of the second polymerizable surfactant 62 face each hydrophobic group 612 and each polymerizable group 613 of the first polymerizable surfactant 61, respectively, by the hydrophobic interaction, and as a result, the second polar group 621 is faced in a direction in which the aqueous dispersion 90 is present, that is, in a direction away from the particle 2.

For example, the polymerization initiator 80 is added to the aqueous dispersion 90 in such a dispersion state to polymerize each of the polymerizable groups 613, 613″, and 623 of the first polymerizable surfactants 61 and 61″, and the second polymerizable surfactant 62. Thus, the particle 2 in which the mother particle 21 is engulfed by the shell body 22′ is prepared as shown in FIG. 12B.

Each of the polymerizable surfactants 61 and 62 forms a micelle-like structure in which the second polar group 621 of the second polymerizable surfactant 62 in the outermost shell is aligned toward the side of the aqueous dispersion 90 after the charge 64 included in the mother particle 21 and the first polar group 611 of the first polymerizable surfactant 61 are ionically bonded in the polymerization system, and then forms the shell body 22 by generating an organic polymer by a polymerization reaction. Thus, the arrangement pattern of a monomer present around the mother particle 21 before the emulsion polymerization affects the state of the polarization in the vicinity of the mother particle 21 after the polymerization, and therefore, it may be said that it is possible to control the process with a high degree of accuracy.

As a result, the obtained particle 2, in which the second polar group (hydroxyl group) 621 is arranged outside thereof, becomes a particle having electrification polarity which depends on the hydroxyl group. Further, the particle 2 has charges in the electrification amount which depends on the number of the second polar group 621 in the second polymerizable surfactant 62, the molecular weight of the second polymerizable surfactant 62, and the additive amount of the second polymerizable surfactant 62.

Furthermore, in the polymerization reaction, one kind or two or more kinds of each of the polymerizable surfactants, a hydrophobic monomer, a crosslinkable monomer, and other well-known polymerization monomers may be respectively used.

In addition, since the emulsion polymerization reaction is carried out using an ionic polymerizable surfactant, the state of emulsion of a mixed solution including raw material monomers is good without using an emulsifying agent in many cases. Therefore, it is not necessary to use the emulsifying agent, but at least one selected from a group consisting of well-known anionic, non-ionic, and cationic emulsifying agents may be used as necessary.

[5] Next, by drying the aqueous dispersion 90 including the particles 2 as shown in FIG. 10D, a dried product 86 of the particles 2 is obtained.

Here, since the hydroxyl group (—OH group) is exposed from the surface of the shell body 22, a hydrogen bond is generated between the hydroxyl groups of the shell body 22 provided in the adjacent particles 2. As a result, an aggregate in which a plurality of particles 2 are aggregated with each other in the dried product 86 is formed.

The drying of the aqueous dispersion 90 can be carried out by various drying methods such as freeze drying, through-flow drying, surface drying, fluidization drying, flash drying, spray drying, vacuum drying, infrared ray drying, high-frequency drying, ultrasonic wave drying, and pulverization drying, for example. Among these drying methods, freeze drying is preferable. By the freeze drying, the drying is carried out by subliming the aqueous dispersion 90 from solid to gas, and the particles 2 can be dried while not giving a substantial influence on the original shape, function, or the like in the shell body 22 included in the particles 2.

In addition, as this freeze drying method, the same method as described in the subsequent process [8] can be used.

Moreover, it is preferable to carry out a purification process such as ultrafiltration, for purifying the particles 2 in the aqueous dispersion 90 before drying the aqueous dispersion 90. In this manner, it is possible to remove the water-soluble oligomers or polymers, included as a by-product in the aqueous dispersion 90, and thus, the content of the particles 2 in the dried product 86 can be increased.

In the present embodiment, by carrying out the processes [1] to [5] as described above, an aggregate in which the particles 2 are aggregated with each other due to a hydrogen bond generated from the hydroxyl group is prepared.

[6] Next, the polymer 32 having a functional group Z having reactivity with the second polar group (hydroxyl group) 621 is added to the dried product (aggregated) 86, and mixed, as shown in FIG. 10E, to obtain a mixture 85 (first process). This process is preferably carried out in an inert gas atmosphere such as an argon gas and a nitrogen gas.

Here, as described in the process [5], an aggregate in which the particles 2 are aggregated with each other is formed in the dried product 86. In the present embodiment, the content of the polymer 32 except for the dried product 86 (particles 2) in the mixture 85 is set to a high content (high concentration) which is 75% by weight or more. In the mixture 85, the polymer 32 is linked to the surface of the particles 2. At this time, since the polymer 32 is present at a high content as described above, the affinity of the particles 2 having the polymer 32 linked to the surface thereof for the mixture 85 is increased, and thus, the particles are easily dispersed in the mixture 85. Thus, the aggregation between the particles 2 is easily dissociated, and thus, the ratio of particles having a large particle diameter, considered to have aggregation of a plurality of particles 2, can be reduced. In addition, the polymer 32 can be linked to approximately the entire surface of the particles 2. As a result, the particles 2 having the polymer 32 linked to the surface thereof are dispersed in the mixture 85 (see FIG. 10F).

Hereinafter, “the content of the polymer 32 except for the dried product 86 (particles 2) in the mixture 85” is simply referred to as “the content of the polymer 32” in some cases for the sake of convenience in description.

In the present embodiment, it is presumed that the linking of the polymer 32 to approximately the entire surface of the particles 2 as described above is due to a mechanism as follows. Further, in FIGS. 13A to 13C, the polymer 32 included in the mixture 85 is denoted as “P”.

That is, when an aggregate of the particles 2 which are aggregated by hydrogen bonds between the hydroxyl groups exposed from the surface thereof is engulfed by the polymer 32 at a high concentration (see FIG. 13A), the hydroxyl group exposed from the outermost surface of the aggregate is reacted with the functional group Z contained in the polymer 32. Further, after the reaction, a sufficient amount of the unreacted polymer 32 is present near the position. By this, as shown in FIG. 13B, the affinity of a site derived from the polymer 32 bonded to the surface of the particles 2 for the polymer 32 in the mixture 85 becomes higher than the aggregation force due to a hydrogen bond or the like, exerted between the particles 2 having the polymer 32 bonded to the surface thereof and other particles 2. As a result, the particles 2 are dispersed in the mixture 85. Thus, the reaction between the hydroxyl groups exposed on the surface of the other particles 2 and the functional group Z contained in the polymer 32 further proceeds with such a reaction being repeated, and thus, consequently, the aggregation between the particles 2 is dissociated. As a result, as shown in FIG. 13C, it is presumed that the particles 2 having the polymer 32 linked to approximately the entire surface thereof are mono-dispersed in the mixture 85.

By the reaction between the second polar group (hydroxyl group) 621 and the functional group Z as described above, the polymer 32 is linked to approximately the entire surface of the shell body 22 (particles 2). That is, the polymer 32 is introduced to the surface of the particles 2.

The polymer 32 is a polymeric compound having a functional group Z having reactivity with the second polar group (hydroxyl group) 621 and a repeat 33 formed by polymerization of the monomers M, as described above.

Examples of the functional group Z provided in the polymer 32 include a halogenated carboxyl group and a halogenated sulfonic acid, and one of them is selected. Since such a halogenated acidic group has excellent reactivity with a hydroxyl group, it can reliably link the polymer 32 to the surface of the shell body 22.

Accordingly, specific examples of the polymer 32 include acid halogenated polymeric compounds represented by the following general formula (2) or (3), and a group R³ in the following general formula (2) or (3) represents a linking group for linking the functional group Z with the repeat 33:

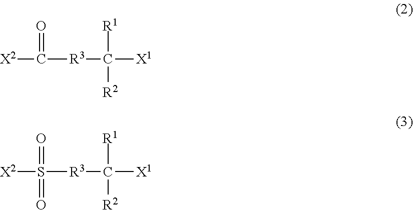

[in Formulae (2) and (3), M represents a repeating unit derived from the monomer, m represents an integer of 1 or more, R³ represents a group selected from at least one of a single bond, hydrogen, an alkylene or arylene group having 1 to 20 carbon atoms, an ether group, a ketone group, and an ester group, and X² represents chlorine, bromine, or iodine].

Examples of such a polymer 32 include compounds represented by the following general formulae (4) to (7):

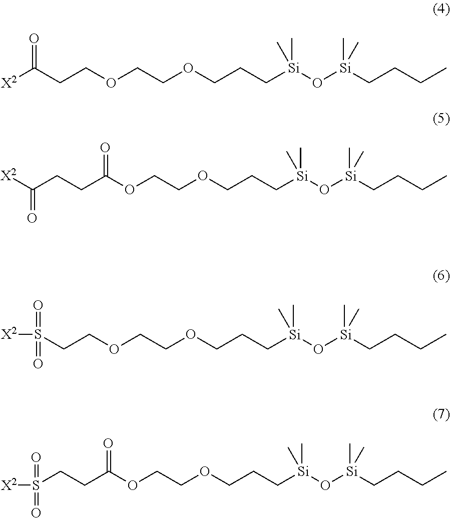

[in Formulae (4) to (7), X²'s each independently represent chlorine, bromine, or iodine].

In the present embodiment, the content of the polymer 32 may be 75% by weight or more, preferably 85% by weight or more, more preferably 95% by weight or more, and still more preferably 100% by weight. Thus, the affinity of a site derived from the polymer 32 bonded to the surface of the particles 2 for the polymer 32 in the mixture 85 reliably becomes higher than the aggregation force due to a hydrogen bond or the like, exerted between the particles 2 having the polymer 32 bonded to the surface thereof and other particles 2. As a result, the dispersibility of the particles 2 into the mixture 85 can be further improved.

Moreover, in the case where the content of the polymer 32 is set to 75% by weight or more and less than 100% by weight, a solvent is added to the mixture 85 so as to set the content of the polymer 32 to the range described above. This solvent is preferably a non-polar solvent or a low-polarity solvent. Thus, an acid halogenated polymeric compound represented by General Formula (2) or (3), which is used as the polymer 32, can be prevented from being decomposed in the functional group Z by the solvent.

Such a non-polar solvent or the low-polarity solvent is not particularly limited, examples thereof include hexane, cyclohexane, benzene, toluene, xylene, diethylether, chloroform, ethyl acetate, methylene chloride, isooctane, decane, dodecane, tetradecane, and tetrahydrofuran, and one kind or a combination of two or more kinds thereof may be used, and further, a solvent containing a polymer not containing a functional group Z (for example, a repeat 33 formed by polymerization of the monomer M) can be used.

Thus, the electrophoretic particle 1 is prepared.

[7] Next, the electrophoretic particle 1 is collected from the mixture 85 as necessary.

As a collecting method, various filtration methods such as ultrafiltration, nanofiltration, microfiltration, cake filtration, and reverse osmosis are included and one kind or a combination of two or more kinds thereof may be used. Among these, ultrafiltration is particularly preferably used.

Ultrafiltration is a method for filtering fine particles, which is suitably used as a method for filtering the electrophoretic particle 1.

[8] Next, the electrophoretic particle 1 is dried as necessary.

The drying of the electrophoretic particle 1, for example, is carried out by various drying methods such as freeze drying, through-flow drying, surface drying, fluidization drying, flash drying, spray drying, vacuum drying, infrared ray drying, high-frequency drying, ultrasonic wave drying, and pulverization drying, but the drying is preferably carried out by freeze drying.

According to the freeze drying, it is possible to dry the shell body 22 mostly without affecting the original shapes, functions, or the like in the shell body 22 included in the electrophoretic particle 1 due to the drying by sublimation of the mixture 85 from solid to liquid.

Hereinafter, a method for freeze drying the electrophoretic particle 1 will be described.

First, the electrophoretic particle 1 which is separated out from the mixture 85 by filtration is cooled and frozen. In this manner, a liquid-phase component (liquid component) such as a solvent included in the electrophoretic particle 1 is changed to solid.

The cooling temperature is not particularly limited as long as cooling temperature is equal to or lower than the temperature at the liquid-phase component is frozen, but it is preferably approximately −100° C. to −20° C., and more preferably −80° C. to −40° C. If the cooling temperature is higher than the range of the temperature described above, there is a case where the liquid-phase component is unable to be sufficiently solidified. On the other hand, if the cooling temperature is lower than the range of the temperature described above, it is not possible to expect the solidification of the liquid-phase component any more.

Next, the surrounding area of the frozen electrophoretic particle 1 is reduced in pressure. In this manner, the boiling point of the liquid-phase component is decreased, and therefore, it is possible to sublimate the liquid-phase component.

The pressure during the reduction of pressure varies depending on the composition of the liquid-phase component, but it is preferably approximately 100 Pa or less, and more preferably approximately 10 Pa or less. If the pressure during the reduction of pressure is within the range described above, it is possible to more reliably sublimate the liquid-phase component.

In addition, since the pressure of the surrounding area of the electrophoretic particle 1 along with the sublimation of the liquid-phase component is increased, it is preferable to continuously exhaust using a vacuum pump or the like during freeze drying and maintain a constant level of pressure. In this manner, it is possible to prevent an increase in the pressure and prevent a decrease in the efficiency of the sublimation of the liquid-phase component.

In this manner, it is possible to carry out freeze drying of the electrophoretic particle 1.

Furthermore, in the method for preparing electrophoretic particles according to the first and second embodiments of the invention as described above, particles 2 which have a mother particle 21 and a shell body 22, and have a hydroxyl group exposed from the surface of the shell body 22, thereby exhibiting hydrophilicity (having polarity) are described. Such particles 2 are aggregated in a non-polar solvent or the low-polarity solvent to form an aggregate, but the particles 2 are not limited to particles with such a configuration. For example, the particles may have a hydroxyl group exposed from the surface thereof to form an aggregate, and they may be, for example, particles having a surface modified with one having a low or high molecular weight with the surface of the mother particle 21 including a hydroxyl group. Further, examples of the one having a low molecular weight include alcohols such as a monool, a diol, and a triol, and a non-ionic surfactant provided with a hydroxyl group at a terminal thereof. Further, examples of the one having a high molecular weight include celluloses such as polyvinyl alcohol and carboxymethyl cellulose, gum arabic, albumin, gelatin, and polyethylene glycol. In addition, the preparation method of the present embodiment is suitable, in particular for particles having a high density of the hydroxyl group on the surface of the particles and high hydrophilicity. Here, high hydrophilicity means that the water contact angle is 30° or lower.

### Electrophoretic Dispersion

Next, the electrophoretic dispersion of the invention will be described.

In the electrophoretic dispersion, at least one of electrophoretic particles (the electrophoretic particles of the invention) is dispersed (suspended) in a dispersion medium (liquid phase dispersion medium; an organic solvent).

As the dispersion medium, a solvent which has a high boiling point of 100° C. or higher and has a relatively high insulation property is preferably used. Examples of the dispersion medium include various water (for example, distilled water and pure water), alcohols such as butanol and glycerol, cellosolves such as butyl cellosolve, esters such as butyl acetate, ketones such as dibutyl ketone, aliphatic hydrocarbons (liquid paraffin) such as pentane, alicyclic hydrocarbons such as cyclohexane, aromatic hydrocarbons such as xylene, halogenated hydrocarbons such as methylene chloride, aromatic heterocycles such as pyridine, nitriles such as acetonitrile, amides such as N,N-dimethyl formamide, carboxylates, silicone oils, and other various oils. These can be used as a single solvent or a mixed solvent.

Among these, as the dispersion medium, aliphatic hydrocarbons (liquid paraffin such as Isopar) or a solvent having silicone oil as a main component is preferred. The dispersion medium having liquid paraffin or silicone oil as a main component has a substantial influence of preventing the aggregation of the electrophoretic particles 1, and therefore, the display performance exhibited by the electrophoretic display device 920 is prevented from being deteriorated over time. Further, since the liquid paraffin or silicone oil has no unsaturated bond, there are advantages of excellent weather resistance and higher safety.

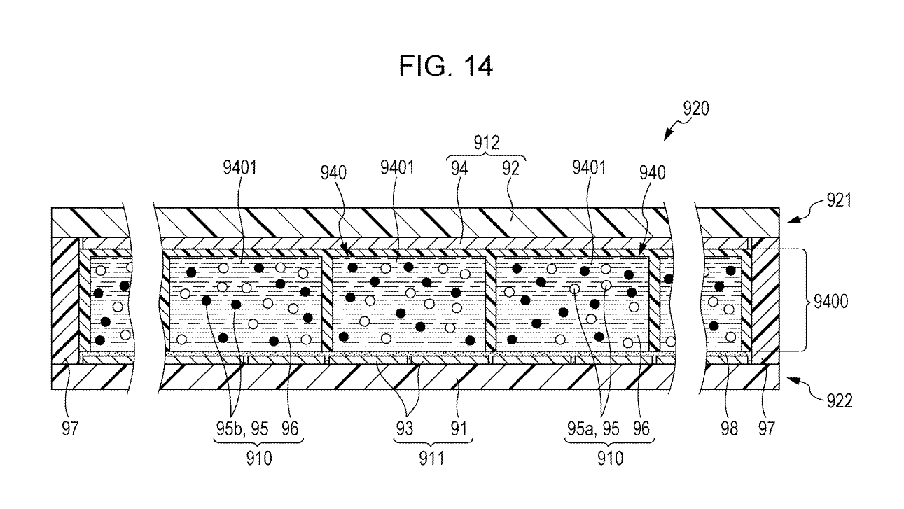

Furthermore, as the dispersion medium, a dispersion medium having a specific dielectric constant of from 1.5 to 3 is preferably used, and a dispersion medium having a specific dielectric constant of from 1.7 to 2.8 is more preferably used. Such a dispersion medium provides excellent dispersibility of the electrophoretic particles 1 as well as a good electrically insulating property, which contributes to realization of an electrophoretic display device 920 shown in FIG. 14, having reduced electricity consumption and capable of high-contrast display. Further, the value of this dielectric constant is a value measured at 50 Hz, which is measured with respect to a dispersion medium having a moisture content of 50 ppm or less and a temperature of 25° C.

In addition, in the dispersion medium, for example, various additional agents such as a charge control agent consisting of particles such as an electrolyte, a (anionic or cationic) surfactant agent, a metal soap, a resin material, a rubber material, oils, a varnish or a compound, lubricant, stabilization or various dyes may be added as necessary.

In addition, the dispersion of the electrophoretic particle into the dispersion medium may be carried out, for example, by one kind or two or more kinds in combination of a paint shaker method, a ball mill method, a media mill method, an ultrasonic dispersion method, a stirring dispersion method or the like.

In such an electrophoretic dispersion, the electrophoretic particle 1 starts to exhibit both excellent dispersion ability and migratability due to the action of a polymer 32 included in a coating layer 3.

### Electrophoresis Display Device

Next, an electrophoretic display device (an electrophoretic device in the invention) to which an electrophoretic sheet of the invention is applied will be described.

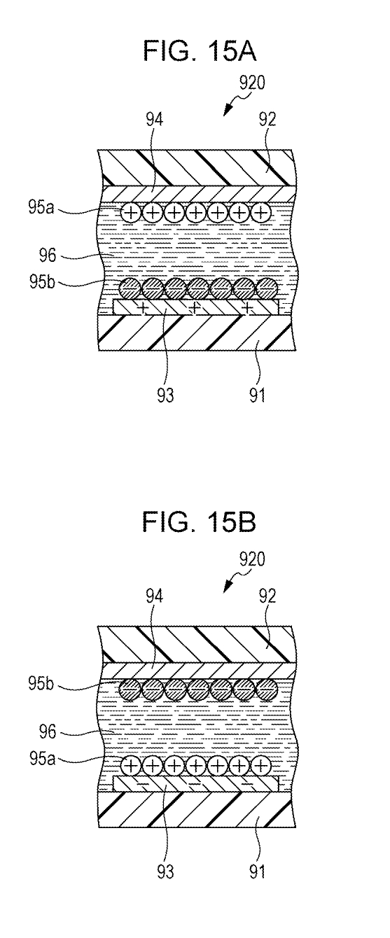

FIG. 14 is a view schematically showing the longitudinal cross-section of the electrophoretic display device according to an embodiment. FIGS. 15A and 15B are each a view schematically showing the operation principle of the electrophoretic display device shown in FIG. 14. Here, hereinbelow, the upper side and the lower side will be denoted as “upper” and “lower”, respectively, in FIGS. 14, 15A and 15B, for the sake of convenience in description.

The electrophoretic display device 920 shown in FIG. 14 includes an electrophoretic display sheet (front plane) 921, a circuit substrate (backplane) 922, an adhesive layer 98 which joins the electrophoretic display sheet 921 and the circuit substrate 922 and a sealing unit 97 which hermetically seals the gap between the electrophoretic display sheet 921 and the circuit substrate 922.

The electrophoretic display sheet (the electrophoretic sheet in the invention) 921 includes a display layer 9400 configured by a substrate 912 provided with a tabular type basal unit 92 and the second electrode 94 which is arranged on the under surface of the basal unit 92, a partition 940 which is arranged on the under surface (other surface) side of the substrate 912 and is formed in a matrix state, and the electrophoretic dispersion 910.

On the other hand, the circuit substrate 922 includes an opposed substrate 911 provided with a tabular type basal unit 91 and a plurality of the first electrodes 93 which are arranged on the upper surface of the basal unit 91 and a circuit (not shown) including a switching element, for example, such as TFT provided on the opposed substrate 911 (the basal unit 91).

Hereinafter, configurations of the respective units will be described in order.

The basal unit 91 and the basal unit 92 are respectively constituted with a sheet type (tabular type) member and have the functions to support and protect each member which is arranged between these.

Each of the basal units 91 and 92 may be configured with either a member having flexibility or a soft member, but a basal unit having flexibility is preferable. By using the basal units 91 and 92 having flexibility, it is possible to obtain an electrophoretic display device 920 having flexibility, that is, for example, the useful electrophoretic display device 920 when an electronic paper is constructed.

In addition, in the case where each of the basal units (base layers) 91 and 92 is configured with a member having flexibility, these are preferably respectively constituted with a resin material.

An average thickness of such basal units 91 and 92 is arbitrarily set depending on a constituent material, a use, or the like, respectively, and is not particularly limited, but the thickness is preferably approximately 20 μm to 500 μm, and more preferably approximately 25 μm to 250 μm.

A first electrode 93 and a second electrode 94 which is the form of laminate (membranal) are respectively arranged on the surface of the partition 940 side of the basal units 91 and 92, that is, the upper surface of the basal unit 91 and the lower surface of the basal unit 92.

When the voltage is applied between the first electrode 93 and the second electrode 94, the electric field occurs between these and this electric field acts to electrophoretic particles 95 (the electrophoretic particles in the invention).

In the present embodiment, the second electrode 94 is set as a common electrode, the first electrode 93 is set as an individual electrode (a pixel electrode connected to a switching element) which is divided in a matrix state (in line state), and the part in which the second electrode 94 and one first electrode 93 are overlapped configures one pixel in the electrophoretic display device 920 having such as configuration.

The constituent materials of each of the electrodes 93 and 94 are not particularly limited as long as each of the electrodes has substantially conductivity.

An average thickness of such electrodes 93 and 94 is arbitrarily set depending on a constituent material, a use, or the like, respectively, and is not particularly limited, but the thickness is preferably approximately 0.05 μm to 10 μm, and more preferably approximately 0.05 μm to 5 μm.

Furthermore, among each of the basal units 91 and 92 and each of the electrodes 93 and 94, a basal unit and an electrode (the basal unit 92 and the second electrode 94 in the present embodiment) which are arranged on the display surface side are respectively set as a basal unit and an electrode having optical transparency, that is, the basal unit 92 and the second electrode 94 are substantially transparent (colorless and transparent, colored and transparent, or translucent).

On the electrophoretic display sheet 921, a display layer 9400 which comes into contact with the lower surface of the second electrode 94 is arranged.

This display layer 9400 is configured with the electrophoretic dispersion (the electrophoretic dispersion in the invention as described above) 910 stored (sealed) inside a plurality of pixel spaces 9401 defined by the partition 940.

The partition 940 is formed so as to divide in a matrix state between the opposed substrate 911 and the substrate 912.

Examples of the constituent material of the partition 940 include various resin materials or the like of thermoplastics resins such as an acrylic-based resin, a urethane-based resin, and an olefin-based resin, thermosetting resins such as an epoxy-based resin, a melamine-based resin, and a phenol-based resin, and one kind or a combination of two or more kinds thereof may be used.

The electrophoretic dispersion 910 which is stored in the pixel spaces 9401 is an electrophoretic dispersion which disperses (suspends) two kinds of colored particle 95b and white particle 95a (at least one of the electrophoretic particles 1) into a dispersion medium 96 in the present embodiment, and the electrophoretic dispersion of the invention as described above is applied thereto.

In such an electrophoretic display device 920, when the voltage is applied between the first electrode 93 and the second electrode 94, the colored particle 95b and the white particle 95a (the electrophoretic particles 1) are electrophoresed toward either electrode according to the electric field occurring therebetween.

In the present embodiment, as a white particle 95a, a white particle having the positive charge is used and as a colored particle (a black particle) 95b, a colored particle having the negative charge is used. That is, as a white particle 95a, the electrophoretic particle 1 in which the polymer 32 is positively charged is used and as a colored particle 95b, the electrophoretic particle 1 in which the polymer 32 is negatively charged is used.

In the case of using such an electrophoretic particle 1, when the first electrode 93 is set as a potential, the white particle 95a moves to the side of the second electrode 94 and gathers at the second electrode 94 as shown in FIG. 15A. On the other hand, the colored particle 95b moves to the side of the first electrode 93 and gathers at the first electrode 93. For this reason, when the electrophoretic display device 920 is seen from above (display surface side), the color of the white particle 95a can be seen, that is, a white color can be seen.

In contrast, when the first electrode 93 is set as a negative potential, the white particle 95a moves to the side of the first electrode 93 and gathers at the first electrode 93 as shown in FIG. 15B. On the other hand, the colored particle 95b moves to the side of the second electrode 94 and gathers at the second electrode 94. For this reason, when the electrophoretic display device 920 is seen from above (display surface side), the color of the colored particle 95b can be seen, that is, a black color can be seen.

In such a configuration, by arbitrarily setting the electrification amount of the white particle 95a and the colored particle 95b (the electrophoretic particle 1), the polar of the electrode 93 or 94, the potential difference between the electrodes 93 and 94, or the like, the desired information (image) is displayed on the display surface side of the electrophoretic display device 920 according to the color combination of the white particle 95a and the colored particle 95b, the number of particles gathered at the electrodes 93 and 94, or the like.

In addition, the specific gravity of the electrophoretic particle 1 is preferably set to be almost the same as the specific gravity of the dispersion medium 96. In this manner, even after the voltage impression is stopped between the electrodes 93 and 94, the electrophoretic particle 1 can remain for a long period at a fixed position in the dispersion medium 96. That is, information displayed on the electrophoretic display device 920 is maintained for a long period.

Here, an average particle diameter of the electrophoretic particles 1 is preferably approximately 0.1 μm to 10 μm and is more preferably approximately 0.1 μm to 7.5 μm. An average particle diameter of the electrophoretic particles 1 is set to be in the range described above, it is possible to reliably prevent the aggregation between the electrophoretic particles 1 and the sedimentation in the dispersion medium 96 and as a result, it is possible to suitably prevent the deterioration of the display quality of the electrophoretic display device 920.

In the present embodiment, the electrophoretic display sheet 921 and the circuit substrate 922 are joined through the adhesive layer 98. In this manner, it is possible to more reliably fix the electrophoretic display sheet 921 and the circuit substrate 922.

An average thickness of the adhesive layer 98 is not particularly limited, but the thickness is preferably approximately 1 μm to 30 μm, and more preferably approximately 5 μm to 20 μm.

A sealing unit 97 is arranged between the basal unit 91 and the basal unit 92 along with marginal part thereof. Each of the electrodes 93 and 94, the display layer 9400, and the adhesive layer 98 are hermetically sealed by the sealing unit 97. In this manner, it is possible to prevent the water entry into the electrophoretic display device 920, and more reliably prevent the deterioration of display performance of the electrophoretic display device 920.

As a constituent material of the sealing unit 97, the same constituent material as a constituent material of the partition 940 as described above can be used.

### Electronic Device

Next, the electronic device of the invention will be described.

The electronic device of the invention is provided with the electrophoretic display device 920 as described above.

### Electronic Paper

First, a case where the electronic device according to an embodiment of the invention is applied to an electronic paper will be described.

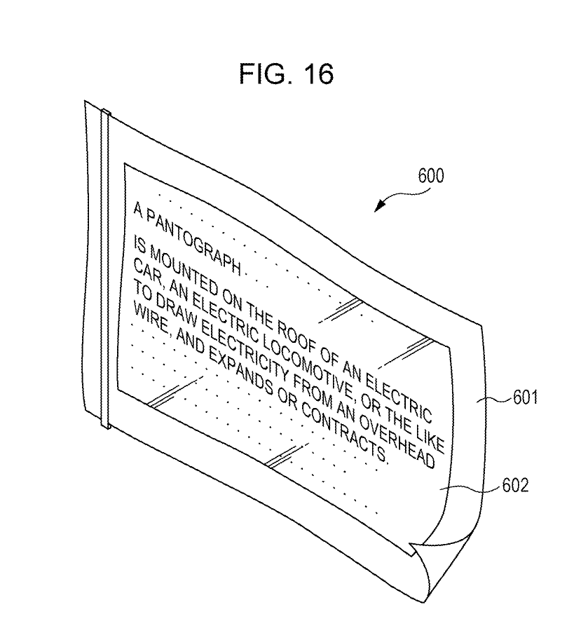

FIG. 16 is a perspective view showing a case where the electronic device according to an embodiment of the invention is applied to an electronic paper.

An electronic paper 600 shown in FIG. 16 is provided with a body 601 which is constituted with a rewritable sheet, having texture and bendability as same as papers and a display unit 602.

In such an electronic paper 600, the display unit 602 is constituted with the electrophoretic display device 920 as described above.

### Display

Next, a case where the electronic device according to an embodiment of the invention is applied to a display will be described.

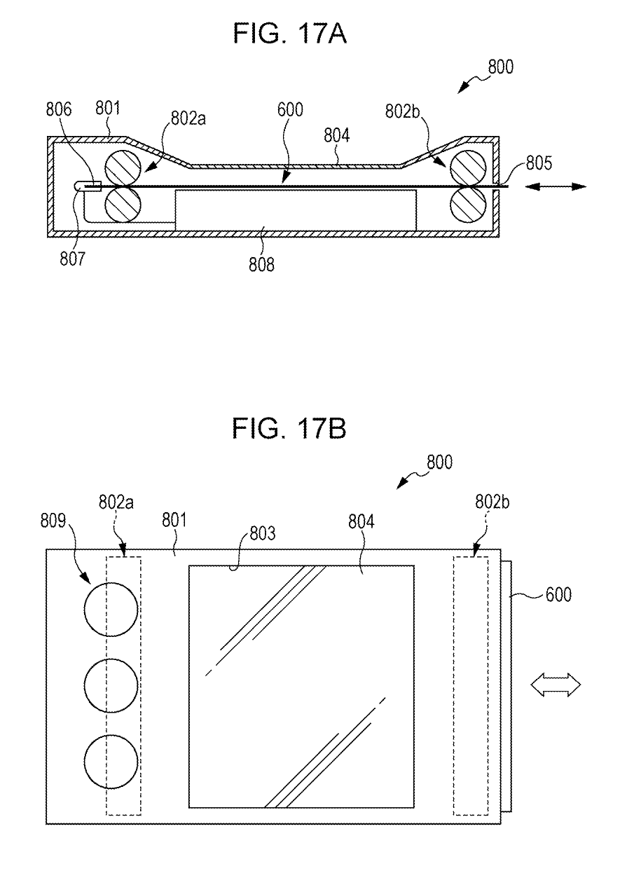

FIGS. 17A and 17B are each a view showing a case where the electronic device according to an embodiment of the invention is applied to a display. Among these, FIG. 17A is a cross-sectional view and FIG. 17B is a plan view.

A display (display device) 800 shown in FIGS. 17A and 17B is provided with a body unit 801 and the electronic paper 600 which is removably arranged with respect to the body unit 801.

In the body unit 801, an insertion port 805 in which the electronic paper 600 is capable of being inserted into the side part thereof (in FIG. 17A, right side) is formed. Further, two sets of transfer roller pair 802a and 802b are arranged the inside. When the electronic paper 600 is inserted into the body unit 801 through the insertion port 805, the electronic paper 600 with the condition sandwiched by the transfer roller pair 802a and 802b is placed in the body unit 801.

In addition, on the display surface side of the body unit 801 (in FIG. 17B, the front side of the paper-surface), a rectangular hole unit 803 is formed and a transparent glass plate 804 is put into this hole unit 803. In this manner, it is possible to visually recognize the electronic paper 600 in the state of being placed in the body unit 801 from the outside of the body unit 801. That is, in this display 800, the display surface is constituted with visually recognizing the electronic paper 600 of the state of being placed in the body unit 801 on the transparent glass plate 804.

Furthermore, a terminal unit 806 is arranged at the pointed end of the insertion direction of the electronic paper 600 (in FIGS. 17A and 17B, right side) and a socket 807 connected with the terminal unit 806 in the state where the electronic paper 600 is placed in the body unit 801 is arranged inside the body unit 801. This socket 807 is electrically connected with a controller 808 and an operation unit 809.

In such a display 800, the electronic paper 600 is removably placed in the body unit 801 and can also be used in a portable state where it is removed from the body unit 801.

In addition, in such a display 800, the electronic paper 600 is constituted with the electrophoretic display device 920 as described above.

Here, the electronic device of the invention is not limited to the electronic paper 600 and the display 800 as mentioned above. Examples of the electronic device of the invention include a television, a view finder type or monitor direct-view type video tape recorder, a car navigation device, a pager, an electronic organizer, a calculator, an electronic newspaper, a word processor, a personal computer, a workstation, a video phone, a POS terminal, and an apparatus provided with a touch panel, and it is possible to apply the electrophoretic display device 920 to the display units of various electronic devices thereof.

As mentioned above, description has been given of electrophoretic particles, a method for preparing electrophoretic particles, an electrophoretic dispersion, an electrophoretic sheet, an electrophoretic apparatus, and an electronic device of the invention based on embodiments shown in the drawings, the invention is not limited thereto. For example, the arbitrary configuration having similar functions may be substituted for the configuration of each unit. In addition, other arbitrary components may be added in the invention.

In addition, in the method for preparing the electrophoretic particles of the invention, one kind or two or more kinds of the arbitrary intended processes may be added.

Furthermore, in the method for preparing electrophoretic particles according to the first and second embodiments as described above, a case where a polymer having excellent dispersibility in a dispersion medium, that is, excellent hydrophobicity is linked to a particle having a hydroxyl group, that is, a polymer having hydrophobicity, has been described, but the invention is not limited to such a configuration. According to the invention, for example, a polymer having hydrophilicity can be linked to a particle having hydrophobicity.

### EXAMPLES

### Example of First Embodiment of Method for Preparing Electrophoretic Particles

### 1. Bonding of Polymerization Initiating Group-Containing Compound to Particle

### Example 1

[1] First, carbon black particles (mother particles: “Asahi Thermal” manufactured by Asahi Carbon Co., Ltd.) having an average particle diameter of 0.1 μm were dispersed in water (aqueous dispersion) to obtain a dispersion. Further, the surface of the carbon black particles was negatively charged.

[2] Next, a cationic polymerizable surfactant (first polymerizable surfactant: DMC) was added to the dispersion. The dispersion was stirred under irradiation with ultrasonic waves to obtain a mixed solution.

[3] Next, a polymerizable surfactant (second polymerizable surfactant: Adeka Reasoap ER-10, manufactured by Adeka Chemical Supply Co., Ltd.) provided with a hydroxyl group was added to the mixture in the equivalent molar amount with respect to the cationic polymerizable surfactant. Thereafter, the mixed solution was stirred under irradiation with ultrasonic waves to obtain an emulsion.

[4] Next, sodium persulfate (polymerization initiator) was added to this emulsion and the mixture was stirred to obtain a mixed solution including a particle (encapsulated mother particle) covered by a shell body in which the surrounding area of the carbon black particles is constituted with an organic polymer. Here, the conditions at this time were set as a temperature of 70° C. and a stirring time of 5 hours.

[5] Next, this mixed solution was dried under the conditions of a temperature of 60° C. for 120 minutes to obtain a dried product of the encapsulated mother particles.

[6] Next, 10 g of 2-bromoisobutyryl bromide (“B0607”, manufactured by Tokyo Chemical Industry Co., Ltd.; polymerization initiating group-containing compound) represented by the following chemical formula (4A) was added to 0.1 g of the obtained dried product of the encapsulated mother particles to obtain a mixture. Thereafter, the obtained mixture was mixed under stirring under a nitrogen atmosphere to obtain an encapsulated mother particle having a polymerization initiating group-containing compound bonded to the surface thereof.

Furthermore, the mixture was mixed and stirred for 3 hours under the conditions of a temperature of 25° C. at a rotation rate of 600 rpm. Further, after 1 hour and 2 hours after the initiation of stirring, respectively, each mixture was irradiated with ultrasonic waves at 38 kHz for 5 minutes.

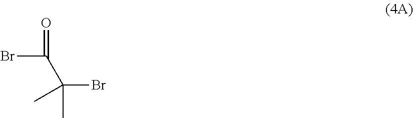

### Example 2

An encapsulated mother particle having a polymerization initiating group-containing compound bonded to the surface thereof was obtained in the same manner as in Example 1 except that 10 g of a 75%-by-weight solution of 2-bromoisobutyryl bromide (BIBB) in tetrahydrofuran (THF) instead of BIBB was added to 0.1 g of the dried product in the process [6] to obtain a mixture.

### Comparative Example 1

An encapsulated mother particle having a polymerization initiating group-containing compound bonded to the surface thereof was obtained in the same manner as in Example 1 except that 10 g of a 50%-by-weight solution of 2-bromoisobutyryl bromide (BIBB) in tetrahydrofuran (THF) instead of BIBB was added to 0.1 g of the dried product in the process [6] to obtain a mixture.

### Comparative Example 2

An encapsulated mother particle having a polymerization initiating group-containing compound bonded to the surface thereof was obtained in the same manner as in Example 1 except that 10 g of a 25%-by-weight solution of 2-bromoisobutyryl bromide (BIBB) in tetrahydrofuran (THF) instead of BIBB was added to 0.1 g of the dried product in the process [6] to obtain a mixture.

### Comparative Example 3

An encapsulated mother particle having a polymerization initiating group-containing compound bonded to the surface thereof was obtained in the same manner as in Example 1 except that 10 g of a 0.2%-by-weight solution of 2-bromoisobutyryl bromide (BIBB) in tetrahydrofuran (THF) instead of BIBB was added to 0.1 g of the dried product in the process [6] to obtain a mixture.

### 2. Evaluation

### 2-1. Measurement of Particle Size Distribution by Dynamic Light Scattering

Methylene chloride as a dispersion solvent was added to each of the encapsulated mother particles having a polymerization initiating group-containing compound bonded to the surface thereof obtained in each of Examples and each of Comparative Examples until the content of the encapsulated mother particle having a polymerization initiating group-containing compound bonded to the surface thereof reached a range suitable for measurement, thereby obtaining a dispersion. Thereafter, for the dispersions of each of Examples and each of Comparative Examples, the particle size distribution was measured by a dynamic light scattering method using a particle size distribution measuring device (“MICROTRAC UPA-250”, manufactured by Nikkiso Co., Ltd.).

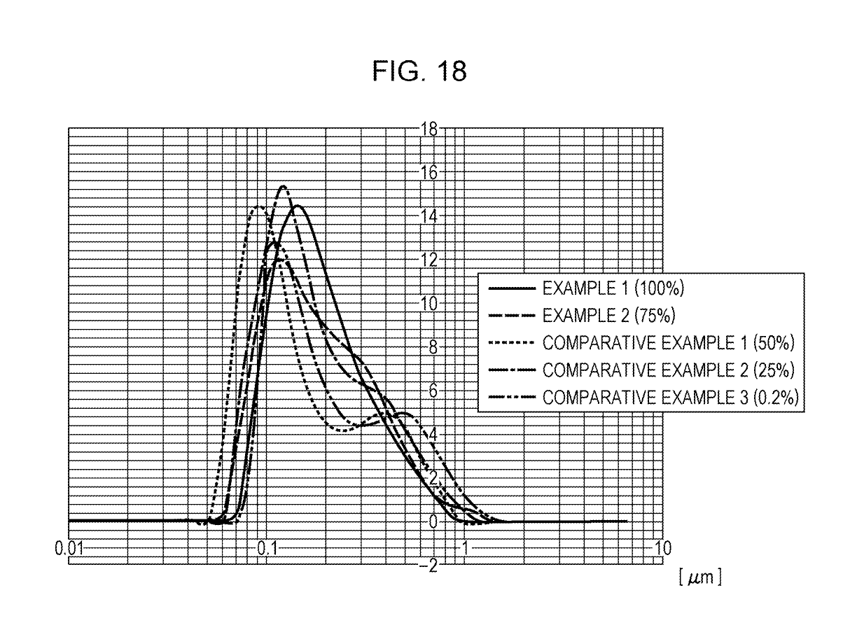

The results thereof are shown in FIG. 18.

In addition, the measurement of this particle size distribution was carried out five times for 30 seconds on a cumulative basis. Further, for the samples of each of Examples and each of Comparative Examples, this measurement was respectively carried out twice and an average of the values was determined by calculation.

### 2-2. Standard Deviation Analysis of Particle Size Distribution

From the particle size distribution measured in the encapsulated mother particles having a polymerization initiating group-containing compound bonded to the surface thereof of each of Examples and each of Comparative Examples, a 84% particle diameter [μm] (a particle diameter corresponding to a point of 84% in a cumulative curve; d84%) and a 16% particle diameter [μm] (a particle diameter corresponding to a point of 16% in a cumulative curve; d16%) were each calculated. From the measured particle diameters, the standard deviation σ of the encapsulated mother particles having a polymerization initiating group-containing compound bonded to the surface thereof was determined using the following equation (II).

σ=(d84%−d16%)/2 (II)

Further, for the encapsulated mother particle having a polymerization initiating group-containing compound bonded to the surface thereof of each of Examples and Comparative Examples 1 and 2, a relative value was determined by taking the standard deviation a calculated from the encapsulated mother particle having a polymerization initiating group-containing compound bonded to the surface thereof of Comparative Example 3 as 1.

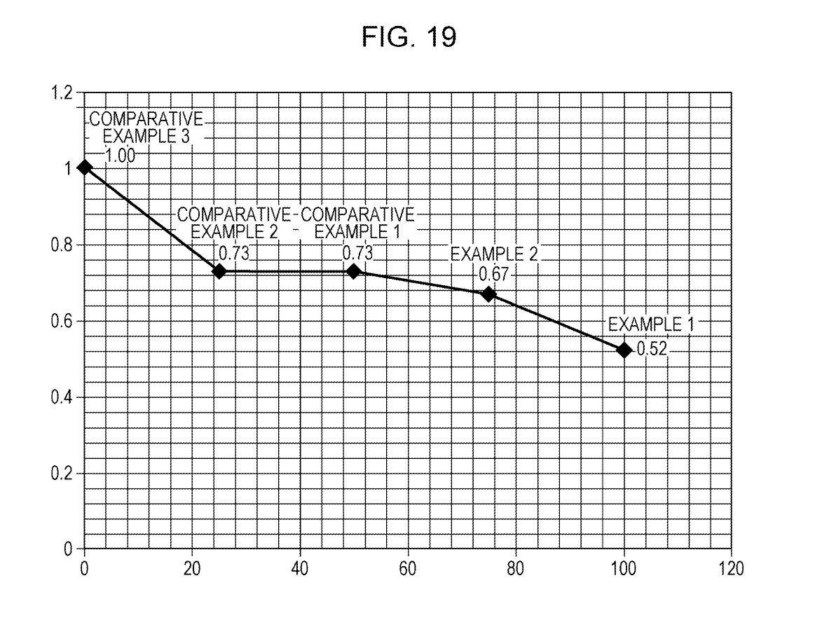

The results thereof are shown in FIG. 19.

### 2-3. Microscopic Image Analysis

For the encapsulated mother particle having a polymerization initiating group-containing compound bonded to the surface thereof of each of Examples and each of Comparative Examples, the microscopic image in the dispersion used respectively in the measurement of the particle size distribution of 2-1 above was acquired at a constant magnification rate. Further, ones each having a particle diameter of 1 μm or more were picked up among the obtained microscope images, and a sum (total area) of their areas was determined.

In addition, for the encapsulated mother particle having a polymerization initiating group-containing compound bonded to the surface thereof of each of Examples and Comparative Examples 1 and 2, a relative value was determined by taking the total area determined from the encapsulated mother particles having a polymerization initiating group-containing compound bonded to the surface thereof of Comparative Example 3 as 1.

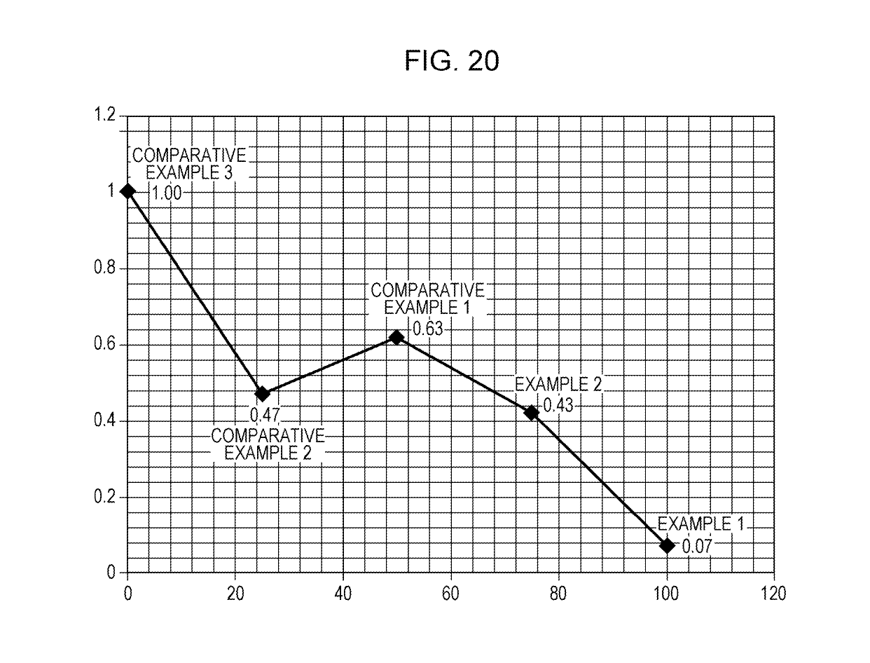

The results thereof are shown in FIG. 20.

### 2-4. Conclusion

As shown in FIG. 18, one peak is usually observed in the particle size distribution of the encapsulated mother particles having a polymerization initiating group-containing compound bonded to the surface thereof of each of Examples. In contrast, two peaks are observed in the particle size distribution of the encapsulated mother particles having a polymerization initiating group-containing compound bonded to the surface thereof of each of Comparative Examples. That is, in each of Comparative Examples, it is presumed that an aggregate of these particles is formed, in addition to the encapsulated mother particles having a polymerization initiating group-containing compound bonded to the surface thereof.

Moreover, this can also be seen from a graph showing the relationship between the standard deviation of the particle size distribution and the content of the polymerization initiating group-containing compound, and the relationship between the total area of those having a particle diameter of 1 μm or more and the content of the polymerization initiating group-containing compound, shown in FIGS. 19 and 20. Therefore, it could be seen that the encapsulated mother particles having a polymerization initiating group-containing compound bonded to the surface thereof can be dispersed in the dispersion while the formation of the aggregate is prevented by setting the content of the polymerization initiating group-containing compound to 75% by weight or more as in each of Examples.

The entire disclosure of Japanese Patent Application Nos. 2014-096299, filed May 7, 2014 and 2014-118635, filed Jun. 9, 2014 are expressly incorporated by reference herein.

What is claimed is:

1. A method for preparing electrophoretic particles including particles having a hydroxyl group on the surface thereof and a polymer linked to the particles, the method comprising:
mixing a first compound provided with a functional group having reactivity with the hydroxyl group with the particles to obtain a mixture, and linking the first compound to the particles; and
linking the polymer to the particles through the first compound,
wherein the content of the compound excluding the particles in the mixture is 75% by weight or more when the mixture is obtained.

2. The method for preparing electrophoretic particles according to claim 1, wherein the first compound is a polymerization initiating group-containing compound having the functional group and a polymerization initiating group.

3. The method for preparing electrophoretic particles according to claim 2, wherein the polymerization initiating group is represented by the following general formula (1): 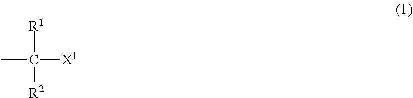
[in which R¹ and R² each independently represent a group selected from hydrogen and an alkyl group having 1 to 20 carbon atoms, in which arbitrary —CH₂— may be substituted with —O— or a cycloalkylene group, and X¹ represents chlorine, bromine, or iodine].

4. The method for preparing electrophoretic particles according to claim 2, wherein the polymer is formed by linking the monomers to the polymerization initiating group by subjecting the monomers to radical polymerization with the addition of the monomers and a catalyst to the mixture in the linking of the polymers to the particle through the first compound.

5. The method for preparing electrophoretic particles according to claim 4, wherein the monomers include silicone macro monomers represented by the following general formula (I): 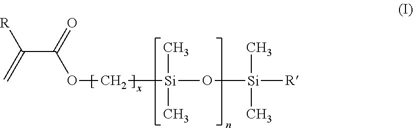
[in which R represents a hydrogen atom or a methyl group, R′ represents a hydrogen atom or an alkyl group having 1 to 4 carbon atoms, n represents an integer of 0 or more, and x represents an integer of 1 to 3].

6. The method for preparing electrophoretic particles according to claim 2, wherein a positively or negatively charged compound further having the functional group, in addition to the polymerization initiating group-containing compound, is included as the first compound.

7. A method for preparing electrophoretic particles including particles having a hydroxyl group on the surface thereof and a polymer linked to the particles, the method comprising:
mixing a second compound having a functional group having reactivity with the hydroxyl group, and the polymer with the particles to obtain a mixture, and linking the second compound to the particles in the mixture,
wherein the content of the compound excluding the particles in the mixture is 75% by weight or more when the mixture is obtained.

8. The method for preparing electrophoretic particles according to claim 7, wherein the second compound has the functional group and a polyorganosiloxane linked to the functional group at one end thereof.

9. The method for preparing electrophoretic particles according to claim 7, wherein the mixture further includes a non-polar solvent, and the content of the second compound excluding the particles in the mixture is set to 75% by weight or more and less than 100% by weight.

10. The method for preparing electrophoretic particles according to claim 7, wherein the mixture further includes the polymer, and the content of the second compound excluding the particles in the mixture is set to 75% by weight or more and less than 100% by weight.

11. The method for preparing electrophoretic particles according to claim 1, wherein the particles are obtained by drying an aqueous dispersion having the particles dispersed therein.

12. The method for preparing electrophoretic particles according to claim 1, wherein the functional group is a halogenated carboxyl group or a halogenated sulfonic acid group.

13. Electrophoretic particles prepared by using the method for preparing electrophoretic particles according to claim 1.

14. Electrophoretic particles prepared by using the method for preparing electrophoretic particles according to claim 2.

15. Electrophoretic particles prepared by using the method for preparing electrophoretic particles according to claim 3.

16. Electrophoretic particles prepared by using the method for preparing electrophoretic particles according to claim 4.

17. An electrophoretic dispersion comprising the electrophoretic particles according to claim 13.

18. An electrophoretic sheet comprising:
a substrate, and
a plurality of structures which are disposed on top of the substrate and store the electrophoretic dispersion according to claim 17.

19. An electrophoretic apparatus comprising the electrophoretic sheet according to claim 18.

20. An electronic device comprising the electrophoretic apparatus according to claim 19.
